(19) United States
(12) Patent Application Publication
(10) Pub. No.: US 2013/0110270 A1
(43) Pub. Date: May 2, 2013

(54) Pi estimating method (PEM Algorithm) and device (D)

(71) Applicants: Johnny B. Schwaller, P.E., Minden, LA (US); Peggy A. Roberts, Shreveport, LA (US)

(72) Inventors: Johnny B. Schwaller, P.E., Minden, LA (US); Peggy A. Roberts, Shreveport, LA (US)

(21) Appl. No.: 13/317,966

(22) Filed: Nov. 1, 2011

(51) Int. Cl. G06F 17/10; G06F 1/03; G06F 19/00

(52) U.S. Cl. 700/97; 708/235

(57) ABSTRACT

Original Pi Estimating Method (PEM) Algorithm is primarily intended for computer application. PEM Algorithm, given in ‘word format’, describes a math process suitable for programming. Using sufficient pi truncations and the set of all real numbers for domain divisions, PEM math process permits a user to specify goal-precisions and to estimate goal-displacements in ALL dimensional-space, domains and ranges, particularly, for ALL infinitesimal space, including beyond quantum values. By use of super-computer, PEM Algorithm can be combined with appropriate interface to control high energy devices for consistent, precise, repeatable values. Uncertainty and probabilities, involved during microscopic, infinitesimal displacements, require precise and repeatable estimates within atomic, sub-atomic, and beyond—domains. Since PEM provides reliable, repeatable, estimates of pi approximations close to actual displacements: probabilities increase and uncertainties lessen. Not to be overlooked, self-contained, binary hardware, PEM Devices involve vastly numerous configurations and unlimited sizes.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING, COMPACT DISC, APPENDIX

Not Applicable, in that, each PEMD Table for fractional displacements are less than 300 lines long.

### BACKGROUND OF THE INVENTION

Precise infinitesimal displacements are not exact but require finite estimates of changes from a predetermined reference. PEMD is a novel utility, ornamental binary device, and original math method which obeys established pi relationships of inverted trigonometric functions of a circle's interior angles (versus center angles). By operation of pi's transcendental property (no algebraic variations-on-integers can equal to its value) and pi's irrational property (pi's value as a decimal representation never ends, infinite!, or never repeats during infinite truncations—pi decimal values to the right of zero). Pi's unique math properties permit almost limitless software (mathematical) simulations for estimating fractional, arc displacement values. Based on target displacements and values resulting from PEMD's simulation using PEM's binary math utility, unique ‘hardware’ configurations can be fabricated for target ‘software’ precisions.

Real world (not infinite) fractional-displacement-estimates are limited by computer data processing limits—that is, estimates requiring precisions several places to the right of a decimal. However, real world-accuracy-limits, can entail realizable and large amounts of finite pi divisions for arc length estimates—but require sufficient pi divisions within fractional arc increments, such that values become extraordinarily numerous and result very close to actual values. What are reasonable infinitesimal limits? Decimal representations of pi truncated to 12 decimal places are sufficient precision for accuracy comparable to the range of Bohr's radius of the hydrogen atom. Precision range within this Utility Patent Application, using PEMD's pi truncation, use 6 decimal precision owing to Printed Table Space Limits and the absence of a supercomputer. However, PE Methods within this application allow ‘n’ digit computer simulation for fractional displacement precisions. These estimates are very close to actual arc lengths and demonstrate pi estimating methods (PEM) for infinitesimal displacements. PE Method and Device (PEMD) are introduced by three PEM Devices: Full, half, and quarter size PEMDs. A Prototype Binary Device is used for illustration purposes, to set-up: unquestioned range values and unquestioned domain values. PEMD's unique binary configuration, permits displacement calibrations and establishes distinct arc motions with pre-set and corresponding partitions for precise value-goals.

Among numerous PEM Device ‘hardware configurations’ suggested by PEMD's Simulation Methods for Displacement Estimates, only select PEMD Examples are presented that illustrate a basis for a novel binary math utility and unique pi estimating method. Select examples illustrate how manipulations of ‘hardware’ parameters approximate fractional displacements accurately, while benefiting from unlimited pi combinations within PEMD's vast ranges of operation. Displacement Ranges depend on PEM Device's physical and governed limits. Many displacement devices can result for articles of manufacture, controlled by user requirements. User physical variations will bound ‘hardware’ targeted precisions—but, PEMD's use of pi's unbounded estimates for arc length and PEMD's ‘software/mathematical methods’ permit many and varied user-defined precisions to be achieved.

Applications which require close estimates to user-specific, target values, or infinitesimal values, and close design tolerances, are implied in many fields of endeavor. Considering Classifications, PEM Algorithm should be listed in many fields of the numerous USPTO Patent Classifications Definitions. Owing to PEM Algorithm's general utility and special methods for ‘infinite’ values, many fields of endeavor utilizing infinitesimal values would involve listing PEM many times. Citing one specific classification, probably will cause PEM's salient appeal to be lost for wide/diverse applications. Only, Classification 341, “Coded Data Generation or Conversion” was observed on USPTO Web-site as sufficiently descriptive for PEM Algorithm's wider appeal. That is, for emphasis again, precision values surface in many fields of endeavor and coded data & conversion-technology state-of-art, vary within many specialized applications. Also emphasis is directed to PEM Algorithm as an original math utility and its ‘Infinite Pi Data’ are not necessarily for machine ends.

Specific references used during development for pi utility, design, math methods, and fabrication of a binary prototype device, using Pi Estimating Method and Device (PEMD) for fractional displacements are:
R. E. Johnson and F. L. Kiokemeister. The Calculus with Analytic Geometry. Third Edition. Boston: Allyn and Bacon, Inc. 1964.
Reginald Stevens Kimball, Ed. D., Editor. Practical Mathematics, Theory and Practice with Applications to Industrial, Business and Military Problems. New York City: National Educational Alliance, Inc., 1948.
Samuel M. Selby, Ph.D. Sc.D., Editor. CRC Standard Mathematical Tables. Seventeenth Edition. The Chemical Rubber Company, Cleveland, Ohio: 1969.
Erick Oberg, Franklin D. Jones, and Holbrook L. Horton. Machinery's Handbook. Edited by Paul B. Schubert. 21st Edition. Industrial Press Inc. 1969.
Arthur Beiser, New York University, Concepts of Modern Physics, McGraw-Hill Book Company, New York, 1967.
Dr. Richard Okura Elwes, Mathematics 1001. Firefly Books Ltd., Ontario, Canada, 2010.
Marc Freidus. Catalog 2010A 2010-2011 Reference Catalog, Victor Machinery Exchange, Inc. Brooklyn, New York: 2010.

### BRIEF SUMMARY OF THE INVENTION

Pi Estimating Method and Device (PEMD) is an original utility, yielding an ornamental device (hardware), and an original mathematical method (software) which takes advantage of pi's unique property of transcendental values for not repeating itself, and in decimal form, for never ending, thereby permitting many PEMD sizes for different displacement precisions and within various design physical-size, packaging constraints. Four basic physical parameters are used to affect displacement precisions. Then, using four physical changes affecting precision, different PEMD Tables (Avg. ppc—see Tables 4 through 7, Pages 50 to 81) of pi estimates are produced for ‘software’ comparison and illustration. An initial ‘hardware’/Test PEMD, hereafter referred to as Prototype Device, was fabricated to establish size references, operating parameters, precisions, and ‘base values’ for software references and comparisons. Tables of fractional displacement are generated for different: Face Heights (Ht.), Track Lengths, crank-drive major Diameters—crank threads-per-inch (TPI)—e.g. 0.75-10 UNC, and Roller Diameter. Unique combinations of four (soft/calculated) variables, relative to an established/(physically verified/tested) math model, combined with physical (hard) Prototype Device, are used to establish proof for claims. Also, accepted mathematical relationships will establish proof of claims when required. Value references, fractional estimated values, are produced in Tables for PEMD Quarter Size, Half Size, and Full Size (same as Prototype Size except with high tpi) and are integral for use with an original PEM Algorithm. Initial Prototype Device values establish hard (ware) and soft (ware) ‘base’ references for illustration purposes only. In dimensional comparisons, initial, verified/proven values are established for ‘real world’ comparisons for different PEMD sizes, in order to demonstrate PEMD's novel utility, flexible device—size options, and to present unique math methods/hardware binary devices for pi estimates of fractional displacements using an original PEM Algorithm.

The main object of the invention is to establish PEMD mathematical methods, using pi estimates to ‘find’ targeted, user-defined, microscopic displacements, by use of either manual, by electro-mechanical, or by electronic or by computer control. For example, DC drives & control, as well as computer driven PEM Devices (thinking outside the prototype-device-box) can involve Cathode-Ray electron beam targeting, and miscellaneous high energy targeting within present and established industry art. Electronic PEM Device fabrication and detail are not discussed. PE Methods & Algorithm can use CNC targeting, and when appreciated, ‘Benefits from PE Methods’ will allow Decision/Precision Maps for computations of PEMD Binary Domains and Ranges or Targeted/Goal Precision Values. PEM Algorithm benefits become obvious, once Tables of Average Precisions per Crank (Avg. ppc) are established for an intended device. Values within a unique PEMD's Table, then become a ‘calibrated method’ for ‘finding’ or ‘pi-estimated’ accurate displacement values very close to, if not equal to, target or goal values. Goals can be above (nX) Reference PEMD Full-Size or a Fractional (1/n) PEMD Size. PEMD Configurations are vastly numerous based on diverse measuring and displacement applications.

What is important and discloses the general idea behind this ornamental and unique method-of-estimation/utility invention is: PEM, within a user-application, permits a user to initially specify target precisions, use PEM's mathematical (soft) methods of estimation, and then, produce hard-results by use of pi estimating methods—which allow a PEM Hardware Device, a novel device that obeys pi's fractional displacement estimates. PEM Device's reliance on pi's math property of unique infinite values to the right of zero, without repeating values, allow many physical variations of PEM Devices. Each device that satisfies PEM will function within calibrated displacement-increments, and will operate on pi's ability to yield infinite number of fractional decimal values. Based on a physical configuration sought, dictated by a chosen target displacement, pi's fractional values, although having no ending or limits within displacement intervals, will aligned to values within displacement increments, such that, discrete infinitesimal values are realized for precision determinations.

### BRIEF DESCRIPTION OF THE SEVERAL FIGURES

### Graph, Math, Photo-View, Tables, and Sample Calculations

The first listing are Graph Figures derived from a Prototype Device which establishes ‘base data’ for generalized pi estimating methods, which obey PEM. Statements for purpose and cross-reference to detailed descriptions will be given as appropriate. The second listing are for Mathematical Equation Figures. The third listing are Photographic-view Figures of a Prototype PEM Device which more clearly illustrates a hardware example that complies with pi estimating methods of PEM Device. Statements corresponding to each Photo-view Figure will explain the purpose of each figure. The fourth listing are various Sample Calculations and a Table for Prototype Device and Tables for three Examples of PEMD physical variations on precisions. The final Table, Table 8, addresses Fractional PEM. Each table will be supported by explanations referenced to other tables or figures when needed and will be provided with sample calculations as appropriate. Total Listing follows:

### GRAPH FIGURE LISTING

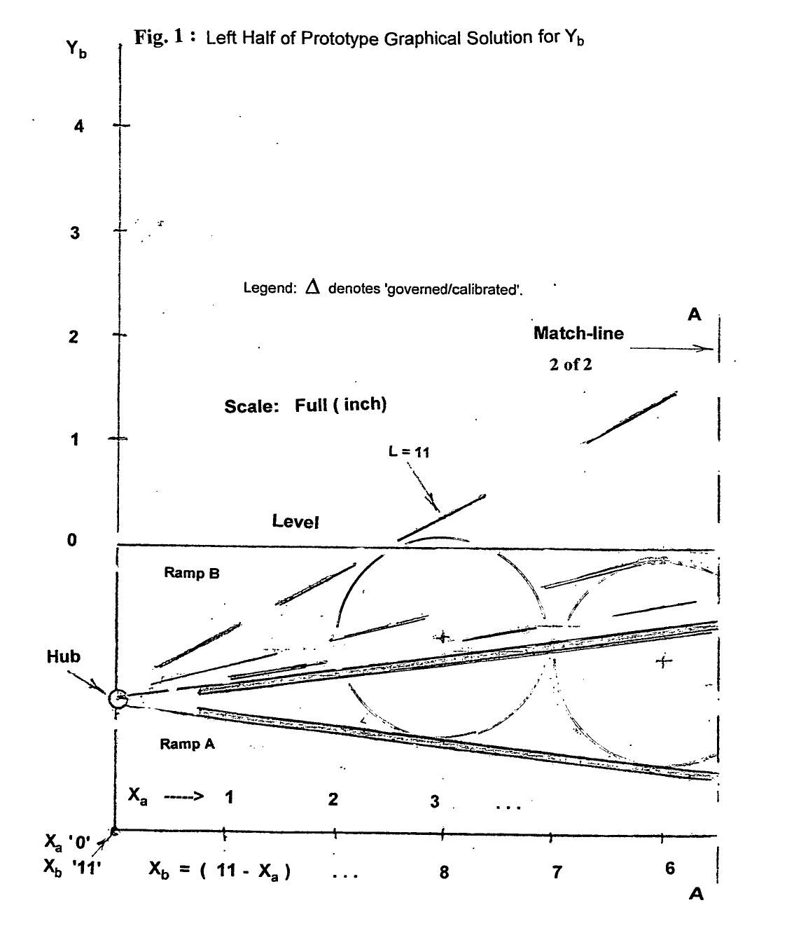

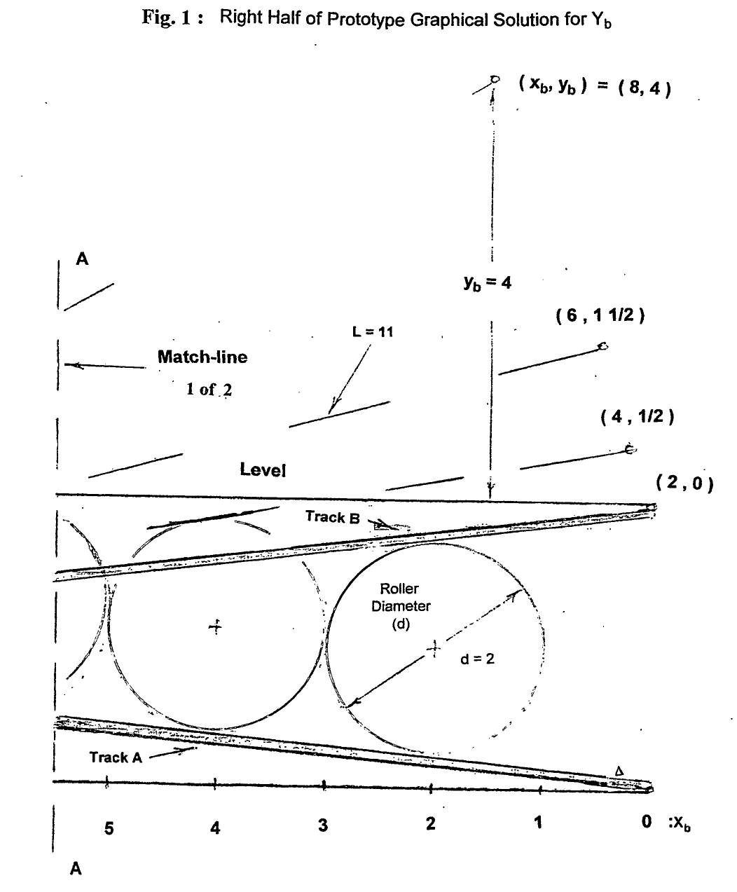

FIG. 1. FIG. 1. Graphical Solution for Prototype Displacement Values.

FIG. 1 also represents Graphical Solution for PEMD Initial Base Values. FIG. 1 establishes ‘Y’ Values of displacement that correspond to each whole value of ‘X’. ‘X’ values correspond to Prototype Crank Major Diameter ¾″-10 threads per inch (tpi), Roller (2″ diameter), Face Height (3″), and Track A & B Length (11″). Roller movement progresses from an initial setting of 1″ (parked), an inverted reference from right to left for increasing values, instead of left to right for increasing values. ‘Y’ Values are graphically determined for Roller Positions, ‘X’ equal to 1, 2, 3, 4, 5, 6, 7, and 8.

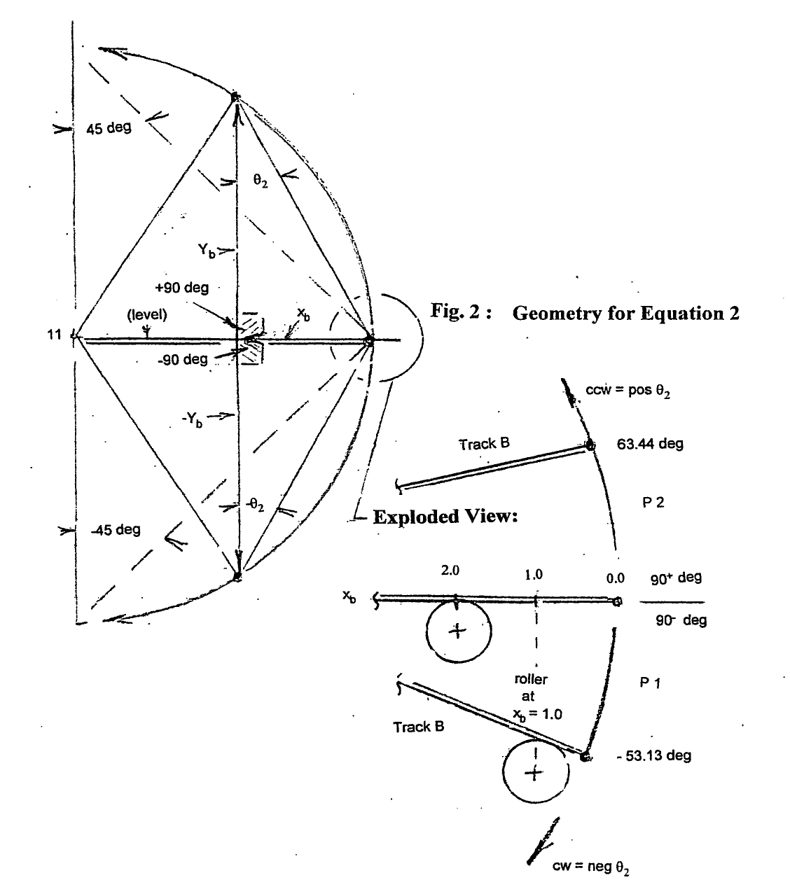

FIG. 2. FIG. 2. Trigonometric Relationships of a Triangle Inscribed in a Circle.

FIG. 2 presents two distinct, inscribed triangles, subtended by an arc length of a circumference segment for math-modeling a PEM Device's fractional displacements. A distinct arc segment below ‘level’ is Arc Partition One (P1). P1 renders negative values of displacement and is used primarily for leveling/calibrating zero used in PEMD. The arc segment above level is Arc Partition Two (P2). P2 is used primarily for pi estimating fractional displacements.

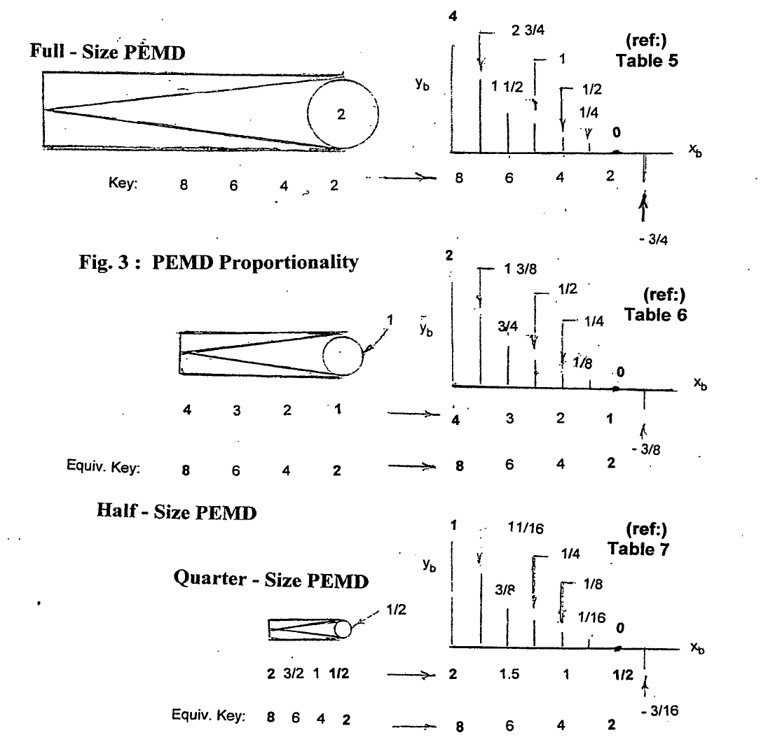

FIG. 3. FIG. 3. Prototype Full Size, PEMD Full Size, PEMID Half Size, and PEMD Quarter Size Configurations.

FIG. 3 illustrates dimensional changes for proportional PEMD variations (Prototype Device as reference) to changes in Crank-drive-major-diameter, threads per inch (tpi), Face Height (Ht., Roller Diameter (Dia.) and Track Length (L). Changes for full-size, half-size, and quarter-size PEMD are ‘keyed’ to domain and range values of the Full-size ‘Reference’, Prototype Device. FIG. 3's particular purpose is to illustrate how physical proportionality affects displacement range and domain. Four proportional component changes for PEMD obey binary operation. All PEMD Sizes are binary and require pi estimating methodology. Fractional PEMD less than Quarter-Size are discussed at Table 8, Page 86. Many PEMD Sizes can be achieved as long as binary proportionality is obeyed.

### MATH FIGURE LISTING

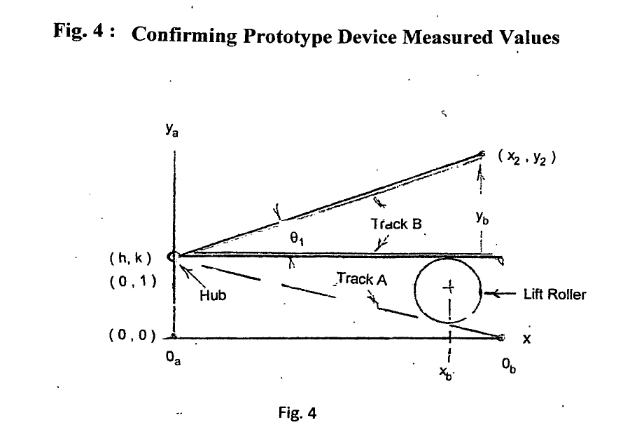

FIG. 4. FIG. 4. A Simple Line Equation for Verifying Prototype Device Measured Displacements.

FIG. 4 represents a Line Equation, translated from a circle's central origin and obeys ‘central angle’ relationships for a line that pivots from its translated ‘Hub’. A simple line equation is used only for establishing/confirming initial values of ‘Y’ from ‘X’ positions. Initial Values are used to find unique-Interval Angles of Arc Partitions (P1 & P2) inscribed in a circle (See FIG. 2). Each angle corresponds to whole values of ‘X’ which become PEMD's Binary Range Basis for Intervals used in dividing P1 & P2 Arc Segments—which in turn, permit the use of pi estimating methods for fractional displacements (See FIG. 4, and Table 1, Page 41.

FIG. 4 Sample Calculations for Table 1-1.

General Form, Equation 1-1 is used for verifying ‘measured’ values of ‘Y’. Sample calculations by operation of Equation 1-1, 1-2 and 1-3 for ‘X’ at 6″, ‘Y’ (at ‘X’=6″) are used for example. Appropriate definitions are given. See Page 42.

FIG. 4 Sample Calculations for Table 1-2.

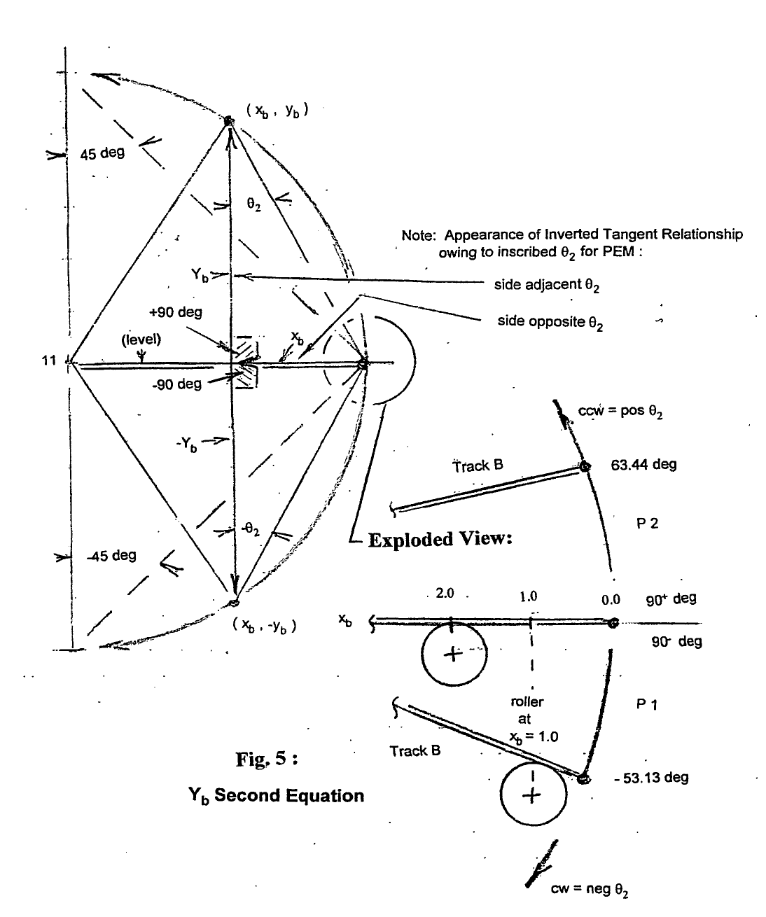

PEMD's general mathematical expressions are developed at two places: FIG. 2 and at FIG. 5. Equation 2 is primarily used for PEMD's pi estimating fractional displacements. Pi's Intervals, used for PEMD, are established at FIG. 4 and Table 1. Congruence with prototype are checked at Table 1-1. Knowing “base values” for ‘X’ Intervals and corresponding ‘Y Intervals’ (expressed in decimals), provide congruence for ranges of pi intervals (expressed in degrees) at Table 1-2. Values must comply with pi's calibrated Intervals in order to be PEM within binary domain & range boundarys; and, to represent a binary device, displacement values must comply with pi estimating method (PEM) and it's device (D) for PEMD. Page 43.

FIG. 5. FIG. 5. Trigonometric Inverse Function for Computing Displacement.

FIG. 5 presents an inverted, unconventional tangent function (see FIG. 5 and Paragraph [0069]), given as Equation 2, that is a simple expression and used extensively for computing fractional displacements in all Tables included with this utility submission. Parameters of Equation 2 are discussed in DETAILED DESCRIPTION OF THE INVENTION. Long established mathematical proofs support arc-length-estimating and become the basis for proving infinitesimal decimal values in all Tables as unquestioned-proof given by pi's estimating method (PEM). Using fractional pi (expressed in degrees) and using corresponding pi's truncated decimal values, allow expressions for microscopic precisions, available for various PEMD. See Pages 33 thru 40 for PEM Algorithm and utility process for precise estimations.

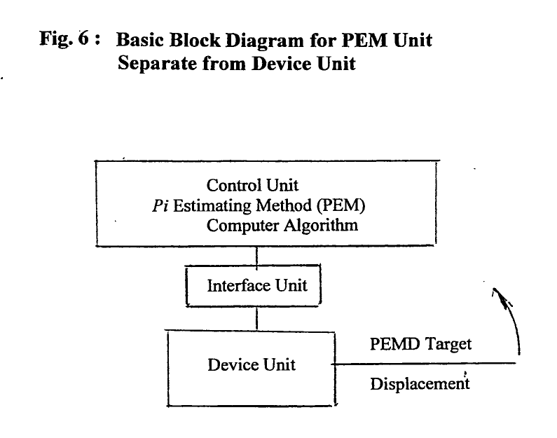

FIG. 6. FIG. 6. Pi Estimating Method (PEM) Algorithm, with Table 5 Values for Illustration, and Sample Calculations for Pi Truncated.

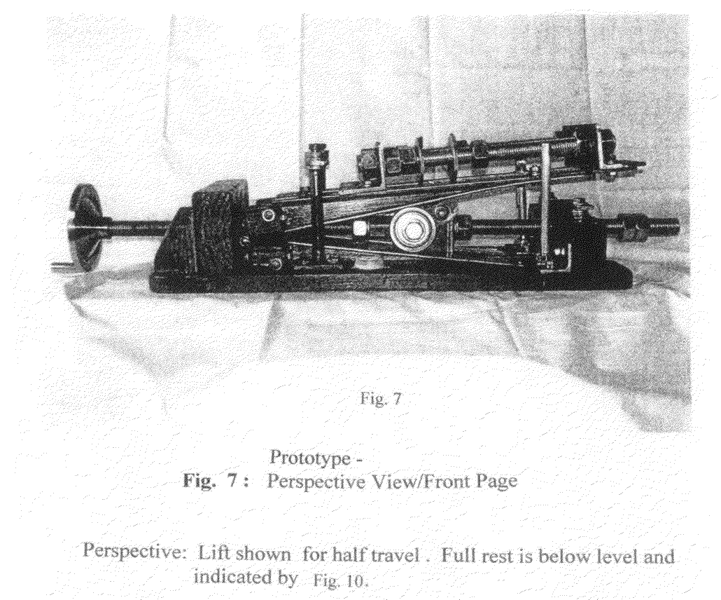

FIG. 6 presents a simplified diagram for a PEM control unit interfaced to a special device unit when a PEMD's domain and range become too small for a PEM Device to be configured as a single self-contained unit (e.g.: the prototype example at FIG. 7). Prototype Device yields pi estimating within a single unit, self-contained binary mechanism Infinitesimal PEM Devices will require PEM control separate from a displacement device. PEM Control obeys a Math Scheme, demonstrated by word or manual algorithm utility which can be readily adapted to programmed decisions for computer application. Micro-miniature PEMD precisions are increased with expanded pi truncations for close approximations, and entail numerous calculations of fractional-arc-length-estimates of infinitesimal displacements. Atomic, subatomic and beyond, displacements require expanded computer use (See Table 8, Pages 82 thru 97).

Sample 1/64 th inch calculations are given for pi truncated to 4 digit, 5 digit, and 6 digit accuracy. Pi Estimates for Example Targets are shown within 6th Digit precision to the right of decimal point. Tables 4, 5, 6, & 7 use only 4 digit domain and range values for Average Precision Per Crank (Avg. ppc). Special calculations for 5 digit and 6 digit truncations (Pages 37 and 39) are given as sample calculations for illustrating additional precision by pi truncated. Math Domain and Range Values, using 4 digit, are sufficient for most displacement estimates Quarter-Size PEMD and greater. Additional truncations for pi, 12 digits or greater should be utilized when sub-fractional arc estimates are needed to simulated values that fall within atomic and sub-atomic domain and range measurements using pi estimating (PE) Methods (M). For illustration purposes, 4 digit pi is used in measuring, math checks, and calibrating devices for binary domain and range relationships using a Prototype Device and three PEMD examples. A fourth example, PEM Algorithm Example, is given at Table 8 to demonstrate “estimating a known and unquestioned atomic value” to confirm PEM Algorithm's infinitesimal power.

### PHOTO-VIEW FIGURE LISTING

FIG. 7. FIG. 7. Perspective View.

FIG. 7 is a side-view of a Full-size Prototype Device and, if desired, FIG. 7 can be used in other publications which require a front page for PEMD. PEM Algorithm is not suitable for photo-representation. See Pages 33, 37. 39, 96 and Paragraph [0103]).

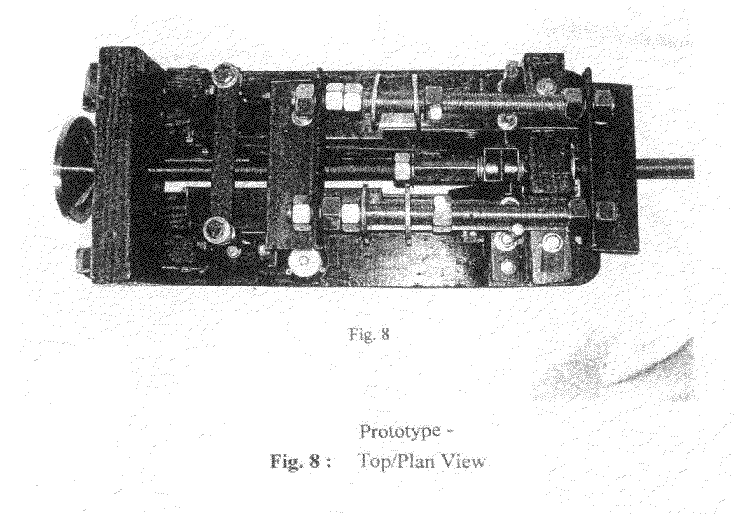

FIG. 8. FIG. 8. Top/Pan View.

FIG. 8 is a top/plan view of a Full-size Prototype Device which has parallel threaded rods for mounting various devices (for example: electron-gun, photo-electric device, laser device, etc). If desired, permanent mounting of a device involves direct attachment to the Lift Arm, directly above Track B—which permits parallel rod deletion.

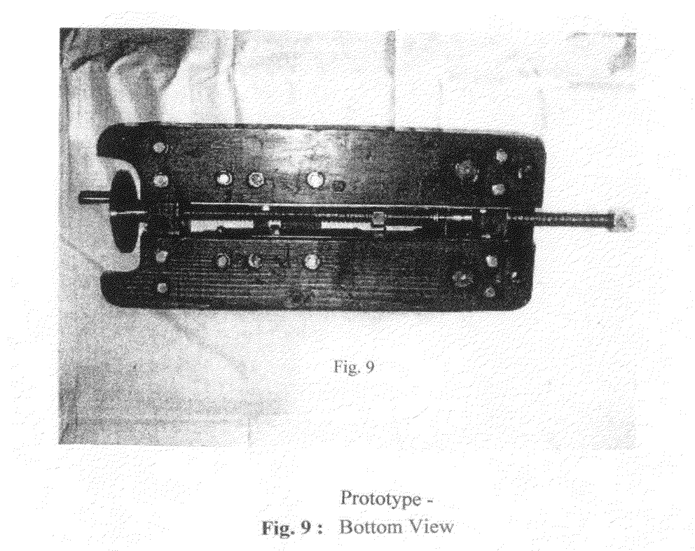

FIG. 9. FIG. 9. Bottom View.

FIG. 9 is a bottom view of a Full-size Prototype Device. Crank shaft length in photograph is longer than needed for selected binary ‘X’ Domain that governs Roller movement. Full-size prototype is used in initial testing, measuring, and incidental PEMD performance verifications.

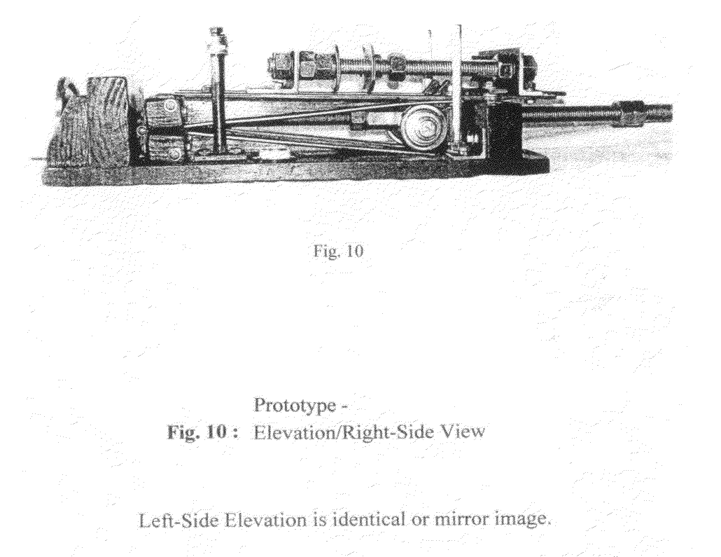

FIG. 10. FIG. 10. Elevation/Right-Side View.

FIG. 10 is an elevation/right-side view of a Full-size Prototype Device. The left-side elevation is mirror image to its right. Tracks, Roller and Device Mounting Rods are clearly shown. Prototype is shown in the parked position, which is below level. Level is when the Roller is at ‘X’ equal to 2″ for Full-size, Face Ht.=3″, ¾″-10 tpi, Roller Dia.=2″, and Track Length=11″. Prototype Device values are ‘base values’ for all PEMD.

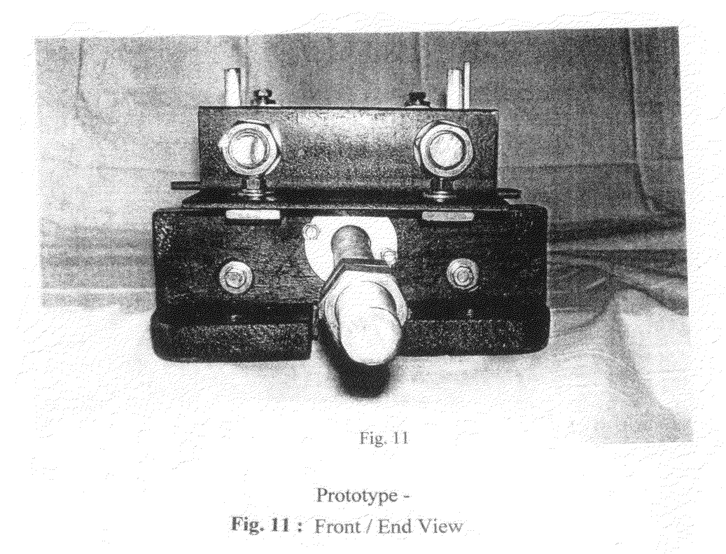

FIG. 11. FIG. 11. Front/End View.

FIG. 11 is an end view that is presented as a front view of a Full-size Prototype Device. Mounting bracket for test devices are attached to the Top Track (designated as Track B, which obeys fractional arc length displacements relative to its Hub). A PEMD at level, is a low-profile device.

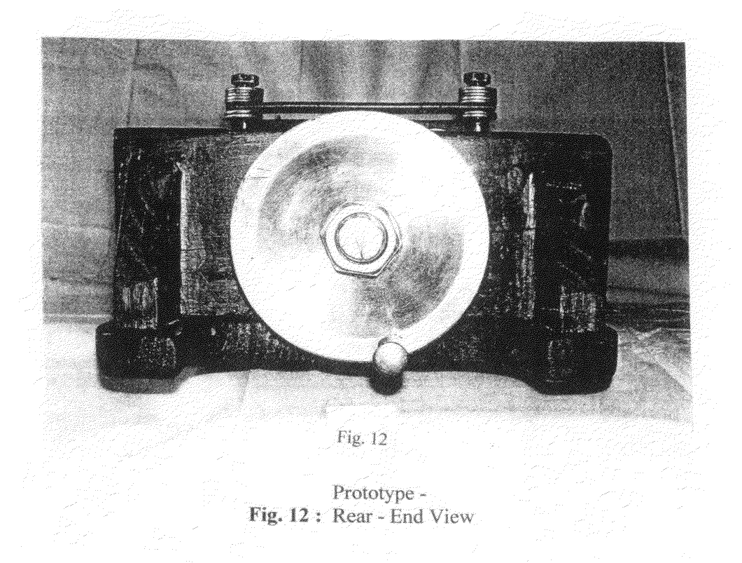

FIG. 12. FIG. 12. Rear/End View.

FIG. 12 is an end view that is presented as a rear view of a Full-size Prototype Device. The Crank (C) advances the Lift Roller according to crank-shaft tpi, advances proportional to 2 pi full revolution, and according to fractional-pi-proportional-displacement within a full revolution of Crank (C).

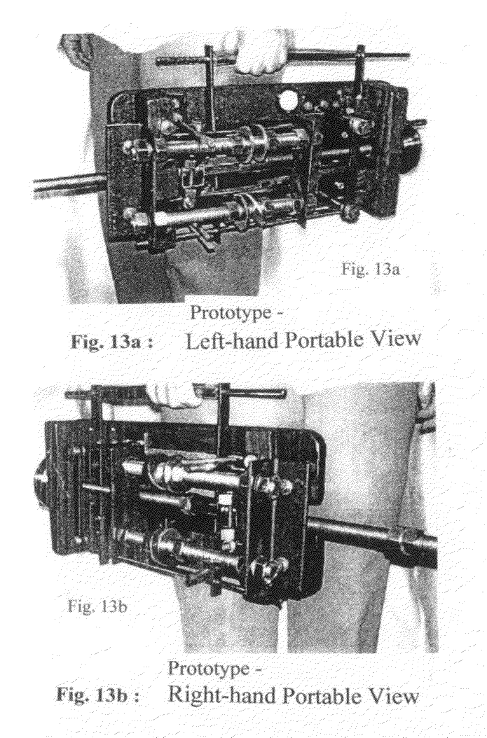

FIG. 13. FIG. 13. Left Hand & Right Hand Portable View.

The purpose of providing portable views are to demonstrate that PEMD does not have to be permanently attached to a bench or permanently to any support structure. Again, the threaded rod used on the “test” model for determining a governed ‘Binary’ (Roller) Domain, the rod is longer than required for the Prototype's binary displacement-range selected. For the rod length shown, Track B will stand straight up or 90 degrees, with ‘X’ at 10″ (or orthogonal to level). User PEMD must be governed (restricted) for targeted displacements that cover binary values and will be less than “test” rod length shown on FIG. 13.

### TABLE LISTING

Table 1. Y Determinations of Graph FIG. 1 (FIG. 1).

Base values are measured, calculated, and established using GF 1 for a Prototype Binary Device: Face Ht.=3″, ¾-10 UNC, Roller Dia.=2″, Track L=11″: Page 41.

Table 1-1. Measured ‘Y’ Displacement for Each ‘X’.

The purpose of Table 1-1 is to create ‘base values’ to be used for user target/goal displacements. Prototype Device's base values are binary and are dependent on physical parameters of the prototype. Prototype physical parameters selected for Full-Size are: Face Area 3″ height, Drive Crank ¾″major diameter, 10 threads per inch, Unified National Course Standard (0.75-10 UNC), Lift Roller 2″ OS diameter, and (roller) Track Length (L) 11″. Other PEMD Bases could have been chosen initially. For PE Methods, Prototype's Device-physical-parameters are binary and are distinctly selected to demonstrate an original binary scheme, a scheme for pi estimating, and for presenting, that is, for illustration purposes, an example of ornamental device, that obeys PEM. All PEMD above and below Full-Size must obey binary proportionality. Prototype Device Graphical Values on Table 1-1 list ‘Target’ or ‘Goal’ Domain & Range Binary Values and allow a Scheme of known/measured Displacements Ranges (Y) to be compared to a simple line equation for ‘calibrating’ PEMD to restricted partitions of two arc segment lengths (P1 & P2). Using Prototype values as PEMD base values, physical, and graphical measured displacement (Y) values, are compared to line equation solutions for ‘Y’ on Table 1-1. This is done as a check, a double check, for measured versus calculated ‘Y’ congruence and for unquestioned base values. Subsequent PE Methods using base values become unquestioned/proven, for simulating pi estimated values using PEM and its device (D). Thus, subsequent PEMD will not require double checks (graph or line equation), but will only require conformance to binary proportionally of pi methods and device parameters calibrated for Full-Size PEMD. See FIG. 3.

Table 1-2. Calculated Angles (Degrees) from Graphical Results of FIG. 1.

Table 1-2 utilizes ‘X’ & ‘Y’ Values from Table 1-1 and by use of inverted trigonometric relationships of interior angles and Equation 2, an alternate method, a pi estimating method (PEM), for calculations, yield PEMD's unique math scheme of dividing displacement-arc-lengths into predetermined Intervals. Inverse tangents using Prototype's ‘X’ binary domain and ‘Y’ binary range, produce ‘angle boundary values’ for each Interval (pi values within an arc length), and then each restricted partition (P1 & P2) are divided by predetermined Intervals (increments that obey tpi), such that, calibrated ‘Y’ displacements, are presented according to domain Intervals, with each Intervals divided by tpi increments. Prototype's calibrated (measured and calculated) domain and range values are PEM base-reference-values. Exact angle boundary (in degrees) for all PEM Intervals are now established for the pre-determined Arc-Segment-Partitions (P1 & P2), as illustrated by Exploded View within FIG. 2 and Table 1-2, Page 41.

Table 2.

The purpose of Table 2 is to show Prototype's Conformance to FIG. 2's ‘below level’ Arc Partition 1′ (P1) and ‘above level’ Arc Partition 2 (P2). A Key Scheme is introduced that align whole values of X to unique and specific angle values using Eq. 2, Page 31. Also, another purpose of Table 2, is to demonstrate how Intervals between ‘calibrated degrees’ are translated to threads per inch (TPI) for establishing ‘X’ Domain Increments and how corresponding degree increments allow computation of fractional displacements. Prototype's P2 Domain is binary and utilizes Intervals 2 to 3, 3 to 4, 4 to 5, 5 to 6, 6 to 7 and 7 to 8 for estimating Prototype's Displacements with integral links to corresponding binary range values. By use of pi (degrees) that correspond to binary range values: +90 to 85.24, 85.24 to 82.87, 82.87 to 78.69, 78.69 to 75.96, 75.96 to 68.55, and 68.55 to 63.44 degrees, respectively, displacement ‘Y’ are calculated using Eq. 2-1. Page 44 calculated values for displacement (Y) are given in inches and millimeters. Although millimeter equivalents were used with inches during Prototype Device testing, inches are selected for presentation and are used throughout further discussions without necessarily stating dimensions. For this application, Inches are understood when not stated.

Table 3

The purpose of Table 3 is a refresher for standards that relate a circle's circumference divided by fractional pi (radians) and degree equivalents of fractional pi. Also fractional pi are related to conventional Quadrant Standards using counter-clockwise rotation for positive angles. For example, a radius from a circle's origin to its circumference, begins a positive sweep at zero degrees when radius is congruent with a positive horizontal axis and begins a positive arc segment on a circle's circumference by counter-clockwise rotation; and, the summation of all arc segments will equal to its circumference when one revolution is complete or a 360 degree sweep returns to point-of-beginning. By definition, an ‘arc segment’ is that fractional length on a circle's circumference which was subtended when a circle's radius rotated a given angle [i.e.: arc=Radius times angle (radians)]. Although a PEMD's motion obeys circle's central angle, the circle's arc segment is equivalently estimated in two restricted Partitions (P1 & P2) by Equation 2. See FIG. 2 and FIG. 5.

PEMDs that are fabricated using a hand crank will require an individual's knowledge of Table 3-1 through 3-6 and his or her comfort with fractional pi estimates for controlling, measuring, and displacing incremental values. Unless fixed fractional displacements are routinely sought and PEMD settings remain predetermined (plus owing to pi's rigor), a pi estimating method (PEM) Algorithm using computer control is suggested. PEM is integral to all PEM Devices (Ds), or PEMD (s). Computer control using PEM Algorithm is the preferred control method. However, with pi familiarity, and use of PEM Word Algorithm, precise estimates can be ‘cranked’ or calculated with relative ease. Then, by use of a PEMD, accurate displacements or measurements can be made. PEMD Quarter-Size and above, permit displacement values by hand or motorized ‘crank’. Based on PEMD sizes much smaller than Quarter-Size, and if need for multiplicity of estimated values, PEM Algorithm by computer control of a device—a device that obeys PEM—will prove to be most useful.

Table 4.

Table 4 is a listing of Average Precision per Crank (Avg. ppc) of the Binary Prototype Device, Face Height=3″, crank diameter=¾″, 10 threads per inch (10 tpi), Roller Diameter [outside (OS)]=2″, and Track A or B Length (L)=11″. First (Left) Column (C), lists the number of completed revolutions per increment within Domain Intervals keyed to whole numbers (e.g. 1-2, 2-3, . . . 7-8) and subdivided by TPI and ‘calibrated to Range Pi Partitions (e.g.: +90 Degrees to +85.24 Degrees which corresponds to Key 2-3). Second Column are increments of ‘X’ using TPI for divisions or alternately, a scheme for determining Domain Divisions can be found on Tables 6 and Table 7, Pages 68 to 74 and 75 to 81, respectively. The Third Column are calculated Y Values using Eq. 2-1, Page 31. Each Table 4 (e.g.: Tables 4-1, 4-2, . . . 4-7. Pages 50 to 53) are a listing of Y Precisions that fall within the whole number Key Scheme that signifies a PEM Domain under consideration. The Remaining Columns are precisions within fractional Cranks (C)—Reference Table 4, Page 50—and each of these columns are averaged to yield “Average Precision per Crank” (Avg. ppc). Avg. ppc is integral to pi estimating (PE) method (M) for approximating Target (T) Values by PEM Algorithm. See Table 3 (Page 47), Table 2-5 (Page 45), Table 2 Sample Calculations (Page 46)., and PEM Algorithm (Page 33).

Table 5.

Table 5 provides a listing for Avg. ppc for a Full-Size PEMD when TPI is changed. Forty threads per inch (¾-40 UNS) is selected for comparison to Table 4, 10 tpi, Prototype Device. Sample Calculations using Table 5 Values and PEM are at Page 34. Impact on accuracy is demonstrated by Target Value minus Pi Estimated (PE) Value: (T−E) using PEM Algorithm (See Page 36).

Table 6.

Table 6 provides a listing for Avg. ppc for a Half-Size PEMD when all four physical parameters are uniformly altered to configure PEMD to binary one half size. Half size PEMD involves half size for Face Ht (3″ reduced to half or 1.5″), Crank Diameter (¾″ reduced to 5/16″ & TPI (40 increased to 48) or 0.3125-48 UNS, Roller Diameter (2″ reduced to half or 1″) and Track Length (11″ reduced to half or 5.5″). Go to FIG. 3 (FIG. 3), for relative physical, proportional, reductions and overview of PEMD Example Rationale. Sample Calculation using Table 6 Values and PEM are at Page 37. Impact on accuracy is demonstrated by Target Value minus Pi Estimated (E) Value (T−E) using PEM Algorithm (see Page 38). Sixth Digit Accuracy improves but remains between one one-millionth and ten one-millionth of an inch.

Table 7.

Table 7 provides a listing for Avg. ppc for a Quarter-Size PEMD when all four physical parameters are uniformly altered to configure PEMD to binary one quarter size relative to a Full-Size binary PEMD. Quarter size PEMD involves quarter size for Face Height (3″ reduced to ¾″), Crank Diameter (¾″ reduced to 3/16″ & TPI (40 increased to 72) or 0.1875-72 UNS, Roller Diameter (2″ reduced to ½″) and Track Length (11″ reduced to 2¾″). Sample Calculations using Table 7 Values and PEM are at Page 39. Same Target (T) Value were used by Table 5, 6, and 7 (or near 1/64th inch) for comparison to precision changes affected by different physical configurations. Although 6th digit precision variations are slight and minor, T−E maintains 6th digit accuracy within ten one-millionth of an inch.

Table 8.

Table 4 (Prototype), Table 5 (Full-Size PEMD), Table 6, (Half-Size PEMD), and Table 7 (Quarter-Size PEMD) involve methods for estimating displacement that fall within machine tolerances. Sizes above Full-Size PEMD are not addressed, in that, proportionalities will involve the same binary methods and tolerances. Table 8's purpose is to demonstrate PEM Schemes (opposite to large for contrast) such that, extremely small displacements are equally valid for PEM Algorithm and a Device, a PEM computer controlled device. Table 8 contains a collection of tables that show added techniques for estimating micro-miniature displacements. By use of PEM Algorithm and math schemes used at machine-levels, pi estimating for atomic and subatomic approximations for any value can be produced and “repeated” when an Algorithm obeys pi-keyed-equivalent-proportionalities of PE Methods. Although a self-contained PEMD for atomic and subatomic level displacement values are not practical in a single unit, PEM software control, obeying the techniques of pi estimating, are realizable for interfacing with and controlling a PEM device. Table 8 addresses pi estimating method (PEM) to estimate known Niels Bohr's Hydrogen Radius Value (Target) for illustration only, and offers example math methods for using PEM Control: to find micro-miniature binary domain and range values for Target Values, to pi estimate, measure and/or displace Target Values using the process of PEM. Consistent PE Methods permit logical “repeat” values above and below Targets by Algorithm. One should realize the salient importance of finding, measuring, and repeating microscopic displacements smaller than Hydrogen, smaller than subatomic, and smaller than smaller by consistent methods offered by PEM.

Table 8-1 lists PEMD Binary Sizes and Binary PEMD Domain and Range Values. It should be noticed that Full-Size (Table 5, Page 54) is identified as 1×, Half-Size (Table 6, Page 68) is “n”=0, and Quarter-Size (Table 7, Page 75) is “n”=1. Hydrogen-Size (Table 8, Page 86) is “n”=27.

Fractional PEMD domain and range lower boundary values correspond to Prototype Device at level, reference zero, and above level. Binary domain, X and Y Values below level are not included in displacement approximations. All “keyed references” are calibrated or use Prototype binary relationships; hence: Equivalent Domain Lower=2, Equivalent Domain Upper=8, Equivalent Range Lower=0, and Equivalent Range Upper=4 (Refer to Table 8-1 and Tables 2 & 4). Since a PEMD obeys binary, notice all binary range values (Ref. Table 8-1, Page 82) are one half of ‘full upper’ domain value because of binary. This binary relationship for domain and range continues on into atomic, subatomic and beyond, for pi estimating.

Table 8-2's purpose is to compare Prototype Device, Full-Size PEMD, Half-Size PEMD and Quarter-Size PEMD, Average Precision Per Crank (Avg. ppc) against Most Significant Digit (MSD) of values in Standard Form resulting from fractional Cranks within one revolution (or one Crank). Exponent values of Avg. ppc are shown for Key Scheme Intervals and for all fractional pi. Then, exponents are averaged for relative precision comparisons of the three PEMD examples to the Prototype Device. Basically, precisions are the same for the four examples regardless of size, except that displacement ranges and domain change. Highlighted (bold) exponent values are for special interest in MSD values used for PEM Form at Table 8-3. Page 85. Table 8-2 lists Domain Lower & Upper Boundary and Range Lower and Upper Boundary in Standard Form where every number can be expressed as a number between 1 and 10 and can be represented as a positive or negative power of ten.

Table 8-3's main purpose is to establish a PEM Form that differs from Standard Form in Table 8-2. In PEM Form, the MSD is just right of the decimal point and every number can be expressed as a number between 0.0 and 1.0 and can be represented as a positive or negative power of ten—with negative power being of interest for Fractional PEMD. PEM Form is used for math ease in allowing the majority of computations in the same power of ten without shifting exponents (See PEM Form “A×C=” Column on Table 8-3, Page 85). Values between zero and one are associated with PEM Form for all PEMD Calculations and its form are integral to PEM Algorithms.

Table 8-4 is ‘Table 8-5 in progress’ with explanations by example calculations (See Page 86). Table 8-4 combines the functions of Tables 8-1, 8-2 and 8-3 to find Niels Bohr's Hydrogen Radius Value. Using Bohr's known and well established Radius Value, as a Target (T) Value, is intended to take advantage of a known micro-miniature value to illustrate pi estimating method (PEM) and PEM Algorithm. In a sense, Table 8-4 is a ‘setup’ Table for determining PEM Key Scheme, PEM Domain and Range Intervals, and methods of Interval Increments for producing only the specific Average Precision per Crank (Avg. ppc) Table (e.g.: Table 8-5, Page 95) that has Hydrogen's Radius Value.

Table 8-5 is preceded by Table 8-5 Confidence Check. The purpose of the confidence check is to assure that micro-miniature PEMD binary magnitudes are proportional equivalents to Full-Size PEMD. Table 8-5 contains Hydrogen's Value. In binary proportional atomic space, Hydrogen is located at Full-Size PEM Key: 4 to 5 Equivalent, Crank 20 to 30 Interval, and by PEM Avg. ppc Table, Table 8-5 in PEM Format, Hydrogen's Radius can be approximated by using PEM Algorithm as given on Table 8-5 Sample Calculations (Page 96).

### DETAILED DESCRIPTION OF THE INVENTION

A pi estimating method (PEM) and its device (D) or PEMD is a self contained binary unit that can measure, control, and provide precise displacement for an attached mechanism within a single unit and is a hardware pi device. PEMD is distinguished from a PEM Software Binary Unit, in that, pi estimating method (PEM) is an Algorithm, primarily intended for synthesized displacement, obeying pi approximations for Target (T) Measurement by the Algorithm. Values resulting from computed pi estimates are to be used for computer control of an ‘external device’ interfaced to a PEM Unit. PEM Algorithm, which is integral to this Utility Application, is primarily intended for computer control applications. A PEM hardware device (D) or PEMD, performs the PEM Algorithm by operation of its mechanism.

The best mode for demonstrating how binary operations of the Prototype Device (FIG. 7) begins with FIG. 1, and PEMD Examples (FIG. 3) and begin with recognizing that a lift roller is calibrated to move (in reverse motion) up Track A and is restricted to movement within a ‘binary domain’. X_{b} increases in value as the lift roller moves up Track A but maintains a ‘continuous set’ of real numbers, as X_{b} glides between 1 and 8, which in theory, can cover an infinite number of intermediate values within Intervals, divisions and subdivisions of X_{b}. However, Prototype Device and three PEMD Examples use ‘threads per inch’ (TPI) for X_{b} Divisions and therefore, the number of intermediate values within Intervals are small. A PEM Software Binary Unit can utilize vastly expanded intermediate values within Intervals and will be limited only by computer computational power. Using power of 10, there are 10ⁿ continuous set of real numbers available for Interval divisions and subdivisions available for synthesized pi estimating method (PEM). Special attention is hereby made, for heightened awareness throughout discussions on Pi's property of infinite truncations without repeating and never ending for domain and range values. Computers are essential for vastly expanded computations that require precisions infinitesimally close to Target.

The ‘X’ domain has been restricted to two distinct partitions for lift operation, Reference (Ref.) FIG. 2 for further discussion of pi partitioning (P). The lower partition (P1) is for lift zeroing, or in x-y plane, for leveling. P2's Domain or X_{b}'s Binary Domain (2 to 8), is Binary: 2¹=2 and 2³=8, at Domain Boundaries Only. All intermediate values between binary boundarys obey Equation 2 (Page 31) for all PEMD and in all PEM Domains and Ranges Limits.

Refer to Geometry for Y_{b}, FIG. 5, Domain Intervals are the same, using equivalent scheme, in all Tables for “Average Precision per Crank, Tables 4 through 8, Pages 50 to 97. An Interval Scheme uses whole numbers in X_{b}'s Binary Domain for intermediate values between binary (2 to 8). Whole numbers are discrete (e.g.: 2 to 3, 3 to 4, 4 to 5, 5 to 6, 6 to 7 and 7 to 8), and being whole numbers, have gaps between and allow Intervals of real sets of numbers within PEMD's binary boundaries. This whole number convention and its equivalence due to proportionality within PEMD, is used as a ‘Key Scheme’ for locating PEMD's displacement (Y_{b}) conditions and is utilized for all Tables referenced.

Prototype ‘X_{b}’ Binary Domain follows the following Interval Convention as Key Scheme:

X_{b}=(parked),(1,2],[zeroed],(2,3],(3,4],(4,5],(5,6],(6,7], and (7,8],

whole number Intervals for all “Avg. ppc Tables” (Ref. Tables 4 through 8)—exception for Table 8 (Ref. Page 87) which does not use X_{b} Interval (1, 2] or (parked), but uses only domain ranges that yield displacements (Y_{b}) above zero reference, without loss of precision or interruption of equivalence. Sample X_{b}: 2 to 3 Interval for Prototype Device and PEMDs are given below:

| | | |
|---|---|---|
| tpi = 10: | (2.0, 2.1, 2.2 . . . 3.0] | Key: 2-3, Ref. |
| | | Table 4-2, Page 50. |
| | | (note: Interval has |
| | | 10 divisions) |
| tpi = 40: | (2.000, 2.025, 2.050 . . . 2.250] | |
| tpi = 40: | (2.250, 2.275, 2.300 . . . 2.500] | Key: 2-3, Ref. |
| | | Table 5-8, Page 57. |
| tpi = 40: | (2.500, 2.525, 2.550 . . . 2.750] | (note: Interval has |
| | | 4 divisions and |
| tpi = 40: | (2.750, 2.775, 2.800 . . . 3.000] | 10 subdivisions each |
| | | for 40 total) |
| tpi = 48: | (1.000, 1.021, 1.042, . . . 1.500] | Key: 2-3 equiv. |
| | | Ref. Table 6-2, |
| | | (note: Interval has |
| | | 24 divisions or half |
| | | 48 because PEMD is |
| | | ½ Size) |
| tpi = 72: | (0.500, 0.514, 0.528, . . . 0.750] | Key: 2-3 equiv. Ref. |
| | | Table 7-2, Page 76. |
| | | (note: Interval has 18 |
| | | divisions or ¼ |
| | | of 72 because PEMD is |
| | | ¼ Size) |

It should be noticed that each Key Scheme/Interval has an open interval for lower interval domain boundary, hence, end points are not included. Upper interval domain boundary is a closed interval and therefore include end points. Data are presented on each Table that respect the foregoing convention.

Self-contained PEMD using tpi for X_{b} Domain Interval divisions quickly deminish with physical thread options for Fractional PEMD. Hence, computer simulation of PEM operations benefit from 10ⁿ Interval divisions and permit arc length approximations for displacement (y_{b}) estimates to be very close, if not equal to, exact values. Recognizing 10ⁿ increments in X_{b} domain values, and Pi not repeating itself for infinite truncations, the development of Table 2 (Ref. Page 44), supported by its Sample Calculations, reveal the need and subtle power of a method or Algorithm which integrally has X_{b}'s 10ⁿ divisions & range values with Pi's infinite vastness.

A Prototype Device is constructed so that its lift function obeys Binary Range Motion and its action is accomplished by Track B being tangent to the lift roller while it travels up Track A, which in turn, is proportionally configured to allow Track B displacement to obey Binary Range Boundary Values. Track B's arc movement, relative to its Hub, yield Y_{b} Binary Range Boundary Values: 0 to 4 which are congruent with its X_{b} Binary Domain Boundary Values: 2 to 8 (FIG. 1 & FIG. 2).

Table 1 (Page 41) lists Prototype Device measured values. These values are verified by simple linear relationships. However, the lift operation moves according to a circle's arc segment during each discrete whole value of X_{b} and its displacement values agree with discrete pi values (Table 1-2, Page 41). For convenience, pi is expressed in degrees, where 360 degrees=2 pi radians. Owing to Track B's arc movement, (FIG. 2 and FIG. 5 respectively), Equation 2 is used to equate device motion by operation of changes in its interior angle (θ₂). Using intermediate pi values (in degrees) of Table 1-2 and regular domain intervals, in general:

Domain Interval (Iₙ)={(x₀,x₁],(x₁,x₂], . . . (xₙ₋₁,xₙ]},

there exists a function, y_{b}=f(x_{b}), such that, for every value of xₙ in a restricted binary domain (xₙ₋₁, xₙ], there exists precisely one number, such that, y_{b}=f(x_{b}) exists in restricted binary range (0, y_{b}],

By Eq. 2-1:

y_{b}=f(x_{b})=x_{b}/tan(θ₂), if and only if (− 5/18 pi<θ₂<⅙pi]
(See Table 3-5, Page 49).

And, f(x_{b}) is smooth because f′(x_{b}) exists and f(x_{b}) is restricted to be continuous at every number (no gaps or jumps) within 2 judiciously selected, and restricted, arc segment Partitions (P1 and P2), which assure the tangent function remains smooth and continuous:

$$\frac{\partial }{\partial x} ( \frac{x}{tan θ} ) = 1 / tan {θ}_{2} , derivative exists .$$

And, −θ₂ in Partition One (P1) is: − 5/18 pi<−θ₂<−½ pi (for zeroing PEMD)
And, +θ₂ in Partition (P2) is: +½ pi>+θ₂>+⅓ pi (for incremental displacements).

Partition One (P1) is not necessary for Fractional PEMD (See Table 8) owing to methods developed by Table 8, Pages 82 thru 97, and therefore, only binary range using pi within P2 boundarys above are considered.

With Equation 2-1 restricted by P2's pi range, and to be congruent with restricted Domain Set of all real numbers within pi Intervals, then all values within domain and range Intervals to be congruent within P2, must obey the following pi Intervals, divisions, and sub-divisions, and obey open & closed interval convention as given (See Paragraph [0051] above, Table 1 and FIG. 1):
Range Intervals: (+90, 85.24], (85.24, 82.88], (82.88, 78.70], (78.70, 75.97] (in degrees)
   (75.97, 68.55], and (68.55, 63.44].

In general expression:

Range Interval (Iₙ)={y₀,y₁],(y₁,y₂], . . . (yₙ₋₁,yₙ]},

a unique y_{b} (or yₙ) exists for every value of x_{b} congrument with pi range intervals immediately above.

Proof of the above are not given, in that, the tangent function, within Equation 2, is well established by trigonometric precedence. Decimal values of unlimited pi truncations, permit unlimited displacement values within restricted Partition P2, calculated via Equation 2-1, and yield unlimited computer simulated displacement values that extended beyond atomic, beyond sub-atomic, and beyond—beyond. Pi estimated method (PEM) precisions achieved via use of PEM Algorithm are only restricted by computer computational capacity and cost.

The PEM Algorithm is presented in word format (Refer to FIG. 3, PEM Ex. (Page 34), PEM Ex. (Page 37), and PEM Ex. (Page 39). Word decisions are utilized for illustrating pi estimating logic. Explanations are given that relate how Average Precision per Crank (Avg. ppc) Tables for specific PEMDs or PEM Control in computer applications are integral to pi estimating. Further Detailed Description of the Invention are located at FIG. 5 and Table 8-4 (Page 86) Sample Calculation for Hydrogen (H₂). Various detailed discussions are included in Brief (additional detail for clarity) Description of the Several Figures: Graph, Math, Photo-View, All Tables, and Sample Calculations as required.

FIG. 4: Confirming Prototype Device Measured Values—Sample Calculations using Equation 1 for verifying binary base values’ utilized in the PEM Process.

m₁=(y₂−y₁)/(x₂−x₁) Eq. 1-1

m₁=(y_{b}−1)/(x_{b}−0) Eq. 1-2

y_{b}=m₁x_{b}+1 Eq. 1-3

In the x-y plane, Prototype Example, Reference FIG. 1: the top track (B) is displaced vertically when the roller advances toward a hing, its hub, and obeys the Point-Slope Form of a Line Equation, passing through two Points: (x₂, y₂) and (x₁, y₁), reference origin is circle center. The Point Slope (m₁) Form is given by Equation (Eq.) (1-1) below, and has a ‘y’ axis intercept occurring at Track A and Track B Hub, Point (h,k), and crossing ‘y’ axis passing thru the Hub at (h,k)=(x₁,y₁)=(0,1). The Prototype's upper track mounting arm, hinged at (0,1), obeys a Line Equation not parallel to a coordinate axis (except zero) and is represented by:

m₁=(y₂−y₁)/(x₂−x₁) General Form. Eq. 1-1

Let Track B Mounting Arm be represented by the Line of Eq. 1-1, starting at its Hub, (0,1), and ending where the Track Arm and the Track B intersect, the absolute value of |y₂−y₁|=y_{b}—to provide ‘y’ ‘displacement reference’ and to distinguish from a graph point location, given by (x₂, y₂). Subscript ‘b’ also alludes to absolute ‘x’ roller displacement from an ‘x_{b}’ zero reference, Track length (L) distance from (0, 0) and (11, 0). Start of Device's Roller movement toward it's Hub, always begins at an initial position, and initial condition for Prototype Device is x_{b}=1. However, all x_{b} movement is relative to its zero reference. Eq. 1-1 translated is:

m₁=(y_{b}−1)/(x_{b}−0) Translated Slope in terms of Hub location. Eq. 1-2

Values for Slope (m₁) and y_{b} are obtained by Graphical Solution (FIG. 1) for whole values of x_{b}, and (x_{b}, y_{b}) are graphical solution-values for the line originating at the Hub, tangent to Device's roller, and ending at (x_{b},y_{b}), for each ‘controlled value’ of x_{b}. This pivoting Line at Hub, in basic form, is given by:

y_{b}=m₁x_{b}+1 Eq. 1-3 purpose is to confirm measured x_{b} and y_{b}. Use of 1-3 Equation involves 2 unknowns. Eq. 1-3

Hence, in order to obtain calculated solutions without the use of a graph (FIG. 1), a second equation is used that utilizes inverted interior angles that correspond to the Prototype's reversed movements. Eq. 1-3 Solutions are listed on Table 1-2 for determining interior angle θ₂ and by a second equation detailed at FIG. 2 and FIG. 5. Y_{b} displacement can be calculated without the use of a graph. However, values are checked against initial solutions for confidence checks. Refer to Table 1-2 at Page 41.

FIG. 5. Equation 2 Values are restricted by binary domain and range.

Y_{b}=f(x_{b})=X_{b}/(tan θ₂) θ₂ is an interior angle in FIG. 5, and Not a center angle. See Below. Eq. 2-1

FIG. 5 illustrates triangles inscribed in a circle. Prototype Lift Roller movement is from a ‘parked position’ at x_{b}=1.0 and moves to x_{b}=2.0. As illustrated by FIG. 5 Exploded View, a unique arc partition below-level (or reference zero) is bounded by fractional pi displacements corresponding to −53.13 degrees (at Track B tangent to Roller at x_{b}=1.0) and to 90-degrees (Track B tangent to Roller at x_{b}2.0). The purpose of this particular arc-segment-length-below-reference is to permit PEMD to ‘zero (at x_{b}=2.0)’. Emphasis is given that the arc partition below level is not used by arc segment estimating for displacements (above level). The negative superscript for 90 degrees signifies when f(x_{b}) approaches 2.0 “from below”, f(x) approaches reference zero “from below”, and corresponds to 90-degrees “from below”.

The following One-sided Limits, which state Pi boundaries (in degrees), use two separate and distinct PEM Partitions (Ref. FIG. 5 Exploded View), which show PEMD's X_{b} motion and degree equivalents of the two Partition Boundaries for P₁ (lower Partition) and P₂ (upper Partition):

$$\begin{matrix}{lim}_{{x}_{b} \to {2}^{-}} [ arctan ( - z ) ] = - {90}^{-} deg . \\ f ( x ) to zero “ from below ” \\ See Table 1 \text{-} 2 for {}_{}^{‵}{z}{}_{}^{′} values . \\ ( {P}_{1}^{′} s {R}_{U} “ from below ” ) - \\ See Table 8 \text{-} 1 for {R}_{U} meaning . & Eq . 2 \text{-} 2 \\ {lim}_{{x}_{b} \to {2}^{+}} [ arctan ( + z ) ] = + {90}^{+} deg . \\ f ( x ) to zero “ from above ” \\ ( {P}_{2}^{′} s {R}_{L} “ from above ” ) \\ Ref . \text{:} Table 8 \text{-} 1 Domain \& \\ Range ( {D}_{U} , {D}_{L} , {R}_{U} , \& {R}_{L} ) & Eq . 2 \text{-} 3 \\ {lim}_{{x}_{b > 2} \to 8} [ arctan ( + z ) ] = + 63.44 deg . \\ {P}_{2}^{′} s angle at {R}_{U} . & Eq . 2 \text{-} 4 \\ {lim}_{{x}_{b < 2} \to 1} [ arctan ( - z ) ] = - 53.13 deg . \\ {P}_{1}^{′} s angle at {R}_{L} . & Eq . 2 \text{-} 5\end{matrix}$$

Refer to FIG. 5 and locate two inscribed triangles with two angles, θ₂ & −θ₂. Both triangles have X_{b} as side-opposite angle. Arc Partition 2 has positive Y_{b} as side-adjacent to Angle 2. Arc Partition 1 has negative Y_{b} as side-adjacent to negative Angle 2. For the inscribed triangles, it is important to notice that conventional trigonometric tangents of a center angle (circle origin reference) become inverted. Instead of convention tan(θ₂)=Y/X, PEMD's motion is represented by a tangent of Angle 2 that uses conventional/standard trigonometric tangents with side-opposite divided by side-adjacent. However, physical ratios using interior angle-coordinates become inverted (mirror) when referenced to use of ‘interior Angle 2 motions. Hence, the tangent of Angle 2 is equal to X_{b} (side-opposite relative to θ₂) divided by Y_{b} (side-adjacent relative to θ₂). Therefore:

tan(θ₂)=X_{b}/Y_{b} Eq. 2-6

FIG. 6. PEMD units, ¼ Size or greater, utilize a Crank Hand Wheel or DC Motor for turning a threaded rod for dividing a PEMD's ‘domain’ values. PEMD unit is self-contained (i.e., PEM and Device) are configured as a single unit), obeys PEM displacements, and, as a complete unit, is the PEM Device (PEMD) that renders precision displacements for target goals of the PEMD Size selected. Word Algorithm is used for estimating target values for the PEMD. Sizing the PEMD is given on Table 8-1, Page 82.

PEMD units smaller than ¼ Size, require a PEM Computer Software Control Algorithm for simulating equivalent (equiv.) ‘domain’ divisions used in determining ‘range’ divisions for targeted pi estimated displacements. PEM Software Values can then be loaded into an Interface Unit (or integrated as a single unit—computer/interface) for driving a Device Unit that can position micro-miniature units with infinitesimal displacements or, for example, drive a laser or electron gun during infinitesimal positioning. All PEMD Schemes obey equivalent (equiv.) ‘domain’ and ‘range’ schemes of the ‘Full-Size’ Prototype Binary Unit.

Pi Estimating Method (PEM), Sample Calculation Examples, and Table 5 Values Used with Fractional Pi Values Utilized in PEM.

Reference: Full Size PEMD Table 5, page 54 for example—values are used for Algorithm below. It should be noticed that the methods, PEM Methods, presented below, are valid for Tables 4, 5, 6, and 7. Although PEM method is simple, its algorithm, given by manual/word ‘steps’ below, can be readily programmed for software computer-decision-making and simulation of target results. Speed, expanded computation, and greater truncations of pi, allow extremely accurate precisions. PEM Software ‘targeting control’ are primarily intended for fractional PEM Devices that utilize PEM Math Process for finding micro-miniature target results. Manual calculations are initially given to illustrate pi estimating method and expected tolerances of estimated results within current machine industry art. Targets within atomic and subatomic scales have domain and range displacement estimates addressed by Table 8-1 and Table 8-1 Sample Calculations. Devices larger than Full-size PEMD are not discussed and are simply Full-size PEMD, or expanded PEMDs.

Starting with a Full-Size PEMD, Target (T) 1/64 Example, 1/64=0. 015625 using Pi Estimating Method (PEM), the following ‘word’ algorithm establishes PE Method (PEM) for PEMD:

Steps for Pi Estimating and Word/Manual Algorithm for Decisions:

| | | | |
|---|---|---|---|
| Locate the value of Y, using pi truncated 4 digits, | T 1/64 | = | 0. 01 56 25 |
| and just less than, or equal to, the first 4 digits | | | |
| of Target Value. Locate Y value at Table 5-5, | | | |
| Crank (C) 43 Value of Y, Value equals (0. 01 29): | | | |
| (1) A = First Partial of pi estimate | C 43 | = | 0. 01 29 |
| | | (minus) | |
| (2) ‘Target Value’ (T) minus ‘Crank (C) Value’. | T − C Result | = | 0. 00 27 25 |
| (3) Take Result of T − C and find multiples of | | | |
| “Average Precision per Crank (Avg ppc)” | | | |
| (on Table 5-5: Y by fractional pi or degrees) | | | |
| Avg. ppc corresponds to fractional Cranks of | | | |
| 1 Revolution (eg. C/4 = 90 deg, C/8 = 45 deg., | | | |
| 360/# = deg.), where 1 Crank = 360 deg, or 2 pi | | | |
| radians, such that, the multiple of the “average | | | |
| displacement per crank (Avg ppc)” is closest | | | |
| to T − C and selected just less than T − C Result: | | | |

| | | | |
|---|---|---|---|
| At Table 5-5 | ½ pi | = C/4 | Avg. ppc = 2 × 0.0012 or 0. 00 24 < 0. 00 27 |
| Note: | ¼ pi | = C/8 | Avg. ppc = 4 × 0.0006 or 0. 00 24 < 0. 00 27 |
| | ⅙ pi | = C/12 | Avg. ppc = 6 × 0.0004 or 0. 00 24 < 0. 00 27 |
| | 1/18 pi | = C/36 | Avg. ppc = 20 × 0.00013 or 0. 00 26 < 0. 00 27. |

| | | | |
|---|---|---|---|
| (4) Select C/36 = 0. 00 01 3 | C/36 | = | 0. 00 01 30 |
| (5) Find Multiples of C/36 | 20 Multiples | = | × 20 |

| | | |
|---|---|---|
| (6) B = Second Partial pi Estimate | = | 0. 00 26 |

(7) Add both Partials (A + B) and subtract from Target (T):

| | | | | | |
|---|---|---|---|---|---|
| A | = | 0. 01 29 | Target | = | 0. 01 56 25 |
| B | = | 0. 00 26 | (A + B) | = | 0. 01 55 |
| (A + B) | = | 0. 01 55 | | (minus) | |

| | | |
|---|---|---|
| T − (A + B) Result | = | 0. 00 01 25. |

| (8) Compare T − (A + B) Result | | | |
|---|---|---|---|
| to Table 5-5's C/360's “Avg. ppc | | | |
| or 5th & 6th Digit Accuracy”: | | | |
| | T − (A + B) Result | = | 0. 00 01 25 |
| | Avg. ppc C/360 | = | 0. 00 00 13 |

(9) Determine how many multiples of C/360 are below or equal to T − (A + B)
Result which are closest to but less than or equal to Result:
Note: Find Multiples (M) times (×) [C/360 Avg. ppc] for values < T − (A + B):

| | | |
|---|---|---|
| (10) × [0. 00 00 13] | = | 0. 00 01 30 > 0. 00 01 25. |
| (9) × [0. 00 00 13] | = | 0. 00 01 17 < 0. 00. 01 25. |

| | | | |
|---|---|---|---|
| (10) Select. Multiple (9). | C/360 | = | 0. 00 00 13 |
| | M (9) | = | × 9 |

| | | |
|---|---|---|
| C = Third Partial pi Estimate | = | 0. 00 01 17 |

(11) PEM Estimated Value for Target Value by sum of all partials are:

| | | | |
|---|---|---|---|
| Partial A | (1st) | | 0. 01 29 |
| Partial B | (2nd) | | 0. 00 26 |
| Partial C | (3rd) | + | 0. 00 01 17 |

| | | | |
|---|---|---|---|
| PEM Value Equals: | 0. 01 56 17 | for | Target 0. 01 56 25 |

| | |
|---|---|
| [pi Estimated (E)] | [actual/Target value (T)] |

A note on Accuracy, Target Value Sought minus Estimated Value, using PEM, subtract ‘E’ from ‘T’: T−E=0.015625 minus 0.015617=0.00 00 08. This difference is much much less (<<) than ANSI machinery allowance <<0.000250. PEM's value allows accuracy 30 times more critical than a typical ANSI stringent of 25% of one one-thousands limit used in Standard Allowances and Tolerances.

Miscellaneous sample calculations, given for various Tables; will be given as required. When the foregoing algorithm is used, it will be provided without all descriptions but will be provided in the same format as above. Any confusion or need for further definitions will be provided for the specific Table; or, one must refer back to this initial PEM Scheme (Algorithm) and descriptions when necessary.

TABLE 6-2
Sample Calculation
½ Size PEM Example

| | | | |
|---|---|---|---|
| Half-Size PEMD, Target: 5/64 Example, | 5/64 | = | 0. 07 81 25 |
| Using Pi Truncated to 5 Digits for Values of Y. | | | |
| (1) A = First Partial of pi estimate Table 6-2: | C 40 | = | 0. 07 39 10 |
| | | (minus) | |
| (2) ‘Target Value’ (T) minus ‘Crank (C) Value’ | T − C Result | = | 0. 00 42 15 |

| | | | |
|---|---|---|---|
| (3) At Table 6-2 | ½ pi | = C/4 | Avg. ppc = 3 × 0.0013 or 0. 00 39 < 0. 00 42 |
| | ¼ pi | = C/8 | Avg. ppc = 6 × 0.0007 or 0. 00 42 < 0. 00 42 |
| | ⅙ pi | = C/12 | Avg. ppc = 10 × 0.0004 or 0. 00 40 < 0. 00 42 |
| | 1/18 pi | = C/36 | Avg. ppc = 30 × 0.00014 or 0. 00 42 < 0. 00 42. |

| | | | |
|---|---|---|---|
| (4) Select C/8 = 0. 00 07 | C/8 | = | 0. 00 07 |
| (5) Find Multiples of C/36 | 6 Multiples | = | × 6 |

| | | |
|---|---|---|
| (6) B = Second Partial pi Estimate | = | 0. 00 42 |

(7) Add both Partials (A + B) and subtract from Target (T):

| | | | | | |
|---|---|---|---|---|---|
| A | = | 0. 07 39 10 | Target | = | 0. 07 81 25 |
| B | = | 0. 00 42 | (A + B) | = | 0. 07 81 10 |
| (A + B) | = | 0. 07 81 10 | | (minus) | |

| | | |
|---|---|---|
| T − (A + B) Result | = | 0. 00 00 15. |

| (8) Compare T − (A + B) Result | | | |
|---|---|---|---|
| to Table 6-2's C/360's “Avg. ppc | | | |
| 5th & 6th Digit Accuracy”: | | | |
| | T − (A + B) Result | = | 0. 00 00 15 |
| | Avg. ppc C/360 | = | 0. 00 00 14 |

| | | |
|---|---|---|
| (9) (1) × [0. 00 00 14] | = | 0. 00 00 14 < 0. 00 00 15. |

| | | | |
|---|---|---|---|
| (10) Select. Multiple M (1). | C = Third Partial pi Estimate | = | 0. 00 00 14 |

(11) PEM Estimated Value for Target Value by sum of all partials:

| | | | |
|---|---|---|---|
| Partial A | (1st) | | 0. 07 39 10 |
| Partial B | (2nd) | | 0. 00 42 |
| Partial C | (3rd) | + | 0. 00 00 14 |

| | | | |
|---|---|---|---|
| PEM Value Equals: | 0. 07 81 24 | for | Target 0. 07 81 25 |

| | |
|---|---|
| [pi Estimated (E)] | [actual/Target value (T)] |

T − E = 0. 00 00 01 << 0. 00 02 50.

TABLE 7-2
Sample Calculation
¼ Size PEM Example

| | | | |
|---|---|---|---|
| Quarter-Size PEMD, Target: 3/64 Example, | 3/64 | = | 0. 04 68 75 |
| Using Pi Truncated to 6 Digits for Values of Y. | | | |
| (1) A = First Partial of pi estimate Table 7-2: | C 32 | = | 0. 04 49 24 |
| | | (minus) | |
| (2) ‘Target Value’ (T) minus ‘Crank (C) Value’ | T − C Result | = | 0. 00 19 51 |

| | | | |
|---|---|---|---|
| (3) At Table 7-2 | ½ pi | = C/4 | Avg. ppc = 2 × 0.0009 or 0. 00 18 < 0. 00 19 |
| | ¼ pi | = C/8 | Avg. ppc = 4 × 0.0004 or 0. 00 16 < 0. 00 19 |
| | ⅙ pi | = C/12 | Avg. ppc = 6 × 0.0003 or 0. 00 18 < 0. 00 19 |
| | 1/18 pi | = C/36 | Avg. ppc = 19 × 0.00010 or 0. 00 19 < 0. 00 19. |

| | | | |
|---|---|---|---|
| (4) Select C/36 = 0. 00 01 | C/36 | = | 0. 00 01 |
| (5) Find Multiples of C/36 | 19 Multiples | = | × 19 |

| | | |
|---|---|---|
| (6) B = Second Partial pi Estimate | = | 0. 00 19 |

(7) Add both Partials (A + B) and subtract from Target (T):

| | | | | | |
|---|---|---|---|---|---|
| A | = | 0. 04 49 24 | Target | = | 0. 04 68 75 |
| B | = | 0. 00 19 | (A + B) | = | 0. 04 68 24 |
| (A + B) | = | 0. 04 68 24 | | (minus) | |

| | | |
|---|---|---|
| T − (A + B) Result | = | 0. 00 00 51. |

| (8) Compare T − (A + B) Result | | | |
|---|---|---|---|
| to Table 7-2's C/360's “Avg. ppc | | | |
| 5th & 6th Digit Accuracy”: | | | |
| | T − (A + B) Result | = | 0. 00 00 51 |
| | Avg. ppc C/360 | = | 0. 00 00 10 |

| | | |
|---|---|---|
| (9) (5) × [0. 00 00 10] | = | 0. 00 00 50 < 0. 00 00 51. |

| | | | |
|---|---|---|---|
| (10) Select. Multiple M (5). | C = Third Partial pi Estimate | = | 0. 00 00 50. |

(11) PEM Estimated Value for Target Value by sum of all partials:

| | | | |
|---|---|---|---|
| Partial A | (1st) | | 0. 04 49 24 |
| Partial B | (2nd) | | 0. 00 19 |
| Partial C | (3rd) | + | 0. 00 00 50 |

| | | | |
|---|---|---|---|
| PEM Value Equals: | 0. 04 68 74 | for | Target 0. 04 68 75 |

| | |
|---|---|
| [pi Estimated (E)] | [actual/Target value (T)] |

T − E = 0. 00 00 01 << 0. 00 02 50.

TABLE 1
Tabulated Y_{b} Measured Displacements and
Calculated Y_{b} Displacements for Prototype Device,
Face Height = 3″, 0.75-10 UNC,
Roller Dia. = 2″, Track L = 11″.
Table 1-1
Graph Measured Y_{b} for Each X_{b} (Ref. FIG. 1)

| Measured: | | Verified by, FIG. 4, | | |
|---|---|---|---|---|
| X_{b} | Y_{b} | Compare to: | m₁ | Y_{b} |
| 1 | −¾″ | | −1.75 | −0.75″ |
| 2 | 0 | | −0.50 | 0.00 |
| 3 | ¼ | | −0.25 | 0.25 |
| 4 | ½ | | −0.125 | 0.50 |
| 5 | 1 | | 0.00 | 1.00 |
| 6 | 1 ½ | | 0.083 | 1.50 |
| 7 | 2 ¾ | | 0.25 | 2.75 |
| 8 | 4″ | | 0.375 | 4.00 |

Table 1-2
Calculated Angles (degrees) from Graphical Results of Table 1-1.

| | | | θ₂ = arctan [z] |
|---|---|---|---|
| X_{b} | Eq. 2 Y_{b} | z = [X_{b}/Y_{b}] | degrees |
| 1 | −0.750 | −1.33333 | −53.13 |
| 2 | 0.000 | ∞ | 90.00 |
| | | (see FIG. 2) | |
| 3 | 0.250 | 12 | 85.24 |
| 4 | 0.500 | 8 | 82.87 |
| 5 | 1.000 | 5 | 78.69 |
| 6 | 1.500 | 4 | 75.96 |
| 7 | 2.750 | 2.5454 | 68.55 |
| 8 | 4.000 | 2 | 63.44 |

TABLE 1-1
Sample Calculations

Given PEMD's xₐ + x_{b} = L and, Prototype Device's Length (L) = 11″,
for example, for xₐ = 3 and L = 11, x_{b} is 11 − xₐ = 11 − 3, x_{b} = 8″.
Select measured displacement (y_{b}) from Graph, Ref. FIG. 1, y_{b} = 4.0″,
and notice that Track B is tangent to the lift roller for x_{b at 8}. Using
central angle equation, Eq. 1-1, for checking displacement (y_{b}) resulting
from reverse motion of a roller moving up Track A, for
x_{b at 8} = 8 and y_{b} = 4, yields a central angle slope of:
m₁ = (y₂ − y₁)/(x₂ − x₁) and Eq. 1-2, m₁ = (4 − 1)/(8 − 0) = 3/8 = 0.375.
Hence, for x_{b} at 8, y_{b} = m₁ x_{b} + 1 = (0.375) (8) + 1 = 4.00″.

This initial confidence check is to establish and verify, domain and range ‘Partition Values’ of restricted arc segments, traveled by Track B, controlled within Distinct Intervals (domain) of a lift roller movement, and result in distinct displacement values (range), for comparison to measured, initial graph results, such that, unquestioned boundaries are set. All PEMD are calibrated using ‘Intervals’, within restricted Partitions of initial arc segments, established initially by graph for ‘full’ restricted ‘binary’ domain and range displacements (See Legend on FIG. 1,). Graph Values provide initial confirmation, checked by equations, and then presented, hence forth, as ‘base values’ utilized for indisputable PEMD Base Values. Check Values will be used in upper and lower Interval Divisions for all pi estimating methods (PEM) and Algorithm Scheme. Infinitesimal Values derived within PEMD Scheme and PEM Process of Arc Segmenting (for pi estimation of fractional displacements) are consistently ‘keyed’ to initial and distinct PEMD Partitions & Intervals. By using initial range and domain base values of FIG. 1, calculations, utilizing restricted boundaries, subsequently provide indisputable, calculated precisions for end-goal-targets which produce PEM Devices (PEMD) to be fabricated obeying PEM Process and/or PEM Algorithm for precise control. PEM Algorithm and PEMD are integral to each other.

TABLE 1-2
Sample Calculations

A second equation utilizing established continuous trigonometric
relationships, for estimating arc-lengths, associated with y_{b} displacements,
are detailed on FIG. 5 and FIG. 2. Angular Intervals that correspond to
displacement and x_{b} increments are presented on Table 1-2 (Page 41).
By using triangles inscribed in a circle, Ref. FIG. 5, values for inscribed,
inverted/(mirror) tan (θ₂), allow alternate calculations for y_{b} displacement.

| | |
|---|---|
| Eq. 2-1 | y_{b} = (x_{b})/tan (θ₂) |

Hence, for x_{b} = 6, and tan (θ₂) = (x_{b}/y_{b}) = (6)/(1.5) = 4 = (z), the
arctan (z) = arctan (4) = 75.96 degrees = θ₂
for x_{b} = 6, y_{b} = (x_{b})/tan (θ₂) = (6)/tan (75.96 deg) = (6)/(4) = 1.500,
and therefore, Eq. 2-1 Values compare to ‘measured’ & ‘Eq. 1-3’ values,
and subsequently, are utilized for incremental values of x_{b} for Prototype
Device's tpi = 10 rotations (full revolutions) per inch and are tabulated
in groups of x_{b} from:
Intervals (1-2], (2-3], (3-4], (4-5], (5-6], (6-7] and (7-8], in Table 2
(Pages 44 & 45).

TABLE 2
TABLE 2: Calculated ‘Y’ Solutions per Crank, TPI = 10
Prototype: Face Ht. = 3″, ¾ - 10 UNC,
Roller Dia. = 2″, Track L = 11″

| | | | | |
|---|---|---|---|---|
| | | Calc. | Calc. | |
| | | Y | Y | Graph Y |
| X_{b} | degree | (in.) | (mm) | notes |

Table 2-1: Angles (−53.13 to −90 deg) x = 1.0 to 2.0

| | | | | |
|---|---|---|---|---|
| 1 | −53.13 | −0.75 | −19.1 | −¾″ |
| 1.1 | −56.820 | −0.7193 | −18.3 | (below) |
| 1.2 | −60.500 | −0.6789 | −17.2 | |
| 1.3 | −64.190 | −0.6287 | −16 | |
| 1.4 | −67.880 | −0.5691 | −14.5 | |
| 1.5 | −71.570 | −0.4999 | −12.7 | −½″ |
| 1.6 | −75.250 | −0.4212 | −10.7 | (below) |
| 1.7 | −78.940 | −0.3323 | −8.44 | |
| 1.8 | −82.630 | −0.2328 | −5.91 | |
| 1.9 | −86.310 | −0.1225 | −3.11 | |
| 2 | −90.00 | −0 | −0 | 0 at −90 deg |
| | | | | (ref. level) |

Table 2-2: Angles (90 to 85.24 deg) x = 2.0 to 3.0

| | | | | |
|---|---|---|---|---|
| 2 | +90 | +0 | +0 | level |
| 2.1 | 89.524 | 0.0174 | 0.44 | |
| 2.2 | 89.048 | 0.0366 | 0.93 | |
| 2.3 | 88.572 | 0.0573 | 1.46 | |
| 2.4 | 88.096 | 0.0798 | 2.03 | |
| 2.5 | 87.620 | 0.1039 | 2.64 | |
| 2.6 | 87.144 | 0.1297 | 3.29 | |
| 2.7 | 86.668 | 0.1572 | 3.99 | |
| 2.8 | 86.192 | 0.1864 | 4.73 | |
| 2.9 | 85.716 | 0.2172 | 5.52 | |
| 3 | 85.24 | 0.25 | 6.35 | ¼″ |
| | | | | (above ref.) |

Table 2-3: Angles (85.24 to 82.87 deg) x = 3.0 to 4.0

| | | | | |
|---|---|---|---|---|
| 3 | 85.24 | 0.25 | 6.35 | ¼″ |
| 3.1 | 85.003 | 0.2711 | 6.88 | (above ref.) |
| 3.2 | 84.766 | 0.2931 | 7.45 | |
| 3.3 | 84.529 | 0.3161 | 8.03 | |
| 3.4 | 84.292 | 0.3398 | 8.63 | |
| 3.5 | 84.055 | 0.3645 | 9.26 | |
| 3.6 | 83.818 | 0.3899 | 9.9 | |
| 3.7 | 83.581 | 0.4163 | 10.6 | |
| 3.8 | 83.344 | 0.4434 | 11.3 | |
| 3.9 | 83.107 | 0.4715 | 12 | |
| 4 | 82.87 | 0.50 | 12.7 | ½″ |
| | | | | (above ref.) |

Table 2-4: Angles (82.87 to 78.69 deg) x = 4.0 to 5.0

| | | | | |
|---|---|---|---|---|
| 4 | 82.87 | 0.50 | 12.7 | ½″ |
| 4.1 | 82.452 | 0.5433 | 13.8 | (above ref,) |
| 4.2 | 82.034 | 0.5877 | 14.9 | |
| 4.3 | 81.616 | 0.6337 | 16.1 | |
| 4.4 | 81.198 | 0.6813 | 17.3 | |
| 4.5 | 80.780 | 0.7305 | 18.6 | |
| 4.6 | 80.362 | 0.7812 | 19.8 | . |
| 4.7 | 79.944 | 0.8335 | 21.2 | |
| 4.8 | 79.526 | 0.8874 | 22.5 | |
| 4.9 | 79.108 | 0.9429 | 23.9 | |
| 5 | 78.69 | 1.00 | 25.4 | 1″ |
| | | | | (above ref.) |

Table 2-5: Angles (78.69 to 75.96 deg) x = 5.0 to 6.0

| | | | | |
|---|---|---|---|---|
| 5 | 78.69 | 1.00 | 25.4 | 1″ |
| 5.1 | 78.417 | 1.0453 | 26.6 | (above ref.) |
| 5.2 | 78.144 | 1.0916 | 27.7 | |
| 5.3 | 77.871 | 1.1390 | 28.9 | |
| 5.4 | 77.598 | 1.1875 | 30.2 | |
| 5.5 | 77.325 | 1.2370 | 31.4 | |
| 5.6 | 77.052 | 1.2875 | 32.7 | |
| 5.7 | 76.779 | 1.3391 | 34 | |
| 5.8 | 76.506 | 1.3918 | 35.4 | |
| 5.9 | 76.233 | 1.4456 | 36.7 | |
| 6 | 75.96 | 1.50 | 38.1 | 1.5″ |
| | | | | (above ref.) |

Table 2-6: Angles (75.96 to 68.55 deg) x = 6.0 to 7.0

| | | | | |
|---|---|---|---|---|
| 6 | 75.96 | 1.50 | 38.1 | 1.5″ |
| 6.1 | 75.219 | 1.6095 | 40.9 | (above ref.) |
| 6.2 | 74.478 | 1.7220 | 43.7 | |
| 6.3 | 73.737 | 1.8378 | 46.7 | |
| 6.4 | 72.996 | 1.9572 | 49.7 | |
| 6.5 | 72.255 | 2.0800 | 52.8 | |
| 6.6 | 71.514 | 2.2065 | 56 | |
| 6.7 | 70.773 | 2.3367 | 59.4 | |
| 6.8 | 70.032 | 2.4707 | 62.8 | |
| 6.9 | 69.291 | 2.6085 | 66.3 | |
| 7 | 68.55 | 2.75 | 69.9 | 2.75″ |
| | | | | (above ref.) |

Table 2-7: Angles (68.55 to 63.44 deg) x = 7.0 to 8.0

| | | | | |
|---|---|---|---|---|
| 7 | 68.55 | 2.75 | 69.9 | 2.75″ |
| 7.1 | 68.039 | 2.8630 | 72.7 | (above ref.) |
| 7.2 | 67.528 | 2.9782 | 75.6 | |
| 7.3 | 67.017 | 3.0961 | 78.6 | |
| 7.4 | 66.506 | 3.2167 | 81.7 | |
| 7.5 | 65.995 | 3.3400 | 84.8 | |
| 7.6 | 65.484 | 3.4661 | 88 | |
| 7.7 | 64.973 | 3.5950 | 91.3 | |
| 7.8 | 64.462 | 3.7268 | 94.7 | |
| 7.9 | 63.951 | 3.8615 | 98.1 | |
| 8 | 63.44 | 4.00 | 102 | 4.0″ |
| | | | | (above ref.) |

‘Y’ in Tables 2-1, 2-2, 2-3, & 2-4 are all: Y_{b}
Y in Tables 2-5, 2-6, & 2-7 & Sample Calculations are all Y_{b}

TABLE 2
Sample Calculations
Example: Table 2-5

| | | | | |
|---|---|---|---|---|
| Crank (C) | X_{b} | Domain: | 5.0 to 6.0 | Key: 5-6 |

| | | |
|---|---|---|
| | | (6″ − 5″)/10 tpi = +0.1″ per Crank (C) |
| X_{b}=: | Interval: | (5.0, 5.1 to 6.0] |
| Pi | Range: | 78.69 deg. to 75.96 deg |
| Interval | | |

75.96 deg. − 78.69 deg./10 tpi = −2.73 deg./
10 = −0.273 deg. per Crank (C)
Y_{b}=: Interval: (78.69 deg., 78.42 deg. to 75.96 deg.]

| | | Pi | |
|---|---|---|---|
| | X_{b} | (Degree) | Y_{b} |
| 40 | 5.00 | 78.69 | 1.000 |
| 41 | 5.10 | 78.417 | 1.0453 |
| 42 | 5.20 | 78.144 | 1.0916 |
| 43 | 5.30 | 77.871 | 1.1390 |
| 44 | 5.40 | 77.598 | 1.1875 |
| 45 | 5.50 | 77.325 | 1.2370 |
| 46 | 5.60 | 77.052 | 1.2875 |
| 47 | 5.70 | 76.779 | 1.3391 |
| 48 | 5.80 | 76.506 | 1.3918 |
| 49 | 5.90 | 75.96 | 1.4456 |
| 50 | 6.00 | 75.96 | 1.500 |

Ref.: FIG. 2 & FIG. 5
For Example, Above, Select: X_{b} = 5 .6
Eq. 2-1: Y_{b} (X_{b}) = (X_{b})/[tan (degree)]
Y_{b} (5.6) = (5.6)/[tan (77.052)] = 1.2875″

TABLE 3
Crank Quadrants, Fractional (Frac.) Cranks in Each Quadrant and Increments
(Inc.) expressed in fractional Pi (& Degree Equivalent of fractional Pi)
Table 3-1: Overview: Fractional Crank (C) & Degree
Increments for One Revolution (Rev)

| | Crank (C): | | | | |
|---|---|---|---|---|---|
| | ¼ C | ⅛ C | 1/12 C | 1/36 C | 1/360 C |
| Inc. = deg. = pi: | 90 deg. | 45 deg. | 30 deg. | 10 deg. | 1 deg. |
| # of Inc.: | ×4 | ×8 | ×12 | ×36 | ×360 |
| =1 Rev.: | 360 | 360 | 360 | 360 | 360 |
| (Deg. full C) | | | | | |

| | | | | | | |
|---|---|---|---|---|---|---|
| | | | Pi | Deg./ | Quadrant | Quadrant (Q) |
| Crank (C) | Degree | Pi Frac. | Simplified | Frac. C | Deg. Range | (C within Q) |

Table 3-2: ¼ C -- Degrees per fractions of 2 pi:

| 0 C | 0 | 0 | (2 pi) | 0 | | 0 | 0 | 0 |
|---|---|---|---|---|---|---|---|---|
| ¼ C | 90 | ¼ | (2 pi) | ½ | pi | 1st 90 | 0-90 | 1st Q |
| ½ C | 180 | ½ | (2 pi) | pi | | 2nd 90 | 91-180 | 2nd Q |
| ¾ C | 270 | ¾ | (2 pi) | 3/2 | pi | 3rd 90 | 181-270 | 3rd Q |
| full C | 360 | 2 | pi | 2 | pi | 4th 90 | 271-360 | 4th Q |

Table 3-3: ⅛ C -- Degrees per fractions of 2 pi:

| 0 C | 0 | 0 | (2 pi) | 0 | | 0 | 0 | 0 |
|---|---|---|---|---|---|---|---|---|
| ⅛ C | 45 | ⅛ | (2 pi) | ¼ | pi | 1st 45 | 0-45 | ½ 1st |
| ¼ C | 90 | 2/8 | (2 pi) | ½ | pi | 2nd 45 | 46-90 | 1st Q |
| ⅜ C | 135 | ⅜ | (2 pi) | ¾ | pi | 3rd 45 | 91-135 | ½ 2nd |
| ½ C | 180 | 4/8 | (2 pi) | pi | | 4th 45 | 136-180 | 2nd Q |
| ⅝ C | 225 | ⅝ | (2 pi) | 5/4 | pi | 5th 45 | 181-225 | ½ 3rd |
| ¾ C | 270 | 6/8 | (2 pi) | 3/2 | pi | 6th 45 | 226-270 | 3rd Q |
| ⅞ C | 315 | ⅞ | (2 pi) | 7/4 | pi | 7th 45 | 271-315 | ½ 4th |
| full C | 360 | 8/8 | (2 pi) | 2 | pi | 8th 45 | 316-360 | 4th Q |

Table 3-4: 1/12 C -- Degrees per fractions of 2 pi:

| 0 C | 0 | 0 | (2 pi) | 0 | | 0 | 0 | 0 |
|---|---|---|---|---|---|---|---|---|
| 1/12 C | 30 | 1/12 | (2 pi) | ⅙ | pi | 1st 30 | 0-30 | ⅓ 1st |
| ⅙ C | 60 | 2/12 | (2 pi) | ⅓ | pi | 2nd 30 | 31-60 | ⅔ 1st |
| ¼ C | 90 | 3/12 | (2 pi) | ½ | pi | 3rd 30 | 61-90 | 1st Q |
| ⅓ C | 120 | 4/12 | (2 pi) | ⅔ | pi | 4th 30 | 91-120 | ⅓ 2nd |
| 5/12 C | 150 | 5/12 | (2 pi) | ⅚ | pi | 5th 30 | 121-150 | ⅔ 2nd |
| ½ C | 180 | 6/12 | (2 pi) | pi | | 6th 30 | 151-180 | 2nd Q |
| 7/12 C | 210 | 7/12 | (2 pi) | 7/6 | pi | 7th 30 | 181-210 | ⅓ 3rd |
| ⅔ C | 240 | 8/12 | (2 pi) | 4/3 | pi | 8th 30 | 211-240 | ⅔ 3rd |
| ¾ C | 270 | 9/12 | (2 pi) | 3/2 | pi | 9th 30 | 241-270 | 3rd Q |
| ⅚ C | 300 | 10/12 | (2 pi) | 5/3 | pi | 10th 30 | 271-300 | ⅓ 4th |
| 11/12 C | 330 | 11/12 | (2 pi) | (11)/6 | pi | 11th 30 | 301-330 | ⅔ 4th |
| full C | 360 | 12/12 | (2 pi) | 2 | pi | 12th 30 | 331-360 | 4th Q |

Table 3-5: 1/36 C -- Degrees per fractions of pi:

| 0 C | 0 | 0 | (2 pi) | 0 | | 0 | 0 | 0 |
|---|---|---|---|---|---|---|---|---|
| | 10 | 1/36 | (2 pi) | 1/18 | pi | 1st 10 | 0-10 | 1st 10 of 1st |
| | 20 | 2/36 | (2 pi) | 1/9 | pi | 2nd 10 | 11-20 | 2nd 10 of 1st |
| | 30 | 3/36 | (2 pi) | ⅙ | pi | 3rd 10 | 21-30 | 3rd 10 of 1st |
| | 40 | 4/36 | (2 pi) | 2/9 | pi | 4th 10 | 31-40 | 4th 10 of 1st |
| | 50 | 5/36 | (2 pi) | 5/18 | pi | 5th 10 | 41-50 | 5th 10 of 1st |
| | 60 | 6/36 | (2 pi) | ⅓ | pi | 6th 10 | 51-60 | 6th 10 of 1st |
| | 70 | 7/36 | (2 pi) | 7/18 | pi | 7th 10 | 61-70 | 7th 10 of 1st |
| | 80 | 8/36 | (2 pi) | 4/9 | pi | 8th 10 | 71-80 | 8th 10 of 1st |
| ¼ C | 90 | 9/36 | (2 pi) | ½ | pi | 9th 10 | 81-90 | 1st Q |
| | 100 | 10/36 | (2 pi) | 5/9 | pi | 10th 10 | 91-100 | 1st 10 of 2nd |
| | 110 | 11/36 | (2 pi) | 11/18 | pi | 11th 10 | 101-110 | 2nd 10 of 2nd |
| | 120 | 12/36 | (2 pi) | ⅔ | pi | 12th 10 | 111-120 | 3rd 10 of 2nd |
| | 130 | 13/36 | (2 pi) | 13/18 | pi | 13th 10 | 121-130 | 4th 10 of 2nd |
| | 140 | 14/36 | (2 pi) | 7/9 | pi | 14th 10 | 131-140 | 5th 10 of 2nd |
| | 150 | 15/36 | (2 pi) | ⅚ | pi | 15th 10 | 141-150 | 6th 10 of 2nd |
| | 160 | 16/36 | (2 pi) | 8/9 | pi | 16th 10 | 151-160 | 7th 10 of 2nd |
| | 170 | 17/36 | (2 pi) | 17/18 | pi | 17th 10 | 161-170 | 8th 10 of 2nd |
| ½ C | 180 | 18/36 | (2 pi) | pi | | 18th 10 | 171-180 | 2nd Q |
| | 190 | 19/36 | (2 pi) | 19/18 | pi | 19th 10 | 181-190 | 1st 10 of 3rd |
| | 200 | 20/36 | (2 pi) | 10/9 | pi | 20th 10 | 191-200 | 2nd 10 of 3rd |
| | 210 | 21/36 | (2 pi) | 7/6 | pi | 21st 10 | 201-210 | 3rd 10 of 3rd |
| | 220 | 22/36 | (2 pi) | 11/9 | pi | 22nd 10 | 211-220 | 4th 10 of 3rd |
| | 230 | 23/36 | (2 pi) | 23/18 | pi | 23rd 10 | 221-230 | 5th 10 of 3rd |
| | 240 | 24/36 | (2 pi) | 4/3 | pi | 24th 10 | 231-240 | 6th 10 of 3rd |
| | 250 | 25/36 | (2 pi) | 25/18 | pi | 25th 10 | 241-250 | 7th 10 of 3rd |
| | 260 | 26/36 | (2 pi) | 13/9 | pi | 26th 10 | 251-260 | 8th 10 of 3rd |
| ¾ C | 270 | 27/36 | (2 pi) | 3/2 | pi | 27th 10 | 261-270 | 3rd Q |
| | 280 | 28/36 | (2 pi) | 14/9 | pi | 28th 10 | 271-280 | 1st 10 of 4th |
| | 290 | 29/36 | (2 pi) | 29/18 | pi | 29th 10 | 281-290 | 2nd 10 of 4th |
| | 300 | 30/36 | (2 pi) | 5/3 | pi | 30th 10 | 291-300 | 3rd 10 of 4th |
| | 310 | 31/36 | (2 pi) | 31/18 | pi | 31st 10 | 301-310 | 4th 10 of 4th |
| | 320 | 32/36 | (2 pi) | 16/9 | pi | 32nd 10 | 311-320 | 5th 10 of 4th |
| | 330 | 33/36 | (2 pi) | 11/6 | pi | 33rd 10 | 321-330 | 6th 10 of 4th |
| | 340 | 34/36 | (2 pi) | 17/9 | pi | 34th 10 | 331-340 | 7th 10 of 4th |
| | 350 | 35/36 | (2 pi) | 35/18 | pi | 35th 10 | 341-350 | 8th 10 of 4th |
| full C | 360 | 36/36 | (2 pi) | 2 | pi | 36th 10 | 351-360 | 4th |

Table 3-6: 1/360 C -- Degrees per fractions of pi:

| 0 C | 0 | 0 | (2 pi) | 0 | | 0 | 0 | 0 |
|---|---|---|---|---|---|---|---|---|
| | 1 | 1/360 | (2 pi) | 1/180 | pi | 1 | 0-1 | |
| | 2 | 2/360 | (2 pi) | 1/90 | pi | 1 | 1-2 | |
| | 3 | 3/360 | (2 pi) | 1/60 | pi | 1 | 2-3 | |
| | 4 | 4/360 | (2 pi) | 1/45 | pi | 1 | 3-4 | |
| | 5 | 5/360 | (2 pi) | 1/36 | pi | 1 | 4-5 | |
| | 6 | 6/360 | (2 pi) | 1/30 | pi | 1 | 5-6 | |
| | 7 | 7/360 | (2 pi) | 7/180 | pi | 1 | 6-7 | |
| | 8 | 8/360 | (2 pi) | 2/45 | pi | 1 | 7-8 | |
| | 9 | 9/360 | (2 pi) | 1/20 | pi | 1 | 8-9 | |
| 1/36 C | 10 | 10/360 | (2 pi) | 1/18 | pi | 1 | 9-10 | 1st 10 of 1st Q |
| | 11 | 11/360 | (2 pi) | 11/180 | pi | 1 | 10-11 | |
| | 12 | 12/360 | (2 pi) | 1/15 | pi | 1 | 11-12 | |
| | 13 | 13/360 | (2 pi) | 13/180 | pi | 1 | 12-13 | |
| | 14 | 14/360 | (2 pi) | 7/90 | pi | 1 | 13-14 | |
| | 15 | 15/360 | (2 pi) | 1/12 | pi | 1 | 14-15 | |
| | 16 | 16/360 | (2 pi) | 4/45 | pi | 1 | 15-16 | |
| | 17 | 17/360 | (2 pi) | 17/180 | pi | 1 | 16-17 | |
| | 18 | 18/360 | (2 pi) | 1/10 | pi | 1 | 17-18 | |
| | 19 | 19/360 | (2 pi) | 19/180 | pi | 1 | 18-19 | |
| | 20 | 20/360 | (2 pi) | 1/9 | pi | 1 | 19-20 | |
| | 21 | 21/360 | (2 pi) | 7/60 | pi | 1 | 20-21 | |
| | 22 | 22/360 | (2 pi) | 11/90 | pi | 1 | 21-22 | |
| | 23 | 23/360 | (2 pi) | 23/180 | pi | 1 | 22-23 | |
| | 24 | 24/360 | (2 pi) | 2/15 | pi | 1 | 23-24 | |
| | 25 | 25/360 | (2 pi) | 5/36 | pi | 1 | 24-25 | |
| | 26 | 26/360 | (2 pi) | 13/90 | pi | 1 | 25-26 | |
| | 27 | 27/360 | (2 pi) | 3/20 | pi | 1 | 26-27 | |
| | 28 | 28/360 | (2 pi) | 7/45 | pi | 1 | 27-28 | |
| | 29 | 29/360 | (2 pi) | 29/180 | pi | 1 | 28-29 | |
| 1/12 C | 30 | 30/360 | (2 pi) | ⅙ | pi | 1 | 29-30 | ⅓ 1st Q |
| | 31 | 31/360 | (2 pi) | 31/180 | pi | 1 | 30-31 | |
| | 32 | 32/360 | (2 pi) | 8/45 | pi | 1 | 31-32 | |
| | 33 | 33/360 | (2 pi) | 11/60 | pi | 1 | 32-33 | |
| | 34 | 34/360 | (2 pi) | 17/90 | pi | 1 | 33-34 | |
| | 35 | 35/360 | (2 pi) | 7/36 | pi | 1 | 34-35 | |
| | 36 | 36/360 | (2 pi) | ⅕ | pi | 1 | 35-36 | |
| | 37 | 37/360 | (2 pi) | 37/180 | pi | 1 | 36-37 | |
| | 38 | 38/360 | (2 pi) | 19/90 | pi | 1 | 37-38 | |
| | 39 | 39/360 | (2 pi) | 13/60 | pi | 1 | 38-39 | |
| | 40 | 40/360 | (2 pi) | 2/9 | pi | 1 | 39-40 | |
| | 41 | 41/360 | (2 pi) | 41/180 | pi | 1 | 40-41 | |
| | 42 | 42/360 | (2 pi) | 7/30 | pi | 1 | 41-42 | |
| | 43 | 43/360 | (2 pi) | 43/180 | pi | 1 | 42-43 | |
| | 44 | 44/360 | (2 pi) | 11/45 | pi | 1 | 43-44 | |
| ⅛ C | 45 | 45/360 | (2 pi) | ¼ | pi | 1 | 44-45 | 1/2 of 1st Q |

TABLE 4
Prototype Displacement Precision: Face Ht. = 3″. ¾ - 10 UNC, Roller Dia. = 2″. Track L = 11″

| | | | | | | | | |
|---|---|---|---|---|---|---|---|---|
| | | | Precision | Precision | Pecision | Precision | Precision | Precision |
| Crank (C) | | | Per Full C | Per ¼ C | Per ⅛ C | Per 1/12 C | Per 1/36 C | 1/360 C |
| Full 360/C | X_{b} | Y_{b} | (360 deg) | (90 deg) | (45 deg) | (30 deg) | (10 deg) | (1 degree) |

Table 4-1: X_{b} = 1.0 to 2.0

| | | | | | | | | |
|---|---|---|---|---|---|---|---|---|
| 0 | 1 | −0.75 | start | start | start | start | start | start |
| 1 | 1.1 | −0.72 | 0.030 | 0.00750 | 0.00375 | 0.00250 | 0.00083 | 0.000083 |
| 2 | 1.2 | −0.68 | 0.040 | 0.01000 | 0.00500 | 0.00333 | 0.00111 | 0.000111 |
| 3 | 1.3 | −0.63 | 0.050 | 0.01250 | 0.00625 | 0.00417 | 0.00139 | 0.000139 |
| 4 | 1.4 | −0.57 | 0.060 | 0.01500 | 0.00750 | 0.00500 | 0.00167 | 0.000167 |
| 5 | 1.5 | −0.50 | 0.070 | 0.01750 | 0.00875 | 0.00583 | 0.00194 | 0.000194 |
| 6 | 1.6 | −0.42 | 0.080 | 0.02000 | 0.01000 | 0.00667 | 0.00222 | 0.000222 |
| 7 | 1.7 | −0.33 | 0.090 | 0.02250 | 0.01125 | 0.00750 | 0.00250 | 0.000250 |
| 8 | 1.8 | −0.23 | 0.100 | 0.02500 | 0.01250 | 0.00833 | 0.00278 | 0.000278 |
| 9 | 1.9 | −0.12 | 0.110 | 0.02750 | 0.01375 | 0.00917 | 0.00306 | 0.000306 |
| 10 | 2 | 0 | 0.120 | 0.03000 | 0.01500 | 0.01000 | 0.00333 | 0.000333 |

| | | | | | | |
|---|---|---|---|---|---|---|
| Average Precision per Crank: | 0.075 | 0.019 | 0.009 | 0.006 | 0.002 | 0.000208 |
| (Avg. ppc) | (inch/Full C) | (inch/¼ C) | (inch/⅛ C) | (inch/ 1/12 C) | (inch/ 1/36 C) | (inch/ 1/360 C) |

Table 4-2: X_{b} = 2.0 to 3.0

| | | | | | | | | |
|---|---|---|---|---|---|---|---|---|
| 10 | 2 | 0 | 0 | 0.00000 | 0.00000 | 0.00000 | 0.00000 | 0.000000 |
| 11 | 2.1 | 0.02 | 0.020 | 0.00500 | 0.00250 | 0.00167 | 0.00056 | 0.000056 |
| 12 | 2.2 | 0.04 | 0.020 | 0.00500 | 0.00250 | 0.00167 | 0.00056 | 0.000056 |
| 13 | 2.3 | 0.06 | 0.020 | 0.00500 | 0.00250 | 0.00167 | 0.00056 | 0.000056 |
| 14 | 2.4 | 0.08 | 0.020 | 0.00500 | 0.00250 | 0.00167 | 0.00056 | 0.000056 |
| 15 | 2.5 | 0.10 | 0.020 | 0.00500 | 0.00250 | 0.00167 | 0.00056 | 0.000056 |
| 16 | 2.6 | 0.13 | 0.030 | 0.00750 | 0.00375 | 0.00250 | 0.00083 | 0.000083 |
| 17 | 2.7 | 0.16 | 0.030 | 0.00750 | 0.00375 | 0.00250 | 0.00083 | 0.000083 |
| 18 | 2.8 | 0.19 | 0.030 | 0.00750 | 0.00375 | 0.00250 | 0.00083 | 0.000083 |
| 19 | 2.9 | 0.22 | 0.030 | 0.00750 | 0.00375 | 0.00250 | 0.00083 | 0.000083 |
| 20 | 3 | 0.25 | 0.030 | 0.00750 | 0.00375 | 0.00250 | 0.00083 | 0.000083 |

| | | | | | | |
|---|---|---|---|---|---|---|
| Average Precision per Crank: | 0.025 | 0.006 | 0.003 | 0.002 | 0.0007 | 0.000069 |
| (Avg. ppc) | (inch/Full C) | (inch/¼ C) | (inch/⅛ C) | (inch/ 1/12 C) | (inch/ 1/36 C) | (inch/ 1/360 C) |

Table 4-3: X_{b} = 3.0 to 4.0

| | | | | | | | | |
|---|---|---|---|---|---|---|---|---|
| 20 | 3 | 0.25 | 0.000 | 0.00000 | 0.00000 | 0.00000 | 0.00000 | 0.000000 |
| 21 | 3.1 | 0.27 | 0.020 | 0.00500 | 0.00250 | 0.00167 | 0.00056 | 0.000056 |
| 22 | 3.2 | 0.29 | 0.020 | 0.00500 | 0.00250 | 0.00167 | 0.00056 | 0.000056 |
| 23 | 3.3 | 0.32 | 0.030 | 0.00750 | 0.00375 | 0.00250 | 0.00083 | 0.000083 |
| 24 | 3.4 | 0.34 | 0.020 | 0.00500 | 0.00250 | 0.00167 | 0.00056 | 0.000056 |
| 25 | 3.5 | 0.36 | 0.020 | 0.00500 | 0.00250 | 0.00167 | 0.00056 | 0.000056 |
| 26 | 3.6 | 0.39 | 0.030 | 0.00750 | 0.00375 | 0.00250 | 0.00083 | 0.000083 |
| 27 | 3.7 | 0.42 | 0.030 | 0.00750 | 0.00375 | 0.00250 | 0.00083 | 0.000083 |
| 28 | 3.8 | 0.44 | 0.020 | 0.00500 | 0.00250 | 0.00167 | 0.00056 | 0.000056 |
| 29 | 3.9 | 0.47 | 0.030 | 0.00750 | 0.00375 | 0.00250 | 0.00083 | 0.000083 |
| 30 | 4 | 0.5 | 0.030 | 0.00750 | 0.00375 | 0.00250 | 0.00083 | 0.000083 |

| | | | | | | |
|---|---|---|---|---|---|---|
| Average Precision per Crank: | 0.025 | 0.006 | 0.003 | 0.002 | 0.0007 | 0.000069 |
| (Avg. ppc) | (inch/Full C) | (inch/¼ C) | (inch/⅛ C) | (inch/ 1/12 C) | (inch/ 1/36 C) | (inch/ 1/360 C) |

Table 4-4: X_{b} = 4.0 to 5.0

| | | | | | | | | |
|---|---|---|---|---|---|---|---|---|
| 30 | 4 | 0.5 | 0.000 | 0.00000 | 0.00000 | 0.00000 | 0.00000 | 0.000000 |
| 31 | 4.1 | 0.54 | 0.040 | 0.01000 | 0.00500 | 0.00333 | 0.00111 | 0.000111 |
| 32 | 4.2 | 0.59 | 0.050 | 0.01250 | 0.00625 | 0.00417 | 0.00139 | 0.000139 |
| 33 | 4.3 | 0.63 | 0.040 | 0.01000 | 0.00500 | 0.00333 | 0.00111 | 0.000111 |
| 34 | 4.4 | 0.68 | 0.050 | 0.01250 | 0.00625 | 0.00417 | 0.00139 | 0.000139 |
| 35 | 4.5 | 0.73 | 0.050 | 0.01250 | 0.00625 | 0.00417 | 0.00139 | 0.000139 |
| 36 | 4.6 | 0.78 | 0.050 | 0.01250 | 0.00625 | 0.00417 | 0.00139 | 0.000139 |
| 37 | 4.7 | 0.83 | 0.050 | 0.01250 | 0.00625 | 0.00417 | 0.00139 | 0.000139 |
| 38 | 4.8 | 0.89 | 0.060 | 0.01500 | 0.00750 | 0.00500 | 0.00167 | 0.000167 |
| 39 | 4.9 | 0.94 | 0.050 | 0.01250 | 0.00625 | 0.00417 | 0.00139 | 0.000139 |
| 40 | 5 | 1 | 0.060 | 0.01500 | 0.00750 | 0.00500 | 0.00167 | 0.000167 |

| | | | | | | |
|---|---|---|---|---|---|---|
| Average Precision per Crank: | 0.050 | 0.013 | 0.006 | 0.004 | 0.0014 | 0.000139 |
| (Avg. ppc) | (inch/Full C) | (inch/¼ C) | (inch/⅛ C) | (inch/ 1/12 C) | (inch/ 1/36 C) | (inch/ 1/360 C) |

Table 4-5: X_{b} = 5.0 to 6.0

| | | | | | | | | |
|---|---|---|---|---|---|---|---|---|
| 40 | 5 | 1 | 0.000 | 0.00000 | 0.00000 | 0.00000 | 0.00000 | 0.000000 |
| 41 | 5.1 | 1.04 | 0.040 | 0.01000 | 0.00500 | 0.00333 | 0.00111 | 0.000111 |
| 42 | 5.2 | 1.09 | 0.050 | 0.01250 | 0.00625 | 0.00417 | 0.00139 | 0.000139 |
| 43 | 5.3 | 1.14 | 0.050 | 0.01250 | 0.00625 | 0.00417 | 0.00139 | 0.000139 |
| 44 | 5.4 | 1.19 | 0.050 | 0.01250 | 0.00625 | 0.00417 | 0.00139 | 0.000139 |
| 45 | 5.5 | 1.24 | 0.050 | 0.01250 | 0.00625 | 0.00417 | 0.00139 | 0.000139 |
| 46 | 5.6 | 1.29 | 0.050 | 0.01250 | 0.00625 | 0.00417 | 0.00139 | 0.000139 |
| 47 | 5.7 | 1.34 | 0.050 | 0.01250 | 0.00625 | 0.00417 | 0.00139 | 0.000139 |
| 48 | 5.8 | 1.39 | 0.050 | 0.01250 | 0.00625 | 0.00417 | 0.00139 | 0.000139 |
| 49 | 5.9 | 1.45 | 0.060 | 0.01500 | 0.00750 | 0.00500 | 0.00167 | 0.000167 |
| 50 | 6 | 1.5 | 0.050 | 0.01250 | 0.00625 | 0.00417 | 0.00139 | 0.000139 |

| | | | | | | |
|---|---|---|---|---|---|---|
| Average Precision per Crank: | 0.050 | 0.013 | 0.006 | 0.004 | 0.0014 | 0.000139 |
| (Avg. ppc) | (inch/Full C) | (inch/¼ C) | (inch/⅛ C) | (inch/ 1/12 C) | (inch/ 1/36 C) | (inch/ 1/360 C) |

Table 4-6: X_{b} = 6.0 to 7.0

| | | | | | | | | |
|---|---|---|---|---|---|---|---|---|
| 50 | 6 | 1.5 | 0.000 | 0.00000 | 0.00000 | 0.00000 | 0.00000 | 0.000000 |
| 51 | 6.1 | 1.61 | 0.110 | 0.02750 | 0.01375 | 0.00917 | 0.00306 | 0.000306 |
| 52 | 6.2 | 1.72 | 0.110 | 0.02750 | 0.01375 | 0.00917 | 0.00306 | 0.000306 |
| 53 | 6.3 | 1.84 | 0.120 | 0.03000 | 0.01500 | 0.01000 | 0.00333 | 0.000333 |
| 54 | 6.4 | 1.96 | 0.120 | 0.03000 | 0.01500 | 0.01000 | 0.00333 | 0.000333 |
| 55 | 6.5 | 2.08 | 0.120 | 0.03000 | 0.01500 | 0.01000 | 0.00333 | 0.000333 |
| 56 | 6.6 | 2.21 | 0.130 | 0.03250 | 0.01625 | 0.01083 | 0.00361 | 0.000361 |
| 57 | 6.7 | 2.34 | 0.130 | 0.03250 | 0.01625 | 0.01083 | 0.00361 | 0.000361 |
| 58 | 6.8 | 2.47 | 0.130 | 0.03250 | 0.01625 | 0.01083 | 0.00361 | 0.000361 |
| 59 | 6.9 | 2.61 | 0.140 | 0.03500 | 0.01750 | 0.01167 | 0.00389 | 0.000389 |
| 60 | 7 | 2.75 | 0.140 | 0.03500 | 0.01750 | 0.01167 | 0.00389 | 0.000389 |

| | | | | | | |
|---|---|---|---|---|---|---|
| Average Precision per Crank: | 0.125 | 0.031 | 0.016 | 0.010 | 0.0035 | 0.000347 |
| (Avg. ppc) | (inch/Full C) | (inch/¼ C) | (inch/⅛ C) | (inch/ 1/12 C) | (inch/ 1/36 C) | (inch/ 1/360 C) |

Table 4-7: X_{b} = 7.0 to 8.0

| | | | | | | | | |
|---|---|---|---|---|---|---|---|---|
| 60 | 7 | 2.75 | 0.070 | 0.01750 | 0.00875 | 0.00583 | 0.00194 | 0.000194 |
| 61 | 7.1 | 2.86 | 0.110 | 0.02750 | 0.01375 | 0.00917 | 0.00306 | 0.000306 |
| 62 | 7.2 | 2.98 | 0.120 | 0.03000 | 0.01500 | 0.01000 | 0.00333 | 0.000333 |
| 63 | 7.3 | 3.10 | 0.120 | 0.03000 | 0.01500 | 0.01000 | 0.00333 | 0.000333 |
| 64 | 7.4 | 3.22 | 0.120 | 0.03000 | 0.01500 | 0.01000 | 0.00333 | 0.000333 |
| 65 | 7.5 | 3.34 | 0.120 | 0.03000 | 0.01500 | 0.01000 | 0.00333 | 0.000333 |
| 66 | 7.6 | 3.47 | 0.130 | 0.03250 | 0.01625 | 0.01083 | 0.00361 | 0.000361 |
| 67 | 7.7 | 3.60 | 0.130 | 0.03250 | 0.01625 | 0.01083 | 0.00361 | 0.000361 |
| 68 | 7.8 | 3.73 | 0.130 | 0.03250 | 0.01625 | 0.01083 | 0.00361 | 0.000361 |
| 69 | 7.9 | 3.86 | 0.130 | 0.03250 | 0.01625 | 0.01083 | 0.00361 | 0.000361 |
| 70 | 8 | 4 | 0.140 | 0.03500 | 0.01750 | 0.01167 | 0.00389 | 0.000389 |

| | | | | | | |
|---|---|---|---|---|---|---|
| Average Precision per Crank: | 0.125 | 0.031 | 0.016 | 0.010 | 0.0035 | 0.000347 |
| (Avg. ppc) | (inch/Full C) | (inch/¼ C) | (inch/⅛ C) | (inch/ 1/12 C) | (inch/ 1/36 C) | (inch/ 1/360 C) |

TABLE 5
Full Size PEMD Displacement Precision: Face Ht. = 3″, Special ¾-40 UNS, Roller Dia. = 2″. Track L = 11″

| | | | | | | | | |
|---|---|---|---|---|---|---|---|---|
| | | | Precision | Precision | Pecision | Precision | Precision | Precision |
| Crank (C) | | | Per Full C | Per ¼ C | Per ⅛ C | Per 1/12 C | Per 1/36 C | 1/360 C |
| Full 360/C | X_{b} | Y_{b} | (360 deg) | (90 deg) | (45 deg) | (30 deg) | (10 deg) | (1 degree) |

Table 5-1: X_{b} = 1.0, 1.025, 1.050, to 1.25

| | | | | | | | | |
|---|---|---|---|---|---|---|---|---|
| 0 | 1 | −0.75 | start | start | start | start | start | start |
| 1 | 1.025 | −0.7433 | 0.00670 | 0.00168 | 0.00084 | 0.00056 | 0.00019 | 0.000019 |
| 2 | 1.050 | −0.7359 | 0.00740 | 0.00185 | 0.00092 | 0.00062 | 0.00021 | 0.000021 |
| 3 | 1.075 | −0.7280 | 0.00790 | 0.00198 | 0.00099 | 0.00066 | 0.00022 | 0.000022 |
| 4 | 1.100 | −0.7194 | 0.00860 | 0.00215 | 0.00107 | 0.00072 | 0.00024 | 0.000024 |
| 5 | 1.125 | −0.7101 | 0.00930 | 0.00233 | 0.00116 | 0.00078 | 0.00026 | 0.000026 |
| 6 | 1.150 | −0.7003 | 0.00980 | 0.00245 | 0.00122 | 0.00082 | 0.00027 | 0.000027 |
| 7 | 1.175 | −0.6899 | 0.01040 | 0.00260 | 0.00130 | 0.00087 | 0.00029 | 0.000029 |
| 8 | 1.200 | −0.6788 | 0.01110 | 0.00278 | 0.00139 | 0.00093 | 0.00031 | 0.000031 |
| 9 | 1.225 | −0.6672 | 0.01160 | 0.00290 | 0.00145 | 0.00097 | 0.00032 | 0.000032 |
| 10 | 1.25 | −0.6549 | 0.01230 | 0.00307 | 0.00154 | 0.00103 | 0.00034 | 0.000034 |

| | | | | | | |
|---|---|---|---|---|---|---|
| Average Precision per Crank: | 0.010 | 0.0024 | 0.0012 | 0.0008 | 0.00026 | 0.000026 |
| | (inch/Full C) | (inch/ ¼ C) | (inch/ ⅛ C) | (inch/ 1/12 C) | (inch/ 1/36 C) | (inch/ 1/360 C) |

Table 5-2: X_{b} = 1.25, 1.275, 1.300, to 1.5 key 1-2

| | | | | | | | | |
|---|---|---|---|---|---|---|---|---|
| 10 | 1.25 | −0.6549 | 0.00000 | 0.00000 | 0.00000 | 0.00000 | 0.00000 | 0.000000 |
| 11 | 1.275 | −0.6421 | 0.01280 | 0.00320 | 0.00160 | 0.00107 | 0.00036 | 0.000036 |
| 12 | 1.300 | −0.6287 | 0.01340 | 0.00335 | 0.00168 | 0.00112 | 0.00037 | 0.000037 |
| 13 | 1.325 | −0.6147 | 0.01400 | 0.00350 | 0.00175 | 0.00117 | 0.00039 | 0.000039 |
| 14 | 1.350 | −0.6001 | 0.01460 | 0.00365 | 0.00183 | 0.00122 | 0.00041 | 0.000041 |
| 15 | 1.375 | −0.5849 | 0.01520 | 0.00380 | 0.00190 | 0.00127 | 0.00042 | 0.000042 |
| 16 | 1.400 | −0.5691 | 0.01580 | 0.00395 | 0.00197 | 0.00132 | 0.00044 | 0.000044 |
| 17 | 1.425 | −0.5527 | 0.01640 | 0.00410 | 0.00205 | 0.00137 | 0.00046 | 0.000046 |
| 18 | 1.450 | −0.5358 | 0.01690 | 0.00422 | 0.00211 | 0.00141 | 0.00047 | 0.000047 |
| 19 | 1.475 | −0.5182 | 0.01760 | 0.00440 | 0.00220 | 0.00147 | 0.00049 | 0.000049 |
| 20 | 1.5 | −0.5000 | 0.01820 | 0.00455 | 0.00228 | 0.00152 | 0.00051 | 0.000051 |

| | | | | | | |
|---|---|---|---|---|---|---|
| Average Precision per Crank: | 0.015 | 0.0039 | 0.0019 | 0.0013 | 0.00043 | 0.000043 |
| | (inch/Full C) | (inch/ ¼ C) | (inch/ ⅛ C) | (inch/ 1/12 C) | (inch/ 1/36 C) | (inch/ 1/360 C) |

Table 5-3: X_{b} = 1.5, 1.525, 1.550, to 1.75

| | | | | | | | | |
|---|---|---|---|---|---|---|---|---|
| 20 | 1.5 | −0.5000 | 0.00000 | 0.00000 | 0.00000 | 0.00000 | 0.00000 | 0.000000 |
| 21 | 1.525 | −0.4812 | 0.01880 | 0.00470 | 0.00235 | 0.00157 | 0.00052 | 0.000052 |
| 22 | 1.550 | −0.4618 | 0.01940 | 0.00485 | 0.00243 | 0.00162 | 0.00054 | 0.000054 |
| 23 | 1.575 | −0.4418 | 0.02000 | 0.00500 | 0.00250 | 0.00167 | 0.00056 | 0.000056 |
| 24 | 1.600 | −0.4212 | 0.02060 | 0.00515 | 0.00258 | 0.00172 | 0.00057 | 0.000057 |
| 25 | 1.625 | −0.4000 | 0.02120 | 0.00530 | 0.00265 | 0.00177 | 0.00059 | 0.000059 |
| 26 | 1.650 | −0.3780 | 0.02200 | 0.00550 | 0.00275 | 0.00183 | 0.00061 | 0.000061 |
| 27 | 1.675 | −0.3555 | 0.02250 | 0.00563 | 0.00281 | 0.00188 | 0.00063 | 0.000063 |
| 28 | 1.700 | −0.3323 | 0.02320 | 0.00580 | 0.00290 | 0.00193 | 0.00064 | 0.000064 |
| 29 | 1.725 | −0.3085 | 0.02380 | 0.00595 | 0.00298 | 0.00198 | 0.00066 | 0.000066 |
| 30 | 1.75 | −0.2840 | 0.02450 | 0.00613 | 0.00306 | 0.00204 | 0.00068 | 0.000068 |

| | | | | | | |
|---|---|---|---|---|---|---|
| Average Precision per Crank: | 0.022 | 0.0054 | 0.0027 | 0.0018 | 0.00060 | 0.000060 |
| | (inch/Full C) | (inch/ ¼ C) | (inch/ ⅛ C) | (inch/ 1/12 C) | (inch/ 1/36 C) | (inch/ 1/360 C) |

Table 5-4: X_{b} = 1.75, 1.775, 1.800, to 2.0 key 1-2

| | | | | | | | | |
|---|---|---|---|---|---|---|---|---|
| 30 | 1.75 | −0.2840 | 0.00000 | 0.00000 | 0.00000 | 0.00000 | 0.00000 | 0.000000 |
| 31 | 1.775 | −0.2588 | 0.02520 | 0.00630 | 0.00315 | 0.00210 | 0.00070 | 0.000070 |
| 32 | 1.800 | −0.2329 | 0.02590 | 0.00647 | 0.00324 | 0.00216 | 0.00072 | 0.000072 |
| 33 | 1.825 | −0.2064 | 0.02650 | 0.00663 | 0.00331 | 0.00221 | 0.00074 | 0.000074 |
| 34 | 1.850 | −0.1791 | 0.02730 | 0.00683 | 0.00341 | 0.00228 | 0.00076 | 0.000076 |
| 35 | 1.875 | −0.1512 | 0.02790 | 0.00698 | 0.00349 | 0.00233 | 0.00078 | 0.000078 |
| 36 | 1.900 | −0.1224 | 0.02880 | 0.00720 | 0.00360 | 0.00240 | 0.00080 | 0.000080 |
| 37 | 1.925 | −0.0930 | 0.02940 | 0.00735 | 0.00368 | 0.00245 | 0.00082 | 0.000082 |
| 38 | 1.950 | −0.0628 | 0.03020 | 0.00755 | 0.00378 | 0.00252 | 0.00084 | 0.000084 |
| 39 | 1.975 | −0.0318 | 0.03100 | 0.00775 | 0.00388 | 0.00258 | 0.00086 | 0.000086 |
| 40 | 2 | 0.0000 | 0.03180 | 0.00795 | 0.00398 | 0.00265 | 0.00088 | 0.000088 |

| | | | | | | |
|---|---|---|---|---|---|---|
| Average Precision per Crank: | 0.028 | 0.0071 | 0.0036 | 0.0024 | 0.00079 | 0.000079 |
| | (inch/Full C) | (inch/ ¼ C) | (inch/ ⅛ C) | (inch/ 1/12 C) | (inch/ 1/36 C) | (inch/ 1/360 C) |

Table 5-5: X_{b} = 2.0, 2.025, 2.050, to 2.25

| | | | | | | | | |
|---|---|---|---|---|---|---|---|---|
| 40 | 2 | 0.0000 | 0.00000 | 0.00000 | 0.00000 | 0.00000 | 0.00000 | 0.000000 |
| 41 | 2.025 | 0.0042 | 0.00420 | 0.00105 | 0.00053 | 0.00035 | 0.00012 | 0.000012 |
| 42 | 2.050 | 0.0085 | 0.00430 | 0.00108 | 0.00054 | 0.00036 | 0.00012 | 0.000012 |
| 43 | 2.075 | 0.0129 | 0.00440 | 0.00110 | 0.00055 | 0.00037 | 0.00012 | 0.000012 |
| 44 | 2.100 | 0.0174 | 0.00450 | 0.00113 | 0.00056 | 0.00038 | 0.00013 | 0.000013 |
| 45 | 2.125 | 0.0221 | 0.00470 | 0.00118 | 0.00059 | 0.00039 | 0.00013 | 0.000013 |
| 46 | 2.150 | 0.0268 | 0.00470 | 0.00118 | 0.00059 | 0.00039 | 0.00013 | 0.000013 |
| 47 | 2.175 | 0.0316 | 0.00480 | 0.00120 | 0.00060 | 0.00040 | 0.00013 | 0.000013 |
| 48 | 2.200 | 0.0366 | 0.00500 | 0.00125 | 0.00063 | 0.00042 | 0.00014 | 0.000014 |
| 49 | 2.225 | 0.0416 | 0.00500 | 0.00125 | 0.00063 | 0.00042 | 0.00014 | 0.000014 |
| 50 | 2.25 | 0.0467 | 0.00510 | 0.00128 | 0.00064 | 0.00043 | 0.00014 | 0.000014 |

| | | | | | | |
|---|---|---|---|---|---|---|
| Average Precision per Crank: | 0.005 | 0.0012 | 0.0006 | 0.0004 | 0.00013 | 0.000013 |
| | (inch/Full C) | (inch/ ¼ C) | (inch/ ⅛ C) | (inch/ 1/12 C) | (inch/ 1/36 C) | (inch/ 1/360 C) |

Table 5-6: X_{b} = 2.25, 2.275, 2.300, to 2.5 key 2-3

| | | | | | | | | |
|---|---|---|---|---|---|---|---|---|
| 50 | 2.25 | 0.0467 | 0.00000 | 0.00000 | 0.00000 | 0.00000 | 0.00000 | 0.000000 |
| 51 | 2.275 | 0.0520 | 0.00530 | 0.00133 | 0.00066 | 0.00044 | 0.00015 | 0.000015 |
| 52 | 2.300 | 0.0573 | 0.00530 | 0.00133 | 0.00066 | 0.00044 | 0.00015 | 0.000015 |
| 53 | 2.325 | 0.0628 | 0.00550 | 0.00138 | 0.00069 | 0.00046 | 0.00015 | 0.000015 |
| 54 | 2.350 | 0.0684 | 0.00560 | 0.00140 | 0.00070 | 0.00047 | 0.00016 | 0.000016 |
| 55 | 2.375 | 0.0740 | 0.00560 | 0.00140 | 0.00070 | 0.00047 | 0.00016 | 0.000016 |
| 56 | 2.400 | 0.0798 | 0.00580 | 0.00145 | 0.00073 | 0.00048 | 0.00016 | 0.000016 |
| 57 | 2.425 | 0.0857 | 0.00590 | 0.00148 | 0.00074 | 0.00049 | 0.00016 | 0.000016 |
| 58 | 2.450 | 0.0916 | 0.00590 | 0.00148 | 0.00074 | 0.00049 | 0.00016 | 0.000016 |
| 59 | 2.475 | 0.0977 | 0.00610 | 0.00153 | 0.00076 | 0.00051 | 0.00017 | 0.000017 |
| 60 | 2.5 | 0.1039 | 0.00620 | 0.00155 | 0.00078 | 0.00052 | 0.00017 | 0.000017 |

| | | | | | | |
|---|---|---|---|---|---|---|
| Average Precision per Crank: | 0.006 | 0.0014 | 0.0007 | 0.0005 | 0.00016 | 0.000016 |
| | (inch/Full C) | (inch/ ¼ C) | (inch/ ⅛ C) | (inch/ 1/12 C) | (inch/ 1/36 C) | (inch/ 1/360 C) |

Table 5-7: X_{b} = 2.5, 2.775, 2.800, to 2.75

| | | | | | | | | |
|---|---|---|---|---|---|---|---|---|
| 60 | 2.5 | 0.1039 | 0.00000 | 0.00000 | 0.00000 | 0.00000 | 0.00000 | 0.000000 |
| 61 | 2.525 | 0.1102 | 0.00630 | 0.00158 | 0.00079 | 0.00053 | 0.00018 | 0.000018 |
| 62 | 2.550 | 0.1166 | 0.00640 | 0.00160 | 0.00080 | 0.00053 | 0.00018 | 0.000018 |
| 63 | 2.575 | 0.1231 | 0.00650 | 0.00163 | 0.00081 | 0.00054 | 0.00018 | 0.000018 |
| 64 | 2.600 | 0.1297 | 0.00660 | 0.00165 | 0.00083 | 0.00055 | 0.00018 | 0.000018 |
| 65 | 2.625 | 0.1364 | 0.00670 | 0.00168 | 0.00084 | 0.00056 | 0.00019 | 0.000019 |
| 66 | 2.650 | 0.1432 | 0.00680 | 0.00170 | 0.00085 | 0.00057 | 0.00019 | 0.000019 |
| 67 | 2.675 | 0.1502 | 0.00700 | 0.00175 | 0.00088 | 0.00058 | 0.00019 | 0.000019 |
| 68 | 2.700 | 0.1572 | 0.00700 | 0.00175 | 0.00088 | 0.00058 | 0.00019 | 0.000019 |
| 69 | 2.725 | 0.1643 | 0.00710 | 0.00178 | 0.00089 | 0.00059 | 0.00020 | 0.000020 |
| 70 | 2.75 | 0.1716 | 0.00730 | 0.00183 | 0.00091 | 0.00061 | 0.00020 | 0.000020 |

| | | | | | | |
|---|---|---|---|---|---|---|
| Average Precision per Crank: | 0.007 | 0.0017 | 0.0008 | 0.0006 | 0.00019 | 0.000019 |
| | (inch/Full C) | (inch/ ¼ C) | (inch/ ⅛ C) | (inch/ 1/12 C) | (inch/ 1/36 C) | (inch/ 1/360 C) |

Table 5-8: X_{b} = 2.75, 2.775, 2.80, to 3.0 key 2-3

| | | | | | | | | |
|---|---|---|---|---|---|---|---|---|
| 70 | 2.75 | 0.1716 | 0.00000 | 0.00000 | 0.00000 | 0.00000 | 0.00000 | 0.000000 |
| 71 | 2.775 | 0.1789 | 0.00730 | 0.00183 | 0.00091 | 0.00061 | 0.00020 | 0.000020 |
| 72 | 2.800 | 0.1864 | 0.00750 | 0.00188 | 0.00094 | 0.00063 | 0.00021 | 0.000021 |
| 73 | 2.825 | 0.1939 | 0.00750 | 0.00187 | 0.00094 | 0.00062 | 0.00021 | 0.000021 |
| 74 | 2.850 | 0.2016 | 0.00770 | 0.00193 | 0.00096 | 0.00064 | 0.00021 | 0.000021 |
| 75 | 2.875 | 0.2094 | 0.00780 | 0.00195 | 0.00098 | 0.00065 | 0.00022 | 0.000022 |
| 76 | 2.900 | 0.2172 | 0.00780 | 0.00195 | 0.00098 | 0.00065 | 0.00022 | 0.000022 |
| 77 | 2.925 | 0.2252 | 0.00800 | 0.00200 | 0.00100 | 0.00067 | 0.00022 | 0.000022 |
| 78 | 2.950 | 0.2333 | 0.00810 | 0.00203 | 0.00101 | 0.00068 | 0.00023 | 0.000023 |
| 79 | 2.975 | 0.2415 | 0.00820 | 0.00205 | 0.00103 | 0.00068 | 0.00023 | 0.000023 |
| 80 | 3 | 0.250 | 0.00830 | 0.00208 | 0.00104 | 0.00069 | 0.00023 | 0.000023 |

| | | | | | | |
|---|---|---|---|---|---|---|
| Average Precision per Crank: | 0.008 | 0.0020 | 0.0010 | 0.0007 | 0.00022 | 0.000022 |
| | (inch/Full C) | (inch/ ¼ C) | (inch/ ⅛ C) | (inch/ 1/12 C) | (inch/ 1/36 C) | (inch/ 1/360 C) |

Table 5-9: X_{b} = 3.0, 1 + 81/40, 1 + 82/40, to 3.25

| | | | | | | | | |
|---|---|---|---|---|---|---|---|---|
| 80 | 3 | 0.2500 | 0.00000 | 0.00000 | 0.00000 | 0.00000 | 0.00000 | 0.000000 |
| 81 | 3.025 | 0.2550 | 0.00500 | 0.00125 | 0.00063 | 0.00042 | 0.00014 | 0.000014 |
| 82 | 3.050 | 0.2603 | 0.00530 | 0.00132 | 0.00066 | 0.00044 | 0.00015 | 0.000015 |
| 83 | 3.075 | 0.2656 | 0.00530 | 0.00133 | 0.00066 | 0.00044 | 0.00015 | 0.000015 |
| 84 | 3.100 | 0.2710 | 0.00540 | 0.00135 | 0.00068 | 0.00045 | 0.00015 | 0.000015 |
| 85 | 3.125 | 0.2764 | 0.00540 | 0.00135 | 0.00067 | 0.00045 | 0.00015 | 0.000015 |
| 86 | 3.150 | 0.2819 | 0.00550 | 0.00138 | 0.00069 | 0.00046 | 0.00015 | 0.000015 |
| 87 | 3.175 | 0.2874 | 0.00550 | 0.00138 | 0.00069 | 0.00046 | 0.00015 | 0.000015 |
| 88 | 3.200 | 0.2930 | 0.00560 | 0.00140 | 0.00070 | 0.00047 | 0.00016 | 0.000016 |
| 89 | 3.225 | 0.2987 | 0.00570 | 0.00143 | 0.00071 | 0.00048 | 0.00016 | 0.000016 |
| 90 | 3.25 | 0.3044 | 0.00570 | 0.00143 | 0.00071 | 0.00047 | 0.00016 | 0.000016 |

| | | | | | | |
|---|---|---|---|---|---|---|
| Average Precision per Crank: | 0.005 | 0.0014 | 0.0007 | 0.0005 | 0.00015 | 0.000015 |
| | (inch/Full C) | (inch/ ¼ C) | (inch/ ⅛ C) | (inch/ 1/12 C) | (inch/ 1/36 C) | (inch/ 1/360 C) |

Table 5-10: X_{b} = 3.25, 1 + 91/40, 1 + 92/40, to 3.5 key 3-4

| | | | | | | | | |
|---|---|---|---|---|---|---|---|---|
| 90 | 3.25 | 0.3044 | 0.00000 | 0.00000 | 0.00000 | 0.00000 | 0.00000 | 0.000000 |
| 91 | 3.275 | 0.3100 | 0.00560 | 0.00140 | 0.00070 | 0.00047 | 0.00016 | 0.000016 |
| 92 | 3.300 | 0.3159 | 0.00590 | 0.00148 | 0.00074 | 0.00049 | 0.00016 | 0.000016 |
| 93 | 3.325 | 0.3217 | 0.00580 | 0.00145 | 0.00072 | 0.00048 | 0.00016 | 0.000016 |
| 94 | 3.350 | 0.3276 | 0.00590 | 0.00148 | 0.00074 | 0.00049 | 0.00016 | 0.000016 |
| 95 | 3.375 | 0.3336 | 0.00600 | 0.00150 | 0.00075 | 0.00050 | 0.00017 | 0.000017 |
| 96 | 3.400 | 0.3396 | 0.00600 | 0.00150 | 0.00075 | 0.00050 | 0.00017 | 0.000017 |
| 97 | 2.425 | 0.3457 | 0.00610 | 0.00153 | 0.00076 | 0.00051 | 0.00017 | 0.000017 |
| 98 | 3.450 | 0.3518 | 0.00610 | 0.00153 | 0.00076 | 0.00051 | 0.00017 | 0.000017 |
| 99 | 3.475 | 0.3579 | 0.00610 | 0.00153 | 0.00076 | 0.00051 | 0.00017 | 0.000017 |
| 100 | 3.5 | 0.3642 | 0.00630 | 0.00158 | 0.00079 | 0.00053 | 0.00018 | 0.000018 |

| | | | | | | |
|---|---|---|---|---|---|---|
| Average Precision per Crank: | 0.006 | 0.0015 | 0.0007 | 0.0005 | 0.00017 | 0.000017 |
| | (inch/Full C) | (inch/ ¼ C) | (inch/ ⅛ C) | (inch/ 1/12 C) | (inch/ 1/36 C) | (inch/ 1/360 C) |

Table 5-11: X_{b} = 3.5, 1 + 101/40, 1 + 102/40, to 3.75

| | | | | | | | | |
|---|---|---|---|---|---|---|---|---|
| 100 | 3.5 | 0.3642 | 0.00000 | 0.00000 | 0.00000 | 0.00000 | 0.00000 | 0.000000 |
| 101 | 3.525 | 0.3705 | 0.00630 | 0.00157 | 0.00079 | 0.00052 | 0.00017 | 0.000017 |
| 102 | 3.550 | 0.3768 | 0.00630 | 0.00158 | 0.00079 | 0.00053 | 0.00018 | 0.000018 |
| 103 | 3.575 | 0.3831 | 0.00630 | 0.00157 | 0.00079 | 0.00052 | 0.00017 | 0.000017 |
| 104 | 3.600 | 0.3896 | 0.00650 | 0.00163 | 0.00081 | 0.00054 | 0.00018 | 0.000018 |
| 105 | 3.625 | 0.3960 | 0.00640 | 0.00160 | 0.00080 | 0.00053 | 0.00018 | 0.000018 |
| 106 | 3.650 | 0.4026 | 0.00660 | 0.00165 | 0.00082 | 0.00055 | 0.00018 | 0.000018 |
| 107 | 3.675 | 0.4092 | 0.00660 | 0.00165 | 0.00082 | 0.00055 | 0.00018 | 0.000018 |
| 108 | 3.700 | 0.4158 | 0.00660 | 0.00165 | 0.00082 | 0.00055 | 0.00018 | 0.000018 |
| 109 | 3.725 | 0.4225 | 0.00670 | 0.00168 | 0.00084 | 0.00056 | 0.00019 | 0.000019 |
| 110 | 3.75 | 0.4292 | 0.00670 | 0.00168 | 0.00084 | 0.00056 | 0.00019 | 0.000019 |

| | | | | | | |
|---|---|---|---|---|---|---|
| Average Precision per Crank: | 0.007 | 0.0016 | 0.0008 | 0.0005 | 0.00018 | 0.000018 |
| | (inch/Full C) | (inch/ ¼ C) | (inch/ ⅛ C) | (inch/ 1/12 C) | (inch/ 1/36 C) | (inch/ 1/360 C) |

Table 5-12: X_{b} = 3.75, 1 + 111/40, 1 + 112/40, to 4.0 key 3-4

| | | | | | | | | |
|---|---|---|---|---|---|---|---|---|
| 110 | 3.75 | 0.4292 | 0.00000 | 0.00000 | 0.00000 | 0.00000 | 0.00000 | 0.000000 |
| 111 | 3.775 | 0.4360 | 0.00680 | 0.00170 | 0.00085 | 0.00057 | 0.00019 | 0.000019 |
| 112 | 3.800 | 0.4429 | 0.00690 | 0.00173 | 0.00086 | 0.00058 | 0.00019 | 0.000019 |
| 113 | 3.825 | 0.4498 | 0.00690 | 0.00172 | 0.00086 | 0.00057 | 0.00019 | 0.000019 |
| 114 | 8.850 | 0.4568 | 0.00700 | 0.00175 | 0.00088 | 0.00058 | 0.00019 | 0.000019 |
| 115 | 3.875 | 0.4638 | 0.00700 | 0.00175 | 0.00088 | 0.00058 | 0.00019 | 0.000019 |
| 116 | 3.900 | 0.4708 | 0.00700 | 0.00175 | 0.00088 | 0.00058 | 0.00019 | 0.000019 |
| 117 | 3.925 | 0.4780 | 0.00720 | 0.00180 | 0.00090 | 0.00060 | 0.00020 | 0.000020 |
| 118 | 3.950 | 0.4851 | 0.00710 | 0.00178 | 0.00089 | 0.00059 | 0.00020 | 0.000020 |
| 119 | 3.975 | 0.4924 | 0.00730 | 0.00183 | 0.00091 | 0.00061 | 0.00020 | 0.000020 |
| 120 | 4 | 0.5000 | 0.00760 | 0.00190 | 0.00095 | 0.00063 | 0.00021 | 0.000021 |

| | | | | | | |
|---|---|---|---|---|---|---|
| Average Precision per Crank: | 0.007 | 0.0018 | 0.0009 | 0.0006 | 0.00020 | 0.000020 |
| | (inch/Full C) | (inch/ ¼ C) | (inch/ ⅛ C) | (inch/ 1/12 C) | (inch/ 1/36 C) | (inch/ 1/360 C) |

Table 5-13: X_{b} = 4.0, 1 + 121/40, 1 + 122/40, to 4.25

| | | | | | | | | |
|---|---|---|---|---|---|---|---|---|
| 120 | 4 | 0.5000 | 0.00000 | 0.00000 | 0.00000 | 0.00000 | 0.00000 | 0.000000 |
| 121 | 4.025 | 0.5102 | 0.01020 | 0.00255 | 0.00128 | 0.00085 | 0.00028 | 0.000028 |
| 122 | 4.050 | 0.5209 | 0.01070 | 0.00268 | 0.00134 | 0.00089 | 0.00030 | 0.000030 |
| 123 | 4.075 | 0.5317 | 0.01080 | 0.00270 | 0.00135 | 0.00090 | 0.00030 | 0.000030 |
| 124 | 4.100 | 0.5425 | 0.01080 | 0.00270 | 0.00135 | 0.00090 | 0.00030 | 0.000030 |
| 125 | 4.125 | 0.5535 | 0.01100 | 0.00275 | 0.00138 | 0.00092 | 0.00031 | 0.000031 |
| 126 | 4.150 | 0.5646 | 0.01110 | 0.00278 | 0.00139 | 0.00093 | 0.00031 | 0.000031 |
| 127 | 4.175 | 0.5757 | 0.01110 | 0.00278 | 0.00139 | 0.00093 | 0.00031 | 0.000031 |
| 128 | 4.200 | 0.5870 | 0.01130 | 0.00282 | 0.00141 | 0.00094 | 0.00031 | 0.000031 |
| 129 | 4.225 | 0.5983 | 0.01130 | 0.00283 | 0.00141 | 0.00094 | 0.00031 | 0.000031 |
| 130 | 4.25 | 0.6098 | 0.01150 | 0.00287 | 0.00144 | 0.00096 | 0.00032 | 0.000032 |

| | | | | | | |
|---|---|---|---|---|---|---|
| Average Precision per Crank: | 0.011 | 0.0027 | 0.0014 | 0.0009 | 0.00031 | 0.000031 |
| | (inch/Full C) | (inch/ ¼ C) | (inch/ ⅛ C) | (inch/ 1/12 C) | (inch/ 1/36 C) | (inch/ 1/360 C) |

Table 5-14: X_{b} = 4.25, 1 + 131/40, 1 + 132/40, to 4.5 key 4-5

| | | | | | | | | |
|---|---|---|---|---|---|---|---|---|
| 130 | 4.25 | 0.6098 | 0.00000 | 0.00000 | 0.00000 | 0.00000 | 0.00000 | 0.000000 |
| 131 | 4.275 | 0.6213 | 0.01150 | 0.00287 | 0.00144 | 0.00096 | 0.00032 | 0.000032 |
| 132 | 4.300 | 0.6330 | 0.01170 | 0.00293 | 0.00146 | 0.00098 | 0.00033 | 0.000033 |
| 133 | 4.325 | 0.6447 | 0.01170 | 0.00293 | 0.00146 | 0.00098 | 0.00033 | 0.000033 |
| 134 | 4.350 | 0.6566 | 0.01190 | 0.00297 | 0.00149 | 0.00099 | 0.00033 | 0.000033 |
| 135 | 4.375 | 0.6685 | 0.01190 | 0.00298 | 0.00149 | 0.00099 | 0.00033 | 0.000033 |
| 136 | 4.400 | 0.6805 | 0.01200 | 0.00300 | 0.00150 | 0.00100 | 0.00033 | 0.000033 |
| 137 | 4.425 | 0.6927 | 0.01220 | 0.00305 | 0.00153 | 0.00102 | 0.00034 | 0.000034 |
| 138 | 4.450 | 0.7049 | 0.01220 | 0.00305 | 0.00153 | 0.00102 | 0.00034 | 0.000034 |
| 139 | 4.475 | 0.7172 | 0.01230 | 0.00307 | 0.00154 | 0.00103 | 0.00034 | 0.000034 |
| 140 | 4.5 | 0.7296 | 0.01240 | 0.00310 | 0.00155 | 0.00103 | 0.00034 | 0.000034 |

| | | | | | | |
|---|---|---|---|---|---|---|
| Average Precision per Crank: | 0.012 | 0.0030 | 0.0015 | 0.0010 | 0.00033 | 0.000033 |
| | (inch/Full C) | (inch/ ¼ C) | (inch/ ⅛ C) | (inch/ 1/12 C) | (inch/ 1/36 C) | (inch/ 1/360 C) |

Table 5-15: X_{b} = 4.5, 1 + 141/40, 1 + 142/40, to 4.75

| | | | | | | | | |
|---|---|---|---|---|---|---|---|---|
| 140 | 4.5 | 0.7296 | 0.00000 | 0.00000 | 0.00000 | 0.00000 | 0.00000 | 0.000000 |
| 141 | 4.525 | 0.7422 | 0.01260 | 0.00315 | 0.00157 | 0.00105 | 0.00035 | 0.000035 |
| 142 | 4.550 | 0.7548 | 0.01260 | 0.00315 | 0.00158 | 0.00105 | 0.00035 | 0.000035 |
| 143 | 4.575 | 0.7675 | 0.01270 | 0.00317 | 0.00159 | 0.00106 | 0.00035 | 0.000035 |
| 144 | 4.600 | 0.7803 | 0.01280 | 0.00320 | 0.00160 | 0.00107 | 0.00036 | 0.000036 |
| 145 | 4.625 | 0.7933 | 0.01300 | 0.00325 | 0.00163 | 0.00108 | 0.00036 | 0.000036 |
| 146 | 4.650 | 0.8063 | 0.01300 | 0.00325 | 0.00163 | 0.00108 | 0.00036 | 0.000036 |
| 147 | 4.675 | 0.8194 | 0.01310 | 0.00328 | 0.00164 | 0.00109 | 0.00036 | 0.000036 |
| 148 | 4.700 | 0.8326 | 0.01320 | 0.00330 | 0.00165 | 0.00110 | 0.00037 | 0.000037 |
| 149 | 4.725 | 0.8459 | 0.01330 | 0.00332 | 0.00166 | 0.00111 | 0.00037 | 0.000037 |
| 150 | 4.75 | 0.8594 | 0.01350 | 0.00338 | 0.00169 | 0.00113 | 0.00038 | 0.000038 |

| | | | | | | |
|---|---|---|---|---|---|---|
| Average Precision per Crank: | 0.013 | 0.0032 | 0.0016 | 0.0011 | 0.00036 | 0.000036 |
| | (inch/Full C) | (inch/ ¼ C) | (inch/ ⅛ C) | (inch/ 1/12 C) | (inch/ 1/36 C) | (inch/ 1/360 C) |

Table 5-16: X_{b} = 4.75, 1 + 151/40, 1 + 152/40, to 5.0 key 4-5

| | | | | | | | | |
|---|---|---|---|---|---|---|---|---|
| 150 | 4.75 | 0.8594 | 0.00000 | 0.00000 | 0.00000 | 0.00000 | 0.00000 | 0.000000 |
| 151 | 4.775 | 0.8729 | 0.01350 | 0.00337 | 0.00169 | 0.00113 | 0.00037 | 0.000037 |
| 152 | 4.800 | 0.8865 | 0.01360 | 0.00340 | 0.00170 | 0.00113 | 0.00038 | 0.000038 |
| 153 | 4.825 | 0.9002 | 0.01370 | 0.00343 | 0.00171 | 0.00114 | 0.00038 | 0.000038 |
| 154 | 4.850 | 0.9141 | 0.01390 | 0.00348 | 0.00174 | 0.00116 | 0.00039 | 0.000039 |
| 155 | 4.875 | 0.9280 | 0.01390 | 0.00348 | 0.00174 | 0.00116 | 0.00039 | 0.000039 |
| 156 | 4.900 | 0.9420 | 0.01400 | 0.00350 | 0.00175 | 0.00117 | 0.00039 | 0.000039 |
| 157 | 4.925 | 0.9561 | 0.01410 | 0.00353 | 0.00176 | 0.00118 | 0.00039 | 0.000039 |
| 158 | 4.950 | 0.9703 | 0.01420 | 0.00355 | 0.00178 | 0.00118 | 0.00039 | 0.000039 |
| 159 | 4.975 | 0.9847 | 0.01440 | 0.00360 | 0.00180 | 0.00120 | 0.00040 | 0.000040 |
| 160 | 5 | 1.0000 | 0.01530 | 0.00383 | 0.00191 | 0.00128 | 0.00042 | 0.000042 |

| | | | | | | |
|---|---|---|---|---|---|---|
| Average Precision per Crank: | 0.014 | 0.0035 | 0.0018 | 0.0012 | 0.00039 | 0.000039 |
| | (inch/Full C) | (inch/ ¼ C) | (inch/ ⅛ C) | (inch/ 1/12 C) | (inch/ 1/36 C) | (inch/ 1/360 C) |

Table 5-17: X_{b} = 5.0, 1 + 161/40, 1 + 162/40, to 5.25

| | | | | | | | | |
|---|---|---|---|---|---|---|---|---|
| 160 | 5 | 1.0000 | 0.00000 | 0.00000 | 0.00000 | 0.00000 | 0.00000 | 0.000000 |
| 161 | 5.025 | 1.0103 | 0.01030 | 0.00257 | 0.00129 | 0.00086 | 0.00029 | 0.000029 |
| 162 | 5.050 | 1.0216 | 0.01130 | 0.00283 | 0.00141 | 0.00094 | 0.00031 | 0.000031 |
| 163 | 5.075 | 1.0330 | 0.01140 | 0.00285 | 0.00142 | 0.00095 | 0.00032 | 0.000032 |
| 164 | 5.100 | 1.0444 | 0.01140 | 0.00285 | 0.00143 | 0.00095 | 0.00032 | 0.000032 |
| 165 | 6.125 | 1.0559 | 0.01150 | 0.00288 | 0.00144 | 0.00096 | 0.00032 | 0.000032 |
| 166 | 5.150 | 1.0674 | 0.01150 | 0.00287 | 0.00144 | 0.00096 | 0.00032 | 0.000032 |
| 167 | 5.175 | 1.0790 | 0.01160 | 0.00290 | 0.00145 | 0.00097 | 0.00032 | 0.000032 |
| 168 | 5.200 | 1.0907 | 0.01170 | 0.00293 | 0.00146 | 0.00098 | 0.00033 | 0.000033 |
| 169 | 5.225 | 1.1024 | 0.01170 | 0.00293 | 0.00146 | 0.00098 | 0.00033 | 0.000033 |
| 170 | 5.25 | 1.1142 | 0.01180 | 0.00295 | 0.00148 | 0.00098 | 0.00033 | 0.000033 |

| | | | | | | |
|---|---|---|---|---|---|---|
| Average Precision per Crank: | 0.011 | 0.0029 | 0.0014 | 0.0010 | 0.00032 | 0.000032 |
| | (inch/Full C) | (inch/ ¼ C) | (inch/⅛ C) | (inch/ 1/12 C) | (inch/ 1/36 C) | (inch/ 1/360 C) |

Table 5-18: X_{b} = 5.25, 1 + 171/40, 1 + 172/40, to 5.5 key 5-6

| | | | | | | | | |
|---|---|---|---|---|---|---|---|---|
| 170 | 5.25 | 1.1142 | 0.00000 | 0.00000 | 0.00000 | 0.00000 | 0.00000 | 0.000000 |
| 171 | 5.275 | 1.1261 | 0.01190 | 0.00298 | 0.00149 | 0.00099 | 0.00033 | 0.000033 |
| 172 | 5.300 | 1.1381 | 0.01200 | 0.00300 | 0.00150 | 0.00100 | 0.00033 | 0.000033 |
| 173 | 5.325 | 1.1501 | 0.01200 | 0.00300 | 0.00150 | 0.00100 | 0.00033 | 0.000033 |
| 174 | 5.350 | 1.1621 | 0.01200 | 0.00300 | 0.00150 | 0.00100 | 0.00033 | 0.000033 |
| 175 | 5.375 | 1.1743 | 0.01220 | 0.00305 | 0.00153 | 0.00102 | 0.00034 | 0.000034 |
| 176 | 5.400 | 1.1865 | 0.01220 | 0.00305 | 0.00153 | 0.00102 | 0.00034 | 0.000034 |
| 177 | 5.425 | 1.1987 | 0.01220 | 0.00305 | 0.00153 | 0.00102 | 0.00034 | 0.000034 |
| 178 | 5.450 | 1.2111 | 0.01240 | 0.00310 | 0.00155 | 0.00103 | 0.00034 | 0.000034 |
| 179 | 5.475 | 1.2235 | 0.01240 | 0.00310 | 0.00155 | 0.00103 | 0.00034 | 0.000034 |
| 180 | 5.5 | 1.2359 | 0.01240 | 0.00310 | 0.00155 | 0.00103 | 0.00034 | 0.000034 |

| | | | | | | |
|---|---|---|---|---|---|---|
| Average Precision per Crank: | 0.012 | 0.0030 | 0.0015 | 0.0010 | 0.00034 | 0.000034 |
| | (inch/Full C) | (inch/¼ C) | (inch/⅛ C) | (inch/ 1/12 C) | (inch/ 1/36 C) | (inch/ 1/360 C) |

Table 5-19: X_{b} = 5.5, 1 + 181/40, 1 + 182/40, to 5.75

| | | | | | | | | |
|---|---|---|---|---|---|---|---|---|
| 180 | 5.5 | 1.2359 | 0.00000 | 0.00000 | 0.00000 | 0.00000 | 0.00000 | 0.000000 |
| 181 | 5.525 | 1.2485 | 0.01260 | 0.00315 | 0.00157 | 0.00105 | 0.00035 | 0.000035 |
| 182 | 5.550 | 1.2611 | 0.01260 | 0.00315 | 0.00158 | 0.00105 | 0.00035 | 0.000035 |
| 183 | 5.575 | 1.2737 | 0.01260 | 0.00315 | 0.00157 | 0.00105 | 0.00035 | 0.000035 |
| 184 | 5.600 | 1.2865 | 0.01280 | 0.00320 | 0.00160 | 0.00107 | 0.00036 | 0.000036 |
| 185 | 5.625 | 1.2993 | 0.01280 | 0.00320 | 0.00160 | 0.00107 | 0.00036 | 0.000036 |
| 186 | 5.650 | 1.3121 | 0.01280 | 0.00320 | 0.00160 | 0.00107 | 0.00036 | 0.000036 |
| 187 | 5.675 | 1.3251 | 0.01300 | 0.00325 | 0.00162 | 0.00108 | 0.00036 | 0.000036 |
| 188 | 5.700 | 1.3381 | 0.01300 | 0.00325 | 0.00163 | 0.00108 | 0.00036 | 0.000036 |
| 189 | 5.725 | 1.3511 | 0.01300 | 0.00325 | 0.00162 | 0.00108 | 0.00036 | 0.000036 |
| 190 | 5.75 | 1.3643 | 0.01320 | 0.00330 | 0.00165 | 0.00110 | 0.00037 | 0.000037 |

| | | | | | | |
|---|---|---|---|---|---|---|
| Average Precision per Crank: | 0.013 | 0.0032 | 0.0016 | 0.0011 | 0.00036 | 0.000036 |
| | (inch/Full C) | (inch/¼ C) | (inch/⅛ C) | (inch/ 1/12 C) | (inch/ 1/36 C) | (inch/ 1/360 C) |

Table 5-20: X_{b} = 5.75, 1 + 191/40, 1 + 192/40, to 6.0 key 5-6

| | | | | | | | | |
|---|---|---|---|---|---|---|---|---|
| 190 | 5.75 | 1.3643 | 0.00000 | 0.00000 | 0.00000 | 0.00000 | 0.00000 | 0.000000 |
| 191 | 5.775 | 1.3775 | 0.01320 | 0.00330 | 0.00165 | 0.00110 | 0.00037 | 0.000037 |
| 192 | 5.800 | 1.3907 | 0.01320 | 0.00330 | 0.00165 | 0.00110 | 0.00037 | 0.000037 |
| 193 | 5.825 | 1.4041 | 0.01340 | 0.00335 | 0.00167 | 0.00112 | 0.00037 | 0.000037 |
| 194 | 5.850 | 1.4175 | 0.01340 | 0.00335 | 0.00168 | 0.00112 | 0.00037 | 0.000037 |
| 195 | 5.875 | 1.4309 | 0.01340 | 0.00335 | 0.00168 | 0.00112 | 0.00037 | 0.000037 |
| 196 | 5.900 | 1.4445 | 0.01360 | 0.00340 | 0.00170 | 0.00113 | 0.00038 | 0.000038 |
| 197 | 5.925 | 1.4581 | 0.01360 | 0.00340 | 0.00170 | 0.00113 | 0.00038 | 0.000038 |
| 198 | 5.950 | 1.4718 | 0.01370 | 0.00343 | 0.00171 | 0.00114 | 0.00038 | 0.000038 |
| 199 | 5.975 | 1.4855 | 0.01370 | 0.00343 | 0.00171 | 0.00114 | 0.00038 | 0.000038 |
| 200 | 6 | 1.5000 | 0.01450 | 0.00362 | 0.00181 | 0.00121 | 0.00040 | 0.000040 |

| | | | | | | |
|---|---|---|---|---|---|---|
| Average Precision per Crank: | 0.014 | 0.0034 | 0.0017 | 0.0011 | 0.00038 | 0.000038 |
| | (inch/Full C) | (inch/¼ C) | (inch/⅛ C) | (inch/ 1/12 C) | (inch/ 1/36 C) | (inch/ 1/360 C) |

Table 5-21: X_{b} = 6.0, 1 + 201/40, 1 + 202/40, to 6.25

| | | | | | | | | |
|---|---|---|---|---|---|---|---|---|
| 200 | 6 | 1.5000 | 0.00000 | 0.00000 | 0.00000 | 0.00000 | 0.00000 | 0.000000 |
| 201 | 6.025 | 1.5263 | 0.02630 | 0.00658 | 0.00329 | 0.00219 | 0.00073 | 0.000073 |
| 202 | 6.050 | 1.5535 | 0.02720 | 0.00680 | 0.00340 | 0.00227 | 0.00076 | 0.000076 |
| 203 | 6.075 | 1.5809 | 0.02740 | 0.00685 | 0.00342 | 0.00228 | 0.00076 | 0.000076 |
| 204 | 6.100 | 1.6085 | 0.02760 | 0.00690 | 0.00345 | 0.00230 | 0.00077 | 0.000077 |
| 206 | 6.125 | 1.6363 | 0.02780 | 0.00695 | 0.00348 | 0.00232 | 0.00077 | 0.000077 |
| 206 | 6.150 | 1.6643 | 0.02800 | 0.00700 | 0.00350 | 0.00233 | 0.00078 | 0.000078 |
| 207 | 6.175 | 1.6926 | 0.02830 | 0.00708 | 0.00354 | 0.00236 | 0.00079 | 0.000079 |
| 208 | 6.200 | 1.7210 | 0.02840 | 0.00710 | 0.00355 | 0.00237 | 0.00079 | 0.000079 |
| 209 | 6.225 | 1.7497 | 0.02870 | 0.00717 | 0.00359 | 0.00239 | 0.00080 | 0.000080 |
| 210 | 6.25 | 1.7786 | 0.02890 | 0.00722 | 0.00361 | 0.00241 | 0.00080 | 0.000080 |

| | | | | | | |
|---|---|---|---|---|---|---|
| Average Precision per Crank: | 0.028 | 0.0070 | 0.0035 | 0.0023 | 0.00077 | 0.000077 |
| | (inch/Full C) | (inch/¼ C) | (inch/⅛ C) | (inch/ 1/12 C) | (inch/ 1/36 C) | (inch/ 1/360 C) |

Table 5-22: X_{b} = 6.25, 1 + 211/40, 1 +212/40, to 6.5 key 6-7

| | | | | | | | | |
|---|---|---|---|---|---|---|---|---|
| 210 | 6.25 | 1.7786 | 0.00000 | 0.00000 | 0.00000 | 0.00000 | 0.00000 | 0.000000 |
| 211 | 6.275 | 1.8080 | 0.02940 | 0.00735 | 0.00368 | 0.00245 | 0.00082 | 0.000082 |
| 212 | 6.300 | 1.8370 | 0.02900 | 0.00725 | 0.00362 | 0.00242 | 0.00081 | 0.000081 |
| 213 | 6.325 | 1.8665 | 0.02950 | 0.00738 | 0.00369 | 0.00246 | 0.00082 | 0.000082 |
| 214 | 6.350 | 1.8963 | 0.02980 | 0.00745 | 0.00373 | 0.00248 | 0.00083 | 0.000083 |
| 215 | 6.375 | 1.9262 | 0.02990 | 0.00747 | 0.00374 | 0.00249 | 0.00083 | 0.000083 |
| 216 | 6.400 | 1.9564 | 0.03020 | 0.00755 | 0.00378 | 0.00252 | 0.00084 | 0.000084 |
| 217 | 6.425 | 1.9868 | 0.03040 | 0.00760 | 0.00380 | 0.00253 | 0.00084 | 0.000084 |
| 218 | 6.450 | 2.0175 | 0.03070 | 0.00768 | 0.00384 | 0.00256 | 0.00085 | 0.000085 |
| 219 | 6.475 | 2.0483 | 0.03080 | 0.00770 | 0.00385 | 0.00257 | 0.00086 | 0.000086 |
| 220 | 6.5 | 2.0794 | 0.03110 | 0.00778 | 0.00389 | 0.00259 | 0.00086 | 0.000086 |

| | | | | | | |
|---|---|---|---|---|---|---|
| Average Precision per Crank: | 0.030 | 0.0075 | 0.0038 | 0.0025 | 0.00084 | 0.000084 |
| | (inch/Full C) | (inch/¼ C) | (inch/ ⅛ C) | (inch/ 1/12 C) | (inch/ 1/36 C) | (inch/ 1/360 C) |

Table 5-23: X_{b} = 6.5, 1 + 221/40, 1 + 222/40, to 6.75

| | | | | | | | | |
|---|---|---|---|---|---|---|---|---|
| 220 | 6.5 | 2.0794 | 0.00000 | 0.00000 | 0.00000 | 0.00000 | 0.00000 | 0.000000 |
| 221 | 6.525 | 2.1107 | 0.03130 | 0.00782 | 0.00391 | 0.00261 | 0.00087 | 0.000087 |
| 222 | 6.550 | 2.1423 | 0.03160 | 0.00790 | 0.00395 | 0.00263 | 0.00088 | 0.000088 |
| 223 | 6.575 | 2.1740 | 0.03170 | 0.00792 | 0.00396 | 0.00264 | 0.00088 | 0.000088 |
| 224 | 6.600 | 2.2060 | 0.03200 | 0.00800 | 0.00400 | 0.00267 | 0.00089 | 0.000089 |
| 225 | 6.625 | 2.2383 | 0.03230 | 0.00808 | 0.00404 | 0.00269 | 0.00090 | 0.000090 |
| 226 | 6.650 | 2.2707 | 0.03240 | 0.00810 | 0.00405 | 0.00270 | 0.00090 | 0.000090 |
| 227 | 6.675 | 2.3034 | 0.03270 | 0.00817 | 0.00409 | 0.00272 | 0.00091 | 0.000091 |
| 228 | 6.700 | 2.3363 | 0.03290 | 0.00823 | 0.00411 | 0.00274 | 0.00091 | 0.000091 |
| 229 | 6.725 | 2.3695 | 0.03320 | 0.00830 | 0.00415 | 0.00277 | 0.00092 | 0.000092 |
| 230 | 6.75 | 2.4029 | 0.03340 | 0.00835 | 0.00417 | 0.00278 | 0.00093 | 0.000093 |

| | | | | | | |
|---|---|---|---|---|---|---|
| Average Precision per Crank: | 0.032 | 0.0081 | 0.0040 | 0.0027 | 0.00090 | 0.000090 |
| | (inch/Full C) | (inch/ ¼ C) | (inch/ ⅛ C) | (inch/ 1/12 C) | (inch/ 1/36 C) | (inch/ 1/360 C) |

Table 5-24: X_{b} = 6.75, 1 + 231/40, 1 + 232/40, to 7.0 key 6-7

| | | | | | | | | |
|---|---|---|---|---|---|---|---|---|
| 230 | 6.75 | 2.4029 | 0.00000 | 0.00000 | 0.00000 | 0.00000 | 0.00000 | 0.000000 |
| 231 | 6.775 | 2.4365 | 0.03360 | 0.00840 | 0.00420 | 0.00280 | 0.00093 | 0.000093 |
| 232 | 6.800 | 2.4704 | 0.03390 | 0.00848 | 0.00424 | 0.00283 | 0.00094 | 0.000094 |
| 233 | 6.825 | 2.5046 | 0.03420 | 0.00855 | 0.00427 | 0.00285 | 0.00095 | 0.000095 |
| 234 | 6.850 | 2.5389 | 0.03430 | 0.00858 | 0.00429 | 0.00286 | 0.00095 | 0.000095 |
| 235 | 6.875 | 2.5735 | 0.03460 | 0.00865 | 0.00433 | 0.00288 | 0.00096 | 0.000096 |
| 236 | 6.900 | 2.6084 | 0.03490 | 0.00872 | 0.00436 | 0.00291 | 0.00097 | 0.000097 |
| 237 | 6.925 | 2.6435 | 0.03510 | 0.00877 | 0.00439 | 0.00292 | 0.00097 | 0.000097 |
| 238 | 6.950 | 2.6789 | 0.03540 | 0.00885 | 0.00443 | 0.00295 | 0.00098 | 0.000098 |
| 239 | 6.975 | 2.7145 | 0.03560 | 0.00890 | 0.00445 | 0.00297 | 0.00099 | 0.000099 |
| 240 | 7 | 2.7500 | 0.03550 | 0.00887 | 0.00444 | 0.00296 | 0.00099 | 0.000099 |

| | | | | | | |
|---|---|---|---|---|---|---|
| Average Precision per Crank: | 0.035 | 0.0087 | 0.0043 | 0.0029 | 0.00096 | 0.000096 |
| | (inch/Full C) | (inch/ ¼ C) | (inch/ ⅛ C) | (inch/ 1/12 C) | (inch/ 1/36 C) | (inch/ 1/360 C) |

Table 5-25: X_{b} = 7.0, 1 + 241/40, 1 + 242/40, to 7.25

| | | | | | | | | |
|---|---|---|---|---|---|---|---|---|
| 240 | 7 | 2.7500 | 0.00000 | 0.00000 | 0.00000 | 0.00000 | 0.00000 | 0.000000 |
| 241 | 7.025 | 2.7782 | 0.02820 | 0.00705 | 0.00353 | 0.00235 | 0.00078 | 0.000078 |
| 242 | 7.050 | 2.8063 | 0.02810 | 0.00702 | 0.00351 | 0.00234 | 0.00078 | 0.000078 |
| 243 | 7.075 | 2.8346 | 0.02830 | 0.00708 | 0.00354 | 0.00236 | 0.00079 | 0.000079 |
| 244 | 7.100 | 2.8630 | 0.02840 | 0.00710 | 0.00355 | 0.00237 | 0.00079 | 0.000079 |
| 245 | 7.125 | 2.8915 | 0.02850 | 0.00713 | 0.00356 | 0.00238 | 0.00079 | 0.000079 |
| 246 | 7.150 | 2.9203 | 0.02880 | 0.00720 | 0.00360 | 0.00240 | 0.00080 | 0.000080 |
| 247 | 7.175 | 2.9492 | 0.02890 | 0.00722 | 0.00361 | 0.00241 | 0.00080 | 0.000080 |
| 248 | 7.200 | 2.9782 | 0.02900 | 0.00725 | 0.00363 | 0.00242 | 0.00081 | 0.000081 |
| 249 | 7.225 | 3.0074 | 0.02920 | 0.00730 | 0.00365 | 0.00243 | 0.00081 | 0.000081 |
| 250 | 7.25 | 3.0368 | 0.02940 | 0.00735 | 0.00367 | 0.00245 | 0.00082 | 0.000082 |

| | | | | | | |
|---|---|---|---|---|---|---|
| Average Precision per Crank: | 0.029 | 0.0072 | 0.0036 | 0.0024 | 0.00080 | 0.000080 |
| | (inch/Full C) | (inch/ ¼ C) | (inch/ ⅛ C) | (inch/ 1/12 C) | (inch/ 1/36 C) | (inch/ 1/360 C) |

Table 5-26: X_{b} = 7.25, 1 + 251/40, 1 + 252/40, to 7.5 key 7-8

| | | | | | | | | |
|---|---|---|---|---|---|---|---|---|
| 250 | 7.25 | 3.0368 | 0.00000 | 0.00000 | 0.00000 | 0.00000 | 0.00000 | 0.000000 |
| 251 | 7.275 | 3.0664 | 0.02960 | 0.00740 | 0.00370 | 0.00247 | 0.00082 | 0.000082 |
| 252 | 7.300 | 3.0961 | 0.02970 | 0.00743 | 0.00371 | 0.00248 | 0.00083 | 0.000083 |
| 253 | 7.325 | 3.1260 | 0.02990 | 0.00748 | 0.00374 | 0.00249 | 0.00083 | 0.000083 |
| 254 | 7.350 | 3.1561 | 0.03010 | 0.00753 | 0.00376 | 0.00251 | 0.00084 | 0.000084 |
| 255 | 7.375 | 3.1863 | 0.03020 | 0.00755 | 0.00378 | 0.00252 | 0.00084 | 0.000084 |
| 256 | 7.400 | 3.2167 | 0.03040 | 0.00760 | 0.00380 | 0.00253 | 0.00084 | 0.000084 |
| 257 | 7.425 | 3.2473 | 0.03060 | 0.00765 | 0.00383 | 0.00255 | 0.00085 | 0.000085 |
| 258 | 7.450 | 3.2780 | 0.03070 | 0.00767 | 0.00384 | 0.00256 | 0.00085 | 0.000085 |
| 259 | 7.475 | 3.3089 | 0.03090 | 0.00772 | 0.00386 | 0.00257 | 0.00086 | 0.000086 |
| 260 | 7.5 | 3.3400 | 0.03110 | 0.00777 | 0.00389 | 0.00259 | 0.00086 | 0.000086 |

| | | | | | | |
|---|---|---|---|---|---|---|
| Average Precision per Crank: | 0.030 | 0.0076 | 0.0038 | 0.0025 | 0.00084 | 0.000084 |
| | (inch/Full C) | (inch/ ¼ C) | (inch/ ⅛ C) | (inch/ 1/12 C) | (inch/ 1/36 C) | (inch/ 1/360 C) |

Table 5-27: X_{b} = 7.5, 1 + 261/40, 1 + 262/40, to 7.75

| | | | | | | | | |
|---|---|---|---|---|---|---|---|---|
| 260 | 7.5 | 3.3400 | 0.00000 | 0.00000 | 0.00000 | 0.00000 | 0.00000 | 0.000000 |
| 261 | 7.525 | 3.3713 | 0.03130 | 0.00783 | 0.00391 | 0.00261 | 0.00087 | 0.000087 |
| 262 | 7.550 | 3.4027 | 0.03140 | 0.00785 | 0.00392 | 0.00262 | 0.00087 | 0.000087 |
| 263 | 7.575 | 3.4343 | 0.03160 | 0.00790 | 0.00395 | 0.00263 | 0.00088 | 0.000088 |
| 264 | 7.600 | 3.4661 | 0.03180 | 0.00795 | 0.00398 | 0.00265 | 0.00088 | 0.000088 |
| 265 | 7.625 | 3.4980 | 0.03190 | 0.00798 | 0.00399 | 0.00266 | 0.00089 | 0.000089 |
| 266 | 7.650 | 3.5302 | 0.03220 | 0.00805 | 0.00402 | 0.00268 | 0.00089 | 0.000089 |
| 267 | 7.675 | 3.5625 | 0.03230 | 0.00808 | 0.00404 | 0.00269 | 0.00090 | 0.000090 |
| 268 | 7.700 | 3.5950 | 0.03250 | 0.00813 | 0.00406 | 0.00271 | 0.00090 | 0.000090 |
| 269 | 7.725 | 3.6277 | 0.03270 | 0.00817 | 0.00409 | 0.00272 | 0.00091 | 0.000091 |
| 270 | 7.75 | 3.6605 | 0.03280 | 0.00820 | 0.00410 | 0.00273 | 0.00091 | 0.000091 |

| | | | | | | |
|---|---|---|---|---|---|---|
| Average Precision per Crank: | 0.032 | 0.0080 | 0.0040 | 0.0027 | 0.00089 | 0.000089 |
| | (inch/Full C) | (inch/ ¼ C) | (inch/ ⅛ C) | (inch/ 1/12 C) | (inch/ 1/36 C) | (inch/ 1/360 C) |

Table 5-28: X_{b} = 7.75, 1 + 271/40, 1 + 272/40, to 8.0 key 7-8

| | | | | | | | | |
|---|---|---|---|---|---|---|---|---|
| 270 | 7.75 | 3.6605 | 0.00000 | 0.00000 | 0.00000 | 0.00000 | 0.00000 | 0.000000 |
| 271 | 7.775 | 3.6935 | 0.03300 | 0.00825 | 0.00412 | 0.00275 | 0.00092 | 0.000092 |
| 272 | 7.800 | 3.7268 | 0.03330 | 0.00833 | 0.00416 | 0.00278 | 0.00093 | 0.000093 |
| 273 | 7.825 | 3.7602 | 0.03340 | 0.00835 | 0.00418 | 0.00278 | 0.00093 | 0.000093 |
| 274 | 7.850 | 3.7937 | 0.03350 | 0.00837 | 0.00419 | 0.00279 | 0.00093 | 0.000093 |
| 275 | 7.875 | 3.8275 | 0.03380 | 0.00845 | 0.00423 | 0.00282 | 0.00094 | 0.000094 |
| 276 | 7.900 | 3.8615 | 0.03400 | 0.00850 | 0.00425 | 0.00283 | 0.00094 | 0.000094 |
| 277 | 7.925 | 3.8956 | 0.03410 | 0.00853 | 0.00426 | 0.00284 | 0.00095 | 0.000095 |
| 278 | 7.950 | 3.9300 | 0.03440 | 0.00860 | 0.00430 | 0.00287 | 0.00096 | 0.000096 |
| 279 | 7.975 | 3.9644 | 0.03440 | 0.00860 | 0.00430 | 0.00287 | 0.00096 | 0.000096 |
| 280 | 8 | 4.0000 | 0.03560 | 0.00890 | 0.00445 | 0.00297 | 0.00099 | 0.000099 |

| | | | | | | |
|---|---|---|---|---|---|---|
| Average Precision per Crank: | 0.034 | 0.0085 | 0.0042 | 0.0028 | 0.00094 | 0.000094 |
| | (inch/Full C) | (inch/ ¼ C) | (inch/ ⅛ C) | (inch/ 1/12 C) | (inch/ 1/36 C) | (inch/ 1/360 C) |

TABLE 6

| | | | | | | | | |
|---|---|---|---|---|---|---|---|---|
| | | | Precision | Precision | Pecision | Precision | Precision | Precision |
| Crank (C) | | | Per Full C | Per ¼ C | Per ⅛ C | Per 1/12 C | Per 1/36 C | 1/360 C |
| Full 360/C | X_{b} | Y_{b} | (360 deg) | (90 deg) | (45 deg) | (30 deg) | (10 deg) | (1 degree) |

½ Size PEMD Displacement Precision: Face Ht. = 1.5″,
5/16 - 48 UNS, Roller Dia. = 1″. Track L = 5½″
Table 6-1: X_{b} = ½, ½ + 1/48, ½ + 2/48, to 1.0 key 1-2 equiv.

| | | | | | | | | |
|---|---|---|---|---|---|---|---|---|
| 0 | 0.5 | −0.3750 | start | start | start | start | start | start |
| 1 | ½ + 1/48 | −0.3692 | 0.006 | 0.0015 | 0.0007 | 0.0005 | 0.00016 | 0.000016 |
| 2 | ½ + 2/48 | −0.3626 | 0.007 | 0.0017 | 0.0008 | 0.0006 | 0.00018 | 0.000018 |
| 3 | ½ + 3/48 | −0.3551 | 0.007 | 0.0019 | 0.0009 | 0.0006 | 0.00021 | 0.000021 |
| 4 | ½ + 4/48 | −0.3467 | 0.008 | 0.0021 | 0.0011 | 0.0007 | 0.00023 | 0.000023 |
| 5 | ½ + 5/48 | −0.3375 | 0.009 | 0.0023 | 0.0012 | 0.0008 | 0.00026 | 0.000026 |
| 6 | ½ + 6/48 | −0.3275 | 0.010 | 0.0025 | 0.0013 | 0.0008 | 0.00028 | 0.000028 |
| 7 | ½ + 7/48 | −0.3166 | 0.011 | 0.0027 | 0.0014 | 0.0009 | 0.00030 | 0.000030 |
| 8 | ½ + 8/48 | −0.3050 | 0.012 | 0.0029 | 0.0015 | 0.0010 | 0.00032 | 0.000032 |
| 9 | ½ + 9/48 | −0.2924 | 0.013 | 0.0032 | 0.0016 | 0.0011 | 0.00035 | 0.000035 |
| 10 | ½ + 10/48 | −0.2791 | 0.013 | 0.0033 | 0.0017 | 0.0011 | 0.00037 | 0.000037 |
| 11 | ½ + 11/48 | −0.2686 | 0.011 | 0.0026 | 0.0013 | 0.0009 | 0.00029 | 0.000029 |
| 12 | ½ + 12/48 | −0.2500 | 0.019 | 0.0047 | 0.0023 | 0.0016 | 0.00052 | 0.000052 |
| 13 | ½ + 13/48 | −0.2342 | 0.016 | 0.0040 | 0.0020 | 0.0013 | 0.00044 | 0.000044 |
| 14 | ½ + 14/48 | −0.2175 | 0.017 | 0.0042 | 0.0021 | 0.0014 | 0.00046 | 0.000046 |
| 15 | ½ + 15/48 | −0.2000 | 0.018 | 0.0044 | 0.0022 | 0.0015 | 0.00049 | 0.000049 |
| 16 | ½ + 16/48 | −0.1815 | 0.019 | 0.0046 | 0.0023 | 0.0015 | 0.00051 | 0.000051 |
| 17 | ½ + 17/48 | −0.1622 | 0.019 | 0.0048 | 0.0024 | 0.0016 | 0.00054 | 0.000054 |
| 18 | ½ + 18/48 | −0.1420 | 0.020 | 0.0051 | 0.0025 | 0.0017 | 0.00056 | 0.000056 |
| 19 | ½ + 19/48 | −0.1208 | 0.021 | 0.0053 | 0.0027 | 0.0018 | 0.00059 | 0.000059 |
| 20 | ½ + 20/48 | −0.0970 | 0.024 | 0.0060 | 0.0030 | 0.0020 | 0.00066 | 0.000066 |
| 21 | ½ + 21/48 | −0.0756 | 0.021 | 0.0054 | 0.0027 | 0.0018 | 0.00059 | 0.000059 |
| 22 | ½ + 22/48 | −0.0514 | 0.024 | 0.0061 | 0.0030 | 0.0020 | 0.00067 | 0.000067 |
| 23 | ½ + 23/48 | −0.0263 | 0.025 | 0.0063 | 0.0031 | 0.0021 | 0.00070 | 0.000070 |
| 24 | 1 | 0.0000 | 0.026 | 0.0066 | 0.0033 | 0.0022 | 0.00073 | 0.000073 |

| Average Precision per Crank: | 0.016 | 0.0039 | 0.0020 | 0.0013 | 0.00043 | 0.000043 |
|---|---|---|---|---|---|---|
| | (inch/Full C) | (inch/¼ C) | (inch/⅛ C) | (inch/ 1/12 C) | (inch/ 1/36 C) | (inch/ 1/360 C) |

5 Digit ½ Size PEMD Displacement Precision: Face Ht. = 1.5″,
5/16 - 48 UNS, Roller Dia. = 1″. Track L = 5½″
Table 6-2: X_{b} = 1.0, ½ + 25/48, ½ + 26/48, to 1.5 key 2-3 equiv.

| | | | | | | | | |
|---|---|---|---|---|---|---|---|---|
| 24 | 1 | 0.000 | 0.000 | 0.0000 | 0.0000 | 0.0000 | 0.00000 | 0.000000 |
| 25 | ½ + 25/48 | 0.00353 | 0.004 | 0.0009 | 0.0004 | 0.0003 | 0.00010 | 0.000010 |
| 26 | ½ + 26/48 | 0.00721 | 0.004 | 0.0009 | 0.0005 | 0.0003 | 0.00010 | 0.000010 |
| 27 | ½ + 2748 | 0.01103 | 0.004 | 0.0010 | 0.0005 | 0.0003 | 0.00011 | 0.000011 |
| 28 | ½ + 28/48 | 0.01500 | 0.004 | 0.0010 | 0.0005 | 0.0003 | 0.00011 | 0.000011 |
| 29 | ½ + 29/48 | 0.01911 | 0.004 | 0.0010 | 0.0005 | 0.0003 | 0.00011 | 0.000011 |
| 30 | ½ + 30/48 | 0.02337 | 0.004 | 0.0011 | 0.0005 | 0.0004 | 0.00012 | 0.000012 |
| 31 | ½ + 31/48 | 0.02776 | 0.004 | 0.0011 | 0.0005 | 0.0004 | 0.00012 | 0.000012 |
| 32 | ½ + 32/48 | 0.03231 | 0.005 | 0.0011 | 0.0006 | 0.0004 | 0.00013 | 0.000013 |
| 33 | ½ + 33/48 | 0.03700 | 0.005 | 0.0012 | 0.0006 | 0.0004 | 0.00013 | 0.000013 |
| 34 | ½ + 34/48 | 0.04184 | 0.005 | 0.0012 | 0.0006 | 0.0004 | 0.00013 | 0.000013 |
| 35 | ½ + 35/48 | 0.04682 | 0.005 | 0.0012 | 0.0006 | 0.0004 | 0.00014 | 0.000014 |
| 36 | ½ + 36/48 | 0.05195 | 0.005 | 0.0013 | 0.0006 | 0.0004 | 0.00014 | 0.000014 |
| 37 | ½ + 37/48 | 0.05722 | 0.005 | 0.0013 | 0.0007 | 0.0004 | 0.00015 | 0.000015 |
| 38 | ½ + 38/48 | 0.06264 | 0.005 | 0.0014 | 0.0007 | 0.0005 | 0.00015 | 0.000015 |
| 39 | ½ + 39/48 | 0.06813 | 0.005 | 0.0014 | 0.0007 | 0.0005 | 0.00015 | 0.000015 |
| 40 | ½ + 40/48 | 0.07391 | 0.006 | 0.0014 | 0.0007 | 0.0005 | 0.00016 | 0.000016 |
| 41 | ½ + 41/48 | 0.07977 | 0.006 | 0.0015 | 0.0007 | 0.0005 | 0.00016 | 0.000016 |
| 42 | ½ + 42/48 | 0.08421 | 0.004 | 0.0011 | 0.0006 | 0.0004 | 0.00012 | 0.000012 |
| 43 | ½ + 43/48 | 0.09192 | 0.008 | 0.0019 | 0.0010 | 0.0006 | 0.00021 | 0.000021 |
| 44 | ½ + 44/48 | 0.09822 | 0.006 | 0.0016 | 0.0008 | 0.0005 | 0.00018 | 0.000018 |
| 45 | ½ + 45/48 | 0.10466 | 0.006 | 0.0016 | 0.0008 | 0.0005 | 0.00018 | 0.000018 |
| 46 | ½ + 46/48 | 0.11125 | 0.007 | 0.0016 | 0.0008 | 0.0005 | 0.00018 | 0.000018 |
| 47 | ½ + 47/48 | 0.11800 | 0.007 | 0.0017 | 0.0008 | 0.0006 | 0.00019 | 0.000019 |
| 48 | 1.5 | 0.125 | 0.007 | 0.0017 | 0.0009 | 0.0006 | 0.00019 | 0.000019 |

| Average Precision per Crank: | 0.005 | 0.0013 | 0.0007 | 0.0004 | 0.00014 | 0.000014 |
|---|---|---|---|---|---|---|
| | (inch/Full C) | (inch/¼ C) | (inch/⅛ C) | (inch/ 1/12 C) | (inch/ 1/36 C) | (inch/ 1/360 C) |

½ Size PEMD Displacement Precision: Face Ht. = 1.5″,
5/16 - 48 UNS, Roller Dia. = 1″. Track L = 5½″
Table 6-3: X_{b} = 1.5, ½ + 49/48, ½ + 50/48, to 2.0 key 3-4 equiv.

| | | | | | | | | |
|---|---|---|---|---|---|---|---|---|
| 48 | 1.5 | 0.1250 | 0.000 | 0.0000 | 0.0000 | 0.0000 | 0.00000 | 0.000000 |
| 49 | ½ + 49/48 | 0.1293 | 0.004 | 0.0011 | 0.0005 | 0.0004 | 0.00012 | 0.000012 |
| 50 | ½ + 50/48 | 0.1338 | 0.005 | 0.0011 | 0.0006 | 0.0004 | 0.00013 | 0.000013 |
| 51 | ½ + 5148 | 0.1382 | 0.004 | 0.0011 | 0.0005 | 0.0004 | 0.00012 | 0.000012 |
| 52 | ½ + 52/48 | 0.1428 | 0.005 | 0.0012 | 0.0006 | 0.0004 | 0.00013 | 0.000013 |
| 53 | ½ + 53/48 | 0.1474 | 0.005 | 0.0012 | 0.0006 | 0.0004 | 0.00013 | 0.000013 |
| 54 | ½ + 54/48 | 0.1522 | 0.005 | 0.0012 | 0.0006 | 0.0004 | 0.00013 | 0.000013 |
| 55 | ½ + 55/48 | 0.1570 | 0.005 | 0.0012 | 0.0006 | 0.0004 | 0.00013 | 0.000013 |
| 56 | ½ + 56/48 | 0.1619 | 0.005 | 0.0012 | 0.0006 | 0.0004 | 0.00014 | 0.000014 |
| 57 | ½ + 57/48 | 0.1668 | 0.005 | 0.0012 | 0.0006 | 0.0004 | 0.00014 | 0.000014 |
| 58 | ½ + 58/48 | 0.1718 | 0.005 | 0.0013 | 0.0006 | 0.0004 | 0.00014 | 0.000014 |
| 59 | ½ + 59/48 | 0.1769 | 0.005 | 0.0013 | 0.0006 | 0.0004 | 0.00014 | 0.000014 |
| 60 | ½ + 60/48 | 0.1821 | 0.005 | 0.0013 | 0.0007 | 0.0004 | 0.00014 | 0.000014 |
| 61 | ½ + 61/48 | 0.1886 | 0.006 | 0.0016 | 0.0008 | 0.0005 | 0.00018 | 0.000018 |
| 62 | ½ + 62/48 | 0.1926 | 0.004 | 0.0010 | 0.0005 | 0.0003 | 0.00011 | 0.000011 |
| 63 | ½ + 63/48 | 0.1980 | 0.005 | 0.0014 | 0.0007 | 0.0005 | 0.00015 | 0.000015 |
| 64 | ½ + 64/48 | 0.2035 | 0.005 | 0.0014 | 0.0007 | 0.0005 | 0.00015 | 0.000015 |
| 65 | ½ + 65/48 | 0.2090 | 0.006 | 0.0014 | 0.0007 | 0.0005 | 0.00015 | 0.000015 |
| 66 | ½ + 66/48 | 0.2146 | 0.006 | 0.0014 | 0.0007 | 0.0005 | 0.00016 | 0.000016 |
| 67 | ½ + 67/48 | 0.2203 | 0.006 | 0.0014 | 0.0007 | 0.0005 | 0.00016 | 0.000016 |
| 68 | ½ + 68/48 | 0.2260 | 0.006 | 0.0014 | 0.0007 | 0.0005 | 0.00016 | 0.000016 |
| 69 | ½ + 69/48 | 0.2319 | 0.006 | 0.0015 | 0.0007 | 0.0005 | 0.00016 | 0.000016 |
| 70 | ½ + 70/48 | 0.2378 | 0.006 | 0.0015 | 0.0007 | 0.0005 | 0.00016 | 0.000016 |
| 71 | ½ + 71/48 | 0.2437 | 0.006 | 0.0015 | 0.0007 | 0.0005 | 0.00016 | 0.000016 |
| 72 | 2 | 0.2500 | 0.006 | 0.0016 | 0.0008 | 0.0005 | 0.00018 | 0.000018 |

| Average Precision per Crank: | 0.005 | 0.0013 | 0.0007 | 0.0004 | 0.00014 | 0.000014 |
|---|---|---|---|---|---|---|
| | (inch/Full C) | (inch/¼ C) | (inch/⅛ C) | (inch/ 1/12 C) | (inch/ 1/36 C) | (inch/ 1/360 C) |

Table 6-4: X_{b} = 2.0, ½ + 73/48, ½ + 74/48, to 2.5 key 4-5 equiv.

| | | | | | | | | |
|---|---|---|---|---|---|---|---|---|
| 72 | 2 | 0.2500 | 0.000 | 0.0000 | 0.0000 | 0.0000 | 0.00000 | 0.000000 |
| 73 | ½ + 73/48 | 0.2587 | 0.009 | 0.0022 | 0.0011 | 0.0007 | 0.00024 | 0.000024 |
| 74 | ½ + 74/48 | 0.2676 | 0.009 | 0.0022 | 0.0011 | 0.0007 | 0.00025 | 0.000025 |
| 75 | ½ + 75/48 | 0.2768 | 0.009 | 0.0023 | 0.0012 | 0.0008 | 0.00026 | 0.000026 |
| 76 | ½ + 76/48 | 0.2860 | 0.009 | 0.0023 | 0.0012 | 0.0008 | 0.00026 | 0.000026 |
| 77 | ½ + 77/48 | 0.2954 | 0.009 | 0.0024 | 0.0012 | 0.0008 | 0.00026 | 0.000026 |
| 78 | ½ + 78/48 | 0.3049 | 0.010 | 0.0024 | 0.0012 | 0.0008 | 0.00026 | 0.000026 |
| 79 | ½ + 79/48 | 0.3145 | 0.010 | 0.0024 | 0.0012 | 0.0008 | 0.00027 | 0.000027 |
| 80 | ½ + 80/48 | 0.3243 | 0.010 | 0.0024 | 0.0012 | 0.0008 | 0.00027 | 0.000027 |
| 81 | ½ + 81/48 | 0.3342 | 0.010 | 0.0025 | 0.0012 | 0.0008 | 0.00028 | 0.000028 |
| 82 | ½ + 82/48 | 0.3443 | 0.010 | 0.0025 | 0.0013 | 0.0008 | 0.00028 | 0.000028 |
| 83 | ½ + 83/48 | 0.3545 | 0.010 | 0.0026 | 0.0013 | 0.0008 | 0.00028 | 0.000028 |
| 84 | ½ + 84/48 | 0.3648 | 0.010 | 0.0026 | 0.0013 | 0.0009 | 0.00029 | 0.000029 |
| 85 | ½ + 85/48 | 0.3753 | 0.011 | 0.0026 | 0.0013 | 0.0009 | 0.00029 | 0.000029 |
| 86 | ½ + 86/48 | 0.3859 | 0.011 | 0.0027 | 0.0013 | 0.0009 | 0.00029 | 0.000029 |
| 87 | ½ + 87/48 | 0.3966 | 0.011 | 0.0027 | 0.0013 | 0.0009 | 0.00030 | 0.000030 |
| 88 | ½ + 88/48 | 0.4075 | 0.011 | 0.0027 | 0.0014 | 0.0009 | 0.00030 | 0.000030 |
| 89 | ½ + 89/48 | 0.4185 | 0.011 | 0.0028 | 0.0014 | 0.0009 | 0.00031 | 0.000031 |
| 90 | ½ + 90/48 | 0.4297 | 0.011 | 0.0028 | 0.0014 | 0.0009 | 0.00031 | 0.000031 |
| 91 | ½ + 91/48 | 0.4410 | 0.011 | 0.0028 | 0.0014 | 0.0009 | 0.00031 | 0.000031 |
| 92 | ½ + 92/48 | 0.4524 | 0.011 | 0.0029 | 0.0014 | 0.0010 | 0.00032 | 0.000032 |
| 93 | ½ + 93/48 | 0.4640 | 0.012 | 0.0029 | 0.0015 | 0.0010 | 0.00032 | 0.000032 |
| 94 | ½ + 94/48 | 0.4747 | 0.011 | 0.0027 | 0.0013 | 0.0009 | 0.00030 | 0.000030 |
| 95 | ½ + 95/48 | 0.4876 | 0.013 | 0.0032 | 0.0016 | 0.0011 | 0.00036 | 0.000036 |
| 96 | 2.5 | 0.5000 | 0.012 | 0.0031 | 0.0016 | 0.0010 | 0.00034 | 0.000034 |

| Average Precision per Crank: | 0.010 | 0.0026 | 0.0013 | 0.0009 | 0.00029 | 0.000029 |
|---|---|---|---|---|---|---|
| | (inch/Full C) | (inch/¼ C) | (inch/⅛ C) | (inch/ 1/12 C) | (inch/ 1/36 C) | (inch/ 1/360 C) |

Table 6-5: X_{b} = 2.5, ½ + 97/48, ½ + 98/48, to 3.0 key 5-6 equiv.

| | | | | | | | | |
|---|---|---|---|---|---|---|---|---|
| 96 | 2.5 | 0.5000 | 0.000 | 0.0000 | 0.0000 | 0.0000 | 0.00000 | 0.000000 |
| 97 | ½ + 97/48 | 0.5089 | 0.009 | 0.0022 | 0.0011 | 0.0007 | 0.00025 | 0.000025 |
| 98 | ½ + 98/48 | 0.5184 | 0.009 | 0.0024 | 0.0012 | 0.0008 | 0.00026 | 0.000026 |
| 99 | ½ + 99/48 | 0.5279 | 0.010 | 0.0024 | 0.0012 | 0.0008 | 0.00026 | 0.000026 |
| 100 | ½ + 100/48 | 0.5376 | 0.010 | 0.0024 | 0.0012 | 0.0008 | 0.00027 | 0.000027 |
| 101 | ½ + 101/48 | 0.5473 | 0.010 | 0.0024 | 0.0012 | 0.0008 | 0.00027 | 0.000027 |
| 102 | ½ + 102/48 | 0.5571 | 0.010 | 0.0025 | 0.0012 | 0.0008 | 0.00027 | 0.000027 |
| 103 | ½ + 103/48 | 0.5670 | 0.010 | 0.0025 | 0.0012 | 0.0008 | 0.00027 | 0.000027 |
| 104 | ½ + 104/48 | 0.5770 | 0.010 | 0.0025 | 0.0013 | 0.0008 | 0.00028 | 0.000028 |
| 105 | ½ + 105/48 | 0.5871 | 0.010 | 0.0025 | 0.0013 | 0.0008 | 0.00028 | 0.000028 |
| 106 | ½ + 106/48 | 0.5973 | 0.010 | 0.0026 | 0.0013 | 0.0009 | 0.00028 | 0.000028 |
| 107 | ½ + 107/48 | 0.6076 | 0.010 | 0.0026 | 0.0013 | 0.0009 | 0.00029 | 0.000029 |
| 108 | ½ + 108/48 | 0.6180 | 0.010 | 0.0026 | 0.0013 | 0.0009 | 0.00029 | 0.000029 |
| 109 | ½ + 109/48 | 0.6284 | 0.010 | 0.0026 | 0.0013 | 0.0009 | 0.00029 | 0.000029 |
| 110 | ½ + 110/48 | 0.6390 | 0.011 | 0.0027 | 0.0013 | 0.0009 | 0.00029 | 0.000029 |
| 111 | ½ + 111/48 | 0.6496 | 0.011 | 0.0026 | 0.0013 | 0.0009 | 0.00029 | 0.000029 |
| 112 | ½ + 112/48 | 0.6604 | 0.011 | 0.0027 | 0.0014 | 0.0009 | 0.00030 | 0.000030 |
| 113 | ½ + 113/48 | 0.6712 | 0.011 | 0.0027 | 0.0014 | 0.0009 | 0.00030 | 0.000030 |
| 114 | ½ + 114/48 | 0.6821 | 0.011 | 0.0027 | 0.0014 | 0.0009 | 0.00030 | 0.000030 |
| 115 | ½ + 115/48 | 0.6931 | 0.011 | 0.0028 | 0.0014 | 0.0009 | 0.00031 | 0.000031 |
| 116 | ½ + 116/48 | 0.7043 | 0.011 | 0.0028 | 0.0014 | 0.0009 | 0.00031 | 0.000031 |
| 117 | ½ + 117/48 | 0.7155 | 0.011 | 0.0028 | 0.0014 | 0.0009 | 0.00031 | 0.000031 |
| 118 | ½ + 118/48 | 0.7268 | 0.011 | 0.0028 | 0.0014 | 0.0009 | 0.00031 | 0.000031 |
| 119 | ½ + 119/48 | 0.7382 | 0.011 | 0.0028 | 0.0014 | 0.0009 | 0.00032 | 0.000032 |
| 120 | 3 | 0.7500 | 0.012 | 0.0030 | 0.0015 | 0.0010 | 0.00033 | 0.000033 |

| Average Precision per Crank: | 0.010 | 0.0026 | 0.0013 | 0.0009 | 0.00029 | 0.000029 |
|---|---|---|---|---|---|---|
| | (inch/Full C) | (inch/¼ C) | (inch/⅛ C) | (inch/ 1/12 C) | (inch/ 1/36 C) | (inch/ 1/360 C) |

Table 6-6: X_{b} = 3.0, ½ + 121/48, ½ + 122/48, to 3.5 key 6-7 equiv.

| | | | | | | | | |
|---|---|---|---|---|---|---|---|---|
| 120 | 3 | 0.7500 | 0.000 | 0.0000 | 0.0000 | 0.0000 | 0.00000 | 0.000000 |
| 121 | ½ + 121/48 | 0.7722 | 0.022 | 0.0056 | 0.0028 | 0.0019 | 0.00062 | 0.000062 |
| 122 | ½ + 122/48 | 0.7950 | 0.023 | 0.0057 | 0.0029 | 0.0019 | 0.00063 | 0.000063 |
| 123 | ½ + 123/48 | 0.8182 | 0.023 | 0.0058 | 0.0029 | 0.0019 | 0.00064 | 0.000064 |
| 124 | ½ + 124/48 | 0.8416 | 0.023 | 0.0058 | 0.0029 | 0.0020 | 0.00065 | 0.000065 |
| 125 | ½ + 125/48 | 0.8653 | 0.024 | 0.0059 | 0.0030 | 0.0020 | 0.00066 | 0.000066 |
| 126 | ½ + 126/48 | 0.8893 | 0.024 | 0.0060 | 0.0030 | 0.0020 | 0.00067 | 0.000067 |
| 127 | ½ + 127/48 | 0.9136 | 0.024 | 0.0061 | 0.0030 | 0.0020 | 0.00068 | 0.000068 |
| 128 | ½ + 128/48 | 0.9282 | 0.015 | 0.0037 | 0.0018 | 0.0012 | 0.00041 | 0.000041 |
| 129 | ½ + 129/48 | 0.9631 | 0.035 | 0.0087 | 0.0044 | 0.0029 | 0.00097 | 0.000097 |
| 130 | ½ + 130/48 | 0.9884 | 0.025 | 0.0063 | 0.0032 | 0.0021 | 0.00070 | 0.000070 |
| 131 | ½ + 131/48 | 1.0139 | 0.026 | 0.0064 | 0.0032 | 0.0021 | 0.00071 | 0.000071 |
| 132 | ½ + 132/48 | 1.0397 | 0.026 | 0.0065 | 0.0032 | 0.0022 | 0.00072 | 0.000072 |
| 133 | ½ + 133/48 | 1.0659 | 0.026 | 0.0066 | 0.0033 | 0.0022 | 0.00073 | 0.000073 |
| 134 | ½ + 134/48 | 1.0924 | 0.027 | 0.0066 | 0.0033 | 0.0022 | 0.00074 | 0.000074 |
| 135 | ½ + 135/48 | 1.1192 | 0.027 | 0.0067 | 0.0033 | 0.0022 | 0.00074 | 0.000074 |
| 136 | ½ + 136/48 | 1.1463 | 0.027 | 0.0068 | 0.0034 | 0.0023 | 0.00075 | 0.000075 |
| 137 | ½ + 137/48 | 1.1737 | 0.027 | 0.0068 | 0.0034 | 0.0023 | 0.00076 | 0.000076 |
| 138 | ½ + 138/48 | 1.2015 | 0.028 | 0.0070 | 0.0035 | 0.0023 | 0.00077 | 0.000077 |
| 139 | ½ + 139/48 | 1.2296 | 0.028 | 0.0070 | 0.0035 | 0.0023 | 0.00078 | 0.000078 |
| 140 | ½ + 140/48 | 1.2580 | 0.028 | 0.0071 | 0.0036 | 0.0024 | 0.00079 | 0.000079 |
| 141 | ½ + 141/48 | 1.2868 | 0.029 | 0.0072 | 0.0036 | 0.0024 | 0.00080 | 0.000080 |
| 142 | ½ + 142/48 | 1.3159 | 0.029 | 0.0073 | 0.0036 | 0.0024 | 0.00081 | 0.000081 |
| 143 | ½ + 143/48 | 1.3454 | 0.029 | 0.0074 | 0.0037 | 0.0025 | 0.00082 | 0.000082 |
| 144 | 3.5 | 1.3750 | 0.030 | 0.0074 | 0.0037 | 0.0025 | 0.00082 | 0.000082 |

| Average Precision per Crank: | 0.026 | 0.0065 | 0.0033 | 0.0022 | 0.00072 | 0.000072 |
|---|---|---|---|---|---|---|
| | (inch/Full C) | (inch/¼ C) | (inch/⅛ C) | (inch/ 1/12 C) | (inch/ 1/36 C) | (inch/ 1/360 C) |

Table 6-7: X_{b} = 3.5, ½ + 145/48, ½ + 146/48, to 4.0 key 7-8 equiv.

| | | | | | | | | |
|---|---|---|---|---|---|---|---|---|
| 144 | 3.5 | 1.3750 | 0.000 | 0.0000 | 0.0000 | 0.0000 | 0.00000 | 0.000000 |
| 145 | ½ + 145/48 | 1.3985 | 0.024 | 0.0059 | 0.0029 | 0.0020 | 0.00065 | 0.000065 |
| 146 | ½ + 146/48 | 1.4220 | 0.023 | 0.0059 | 0.0029 | 0.0020 | 0.00065 | 0.000065 |
| 147 | ½ + 147/48 | 1.4458 | 0.024 | 0.0060 | 0.0030 | 0.0020 | 0.00066 | 0.000066 |
| 148 | ½ + 148/48 | 1.4697 | 0.024 | 0.0060 | 0.0030 | 0.0020 | 0.00066 | 0.000066 |
| 149 | ½ + 149/48 | 1.4940 | 0.024 | 0.0061 | 0.0030 | 0.0020 | 0.00068 | 0.000068 |
| 150 | ½ + 150/48 | 1.5184 | 0.024 | 0.0061 | 0.0031 | 0.0020 | 0.00068 | 0.000068 |
| 151 | ½ + 151/48 | 1.5431 | 0.025 | 0.0062 | 0.0031 | 0.0021 | 0.00069 | 0.000069 |
| 152 | ½ + 152/48 | 1.5680 | 0.025 | 0.0062 | 0.0031 | 0.0021 | 0.00069 | 0.000069 |
| 153 | ½ + 153/48 | 1.5931 | 0.025 | 0.0063 | 0.0031 | 0.0021 | 0.00070 | 0.000070 |
| 154 | ½ + 154/48 | 1.6185 | 0.025 | 0.0064 | 0.0032 | 0.0021 | 0.00071 | 0.000071 |
| 155 | ½ + 155/48 | 1.6442 | 0.026 | 0.0064 | 0.0032 | 0.0021 | 0.00071 | 0.000071 |
| 156 | ½ + 156/48 | 1.6700 | 0.026 | 0.0064 | 0.0032 | 0.0021 | 0.00072 | 0.000072 |
| 157 | ½ + 157/48 | 1.6961 | 0.026 | 0.0065 | 0.0033 | 0.0022 | 0.00073 | 0.000073 |
| 158 | ½ + 158/48 | 1.7225 | 0.026 | 0.0066 | 0.0033 | 0.0022 | 0.00073 | 0.000073 |
| 159 | ½ + 159/48 | 1.7490 | 0.027 | 0.0066 | 0.0033 | 0.0022 | 0.00074 | 0.000074 |
| 160 | ½ + 160/48 | 1.7758 | 0.027 | 0.0067 | 0.0033 | 0.0022 | 0.00074 | 0.000074 |
| 161 | ½ + 161/48 | 1.8029 | 0.027 | 0.0068 | 0.0034 | 0.0023 | 0.00075 | 0.000075 |
| 162 | ½ + 162/48 | 1.8303 | 0.027 | 0.0069 | 0.0034 | 0.0023 | 0.00076 | 0.000076 |
| 163 | ½ + 163/48 | 1.8578 | 0.027 | 0.0069 | 0.0034 | 0.0023 | 0.00076 | 0.000076 |
| 164 | ½ + 164/48 | 1.8857 | 0.028 | 0.0070 | 0.0035 | 0.0023 | 0.00078 | 0.000078 |
| 165 | ½ + 165/48 | 1.9138 | 0.028 | 0.0070 | 0.0035 | 0.0023 | 0.00078 | 0.000078 |
| 166 | ½ + 166/48 | 1.9421 | 0.028 | 0.0071 | 0.0035 | 0.0024 | 0.00079 | 0.000079 |
| 167 | ½ + 167/48 | 1.9707 | 0.029 | 0.0071 | 0.0036 | 0.0024 | 0.00079 | 0.000079 |
| 168 | 4 | 2.0000 | 0.029 | 0.0073 | 0.0037 | 0.0024 | 0.00081 | 0.000081 |

| Average Precision per Crank: | 0.026 | 0.0065 | 0.0033 | 0.0022 | 0.00072 | 0.000072 |
|---|---|---|---|---|---|---|
| | (inch/Full C) | (inch/¼ C) | (inch/⅛ C) | (inch/ 1/12 C) | (inch/ 1/36 C) | (inch/ 1/360 C) |

TABLE 7

| | | | | | | | | |
|---|---|---|---|---|---|---|---|---|
| | | | Precision | Precision | Precision | Precision | Precision | Precision |
| Crank (C) | | | Per Full C | Per ¼ C | Per ⅛ C | Per 1/12 C | Per 1/36 C | 1/360 C |
| Full 360/C | X_{b} | Y_{b} | (360 deg) | (90 deg) | (45 deg) | (30 deg) | (10 deg) | (1 degree) |

¼ Size PEMD Displacement Precision: Face Ht. = ¾″,
3/16 - 72 UNS, Roller Dia. = ½″. Track L = 2¾″
Table 7-1: X_{b} = ¼, ¼ + 1/72, ¼ + 2/72, to ½ key 1-2 equiv.

| | | | | | | | | |
|---|---|---|---|---|---|---|---|---|
| 0 | ¼−0.1875 | start | start | start | start | start | start | |
| 1 | ¼ + 1/72 | −0.1836 | 0.0039 | 0.00097 | 0.00049 | 0.00032 | 0.00011 | 0.000011 |
| 2 | ¼ + 2/72 | −0.1788 | 0.0048 | 0.00120 | 0.00060 | 0.00040 | 0.00013 | 0.000013 |
| 3 | ¼ + 3/72 | −0.1734 | 0.0054 | 0.00135 | 0.00067 | 0.00045 | 0.00015 | 0.000015 |
| 4 | ¼ + 4/72 | −0.1672 | 0.0062 | 0.00155 | 0.00078 | 0.00052 | 0.00017 | 0.000017 |
| 5 | ¼ + 5/72 | −0.1601 | 0.0071 | 0.00178 | 0.00089 | 0.00059 | 0.00020 | 0.000020 |
| 6 | ¼ + 6/72 | −0.1525 | 0.0076 | 0.00190 | 0.00095 | 0.00063 | 0.00021 | 0.000021 |
| 7 | ¼ + 7/72 | −0.1440 | 0.0085 | 0.00213 | 0.00106 | 0.00071 | 0.00024 | 0.000024 |
| 8 | ¼ + 8/72 | −0.1349 | 0.0091 | 0.00228 | 0.00114 | 0.00076 | 0.00025 | 0.000025 |
| 9 | ¼ + 9/72 | −0.1250 | 0.0099 | 0.00248 | 0.00124 | 0.00082 | 0.00028 | 0.000028 |
| 10 | ¼ + 10/72 | −0.1144 | 0.0106 | 0.00265 | 0.00133 | 0.00088 | 0.00029 | 0.000029 |
| 11 | ¼ + 11/72 | −0.1030 | 0.0114 | 0.00285 | 0.00143 | 0.00095 | 0.00032 | 0.000032 |
| 12 | ¼ + 12/72 | −0.0908 | 0.0122 | 0.00305 | 0.00153 | 0.00102 | 0.00034 | 0.000034 |
| 13 | ¼ + 13/72 | −0.0778 | 0.0130 | 0.00325 | 0.00163 | 0.00108 | 0.00036 | 0.000036 |
| 14 | ¼ + 14/72 | −0.0640 | 0.0138 | 0.00345 | 0.00173 | 0.00115 | 0.00038 | 0.000038 |
| 15 | ¼ + 15/72 | −0.0493 | 0.0147 | 0.00368 | 0.00184 | 0.00123 | 0.00041 | 0.000041 |
| 16 | ¼ + 16/72 | −0.0338 | 0.0155 | 0.00388 | 0.00194 | 0.00129 | 0.00043 | 0.000043 |
| 17 | ¼ + 17/72 | −0.0174 | 0.0164 | 0.00410 | 0.00205 | 0.00137 | 0.00046 | 0.000046 |
| 18 | ½0.0000 | 0.0000 | 0.00000 | 0.00000 | 0.00000 | 0.00000 | 0.000000 | |

| Average Precision per Crank: | 0.009 | 0.0024 | 0.0012 | 0.0008 | 0.00026 | 0.000026 |
|---|---|---|---|---|---|---|
| | (inch/Full C) | (inch/¼ C) | (inch/⅛ C) | (inch/ 1/12 C) | (inch/ 1/36 C) | (inch/ 1/360 C) |

6 Digit ¼ Size PEMD Displacement Precision: Face Ht. = ¾″,
3/16 - 72 UNS, Roller Dia. = ½″. Track L = 2¾″
Table 7-2: X_{b} = ½, ¼ + 19/72, ¼ + 20/72, to ¾ key 2-3 equiv.

| | | | | | | | | |
|---|---|---|---|---|---|---|---|---|
| 18 | ½0.0000 | 0.0000 | 0.00000 | 0.00000 | 0.00000 | 0.00000 | 0.000000 | |
| 19 | ¼ + 19/72 | 0.002371 | 0.0024 | 0.00059 | 0.00030 | 0.00020 | 0.00007 | 0.000007 |
| 20 | ¼ + 20/72 | 0.004871 | 0.0025 | 0.00063 | 0.00031 | 0.00021 | 0.00007 | 0.000007 |
| 21 | ¼ + 21/72 | 0.007500 | 0.0026 | 0.00066 | 0.00033 | 0.00022 | 0.00007 | 0.000007 |
| 22 | ¼ + 22/72 | 0.010257 | 0.0028 | 0.00069 | 0.00034 | 0.00023 | 0.00008 | 0.000008 |
| 23 | ¼ + 23/72 | 0.013140 | 0.0029 | 0.00072 | 0.00036 | 0.00024 | 0.00008 | 0.000008 |
| 24 | ¼ + 24/72 | 0.016154 | 0.0030 | 0.00075 | 0.00038 | 0.00025 | 0.00008 | 0.000008 |
| 25 | ¼ + 25/72 | 0.019230 | 0.0031 | 0.00077 | 0.00038 | 0.00026 | 0.00009 | 0.000009 |
| 26 | ¼ + 26/72 | 0.022570 | 0.0033 | 0.00084 | 0.00042 | 0.00028 | 0.00009 | 0.000009 |
| 27 | ¼ + 27/72 | 0.025972 | 0.0034 | 0.00085 | 0.00043 | 0.00028 | 0.00009 | 0.000009 |
| 28 | ¼ + 28/72 | 0.029504 | 0.0035 | 0.00088 | 0.00044 | 0.00029 | 0.00010 | 0.000010 |
| 29 | ¼ + 29/72 | 0.033165 | 0.0037 | 0.00092 | 0.00046 | 0.00031 | 0.00010 | 0.000010 |
| 30 | ¼ + 30/72 | 0.036957 | 0.0038 | 0.00095 | 0.00047 | 0.00032 | 0.00011 | 0.000011 |
| 31 | ¼ + 31/72 | 0.040879 | 0.0039 | 0.00098 | 0.00049 | 0.00033 | 0.00011 | 0.000011 |
| 32 | ¼ + 32/72 | 0.044924 | 0.0040 | 0.00101 | 0.00051 | 0.00034 | 0.00011 | 0.000011 |
| 33 | ¼ + 33/72 | 0.049107 | 0.0042 | 0.00105 | 0.00052 | 0.00035 | 0.00012 | 0.000012 |
| 34 | ¼ + 34/72 | 0.053420 | 0.0043 | 0.00108 | 0.00054 | 0.00036 | 0.00012 | 0.000012 |
| 35 | ¼ + 35/72 | 0.057865 | 0.0044 | 0.00111 | 0.00056 | 0.00037 | 0.00012 | 0.000012 |
| 36 | ¾0.0625 | 0.0046 | 0.00115 | 0.00057 | 0.00038 | 0.00013 | 0.000013 | |

| Average Precision per Crank: | 0.003 | 0.0009 | 0.0004 | 0.0003 | 0.00010 | 0.000010 |
|---|---|---|---|---|---|---|
| | (inch/Full C) | (inch/¼ C) | (inch/⅛ C) | (inch/ 1/12 C) | (inch/ 1/36 C) | (inch/ 1/360 C) |

¼ Size PEMD Displacement Precision: Face Ht. = ¾″,
3/16 - 72 UNS, Roller Dia. = ½″. Track L = 2¾″
Table 7-3: X_{b} = ¾, ¼ + 37/72, ¼ + 38/72, to 1.0 key 3-4 equiv.

| | | | | | | | | |
|---|---|---|---|---|---|---|---|---|
| 36 | ¾0.0625 | 0.0000 | 0.00000 | 0.00000 | 0.00000 | 0.00000 | 0.000000 | |
| 37 | ¼ + 37/72 | 0.0654 | 0.0029 | 0.00073 | 0.00036 | 0.00024 | 0.00008 | 0.000008 |
| 38 | ¼ + 38/72 | 0.0683 | 0.0029 | 0.00073 | 0.00036 | 0.00024 | 0.00008 | 0.000008 |
| 39 | ¼ + 39/72 | 0.0714 | 0.0031 | 0.00078 | 0.00039 | 0.00026 | 0.00009 | 0.000009 |
| 40 | ¼ + 40/72 | 0.0745 | 0.0031 | 0.00077 | 0.00039 | 0.00026 | 0.00009 | 0.000009 |
| 41 | ¼ + 41/72 | 0.0777 | 0.0032 | 0.00080 | 0.00040 | 0.00027 | 0.00009 | 0.000009 |
| 42 | ¼ + 42/72 | 0.0809 | 0.0032 | 0.00080 | 0.00040 | 0.00027 | 0.00009 | 0.000009 |
| 43 | ¼ + 43/72 | 0.0842 | 0.0033 | 0.00082 | 0.00041 | 0.00028 | 0.00009 | 0.000009 |
| 44 | ¼ + 44/72 | 0.0876 | 0.0034 | 0.00085 | 0.00043 | 0.00028 | 0.00009 | 0.000009 |
| 45 | ¼ + 45/72 | 0.0910 | 0.0034 | 0.00085 | 0.00043 | 0.00028 | 0.00009 | 0.000009 |
| 46 | ¼ + 46/72 | 0.0945 | 0.0035 | 0.00088 | 0.00044 | 0.00029 | 0.00010 | 0.000010 |
| 47 | ¼ + 47/72 | 0.0981 | 0.0036 | 0.00090 | 0.00045 | 0.00030 | 0.00010 | 0.000010 |
| 48 | ¼ + 48/72 | 0.1018 | 0.0037 | 0.00092 | 0.00046 | 0.00031 | 0.00010 | 0.000010 |
| 49 | ¼ + 49/72 | 0.1054 | 0.0036 | 0.00090 | 0.00045 | 0.00030 | 0.00010 | 0.000010 |
| 50 | ¼ + 50/72 | 0.1092 | 0.0038 | 0.00095 | 0.00048 | 0.00032 | 0.00011 | 0.000011 |
| 51 | ¼ + 51/72 | 0.1130 | 0.0038 | 0.00095 | 0.00048 | 0.00032 | 0.00011 | 0.000011 |
| 52 | ¼ + 52/72 | 0.1169 | 0.0039 | 0.00098 | 0.00049 | 0.00033 | 0.00011 | 0.000011 |
| 53 | ¼ + 53/72 | 0.1209 | 0.0040 | 0.00100 | 0.00050 | 0.00033 | 0.00011 | 0.000011 |
| 54 | 1 | 0.1250 | 0.0041 | 0.00103 | 0.00051 | 0.00034 | 0.00011 | 0.000011 |

| Average Precision per Crank: | 0.003 | 0.0009 | 0.0004 | 0.0003 | 0.00010 | 0.000010 |
|---|---|---|---|---|---|---|
| | (inch/Full C) | (inch/¼ C) | (inch/⅛ C) | (inch/ 1/12 C) | (inch/ 1/36 C) | (inch/ 1/360 C) |

Table 7-4: X_{b} = 1.0, ¼ + 55/72, ¼ + 56/72, to 1.25 key 4-5 equiv.

| | | | | | | | | |
|---|---|---|---|---|---|---|---|---|
| 54 | 1 | 0.1250 | 0.0000 | 0.00000 | 0.00000 | 0.00000 | 0.00000 | 0.000000 |
| 55 | ¼ + 55/72 | 0.1308 | 0.0058 | 0.00145 | 0.00073 | 0.00048 | 0.00016 | 0.000016 |
| 56 | ¼ + 5672 | 0.1369 | 0.0061 | 0.00153 | 0.00076 | 0.00051 | 0.00017 | 0.000017 |
| 57 | ¼ + 57/72 | 0.1430 | 0.0061 | 0.00153 | 0.00076 | 0.00051 | 0.00017 | 0.000017 |
| 58 | ¼ + 58/72 | 0.1493 | 0.0063 | 0.00158 | 0.00079 | 0.00053 | 0.00018 | 0.000018 |
| 59 | ¼ + 59/72 | 0.1556 | 0.0063 | 0.00158 | 0.00079 | 0.00053 | 0.00018 | 0.000018 |
| 60 | ¼ + 60/72 | 0.1622 | 0.0066 | 0.00165 | 0.00083 | 0.00055 | 0.00018 | 0.000018 |
| 61 | ¼ + 61/72 | 0.1688 | 0.0066 | 0.00165 | 0.00082 | 0.00055 | 0.00018 | 0.000018 |
| 62 | ¼ + 62/72 | 0.1755 | 0.0067 | 0.00168 | 0.00084 | 0.00056 | 0.00019 | 0.000019 |
| 63 | ¼ + 63/72 | 0.1824 | 0.0069 | 0.00173 | 0.00086 | 0.00058 | 0.00019 | 0.000019 |
| 64 | ¼ + 64/72 | 0.1894 | 0.0070 | 0.00175 | 0.00088 | 0.00058 | 0.00019 | 0.000019 |
| 65 | ¼ + 65/72 | 0.1965 | 0.0071 | 0.00178 | 0.00089 | 0.00059 | 0.00020 | 0.000020 |
| 66 | ¼ + 66/72 | 0.2038 | 0.0073 | 0.00183 | 0.00091 | 0.00061 | 0.00020 | 0.000020 |
| 67 | ¼ + 67/72 | 0.2111 | 0.0073 | 0.00183 | 0.00091 | 0.00061 | 0.00020 | 0.000020 |
| 68 | ¼ + 68/72 | 0.2186 | 0.0075 | 0.00187 | 0.00094 | 0.00062 | 0.00021 | 0.000021 |
| 69 | ¼ + 69/72 | 0.2262 | 0.0076 | 0.00190 | 0.00095 | 0.00063 | 0.00021 | 0.000021 |
| 70 | ¼ + 70/72 | 0.2339 | 0.0077 | 0.00193 | 0.00096 | 0.00064 | 0.00021 | 0.000021 |
| 71 | ¼ + 71/72 | 0.2418 | 0.0079 | 0.00198 | 0.00099 | 0.00066 | 0.00022 | 0.000022 |
| 72 | 1.25 | 0.2500 | 0.0082 | 0.00205 | 0.00103 | 0.00068 | 0.00023 | 0.000023 |

| Average Precision per Crank: | 0.007 | 0.0017 | 0.0009 | 0.0006 | 0.00019 | 0.000019 |
|---|---|---|---|---|---|---|
| | (inch/Full C) | (inch/¼ C) | (inch/⅛ C) | (inch/ 1/12 C) | (inch/ 1/36 C) | (inch/ 1/360 C) |

Table 7-5: X_{b} = 1.25, ¼ + 73/72, ¼ + 74/72, to 1.5 key 5-6 equiv.

| | | | | | | | | |
|---|---|---|---|---|---|---|---|---|
| 72 | 1.25 | 0.2500 | 0.0000 | 0.00000 | 0.00000 | 0.00000 | 0.00000 | 0.000000 |
| 73 | ¼ + 73/72 | 0.2560 | 0.0060 | 0.00150 | 0.00075 | 0.00050 | 0.00017 | 0.000017 |
| 74 | ¼ + 7472 | 0.2624 | 0.0064 | 0.00160 | 0.00080 | 0.00053 | 0.00018 | 0.000018 |
| 75 | ¼ + 75/72 | 0.2688 | 0.0064 | 0.00160 | 0.00080 | 0.00053 | 0.00018 | 0.000018 |
| 76 | ¼ + 76/72 | 0.2753 | 0.0065 | 0.00163 | 0.00081 | 0.00054 | 0.00018 | 0.000018 |
| 77 | ¼ + 77/72 | 0.2819 | 0.0066 | 0.00165 | 0.00082 | 0.00055 | 0.00018 | 0.000018 |
| 78 | ¼ + 78/72 | 0.2885 | 0.0066 | 0.00165 | 0.00082 | 0.00055 | 0.00018 | 0.000018 |
| 79 | ¼ + 79/72 | 0.2953 | 0.0068 | 0.00170 | 0.00085 | 0.00057 | 0.00019 | 0.000019 |
| 80 | ¼ + 80/72 | 0.3021 | 0.0068 | 0.00170 | 0.00085 | 0.00057 | 0.00019 | 0.000019 |
| 81 | ¼ + 81/72 | 0.3090 | 0.0069 | 0.00173 | 0.00086 | 0.00058 | 0.00019 | 0.000019 |
| 82 | ¼ + 82/72 | 0.3160 | 0.0070 | 0.00175 | 0.00088 | 0.00058 | 0.00019 | 0.000019 |
| 83 | ¼ + 83/72 | 0.3231 | 0.0071 | 0.00178 | 0.00089 | 0.00059 | 0.00020 | 0.000020 |
| 84 | ¼ + 84/72 | 0.3302 | 0.0071 | 0.00178 | 0.00089 | 0.00059 | 0.00020 | 0.000020 |
| 85 | ¼ + 85/72 | 0.3374 | 0.0072 | 0.00180 | 0.00090 | 0.00060 | 0.00020 | 0.000020 |
| 86 | ¼ + 86/72 | 0.3447 | 0.0073 | 0.00183 | 0.00091 | 0.00061 | 0.00020 | 0.000020 |
| 87 | ¼ + 87/72 | 0.3521 | 0.0074 | 0.00185 | 0.00093 | 0.00062 | 0.00021 | 0.000021 |
| 88 | ¼ + 88/72 | 0.3596 | 0.0075 | 0.00187 | 0.00094 | 0.00062 | 0.00021 | 0.000021 |
| 89 | ¼ + 89/72 | 0.3672 | 0.0076 | 0.00190 | 0.00095 | 0.00063 | 0.00021 | 0.000021 |
| 90 | 1.5 | 0.3750 | 0.0078 | 0.00195 | 0.00097 | 0.00065 | 0.00022 | 0.000022 |

| Average Precision per Crank: | 0.007 | 0.0017 | 0.0009 | 0.0006 | 0.00019 | 0.000019 |
|---|---|---|---|---|---|---|
| | (inch/Full C) | (inch/¼ C) | (inch/⅛C) | (inch/ 1/12 C) | (inch/ 1/36 C) | (inch/ 1/360 C) |

Table 7-6: X_{b} = 1.5, ¼ + 91/72, ¼ + 92/72, to 1.75 key 6-7 equiv.

| | | | | | | | | |
|---|---|---|---|---|---|---|---|---|
| 90 | 1.5 | 0.3750 | 0.0000 | 0.00000 | 0.00000 | 0.00000 | 0.00000 | 0.000000 |
| 91 | ¼ + 91/72 | 0.3899 | 0.0149 | 0.00373 | 0.00186 | 0.00124 | 0.00041 | 0.000041 |
| 92 | ¼ + 9272 | 0.4052 | 0.0153 | 0.00383 | 0.00191 | 0.00128 | 0.00042 | 0.000042 |
| 93 | ¼ + 93/72 | 0.4208 | 0.0156 | 0.00390 | 0.00195 | 0.00130 | 0.00043 | 0.000043 |
| 94 | ¼ + 94/72 | 0.4366 | 0.0158 | 0.00395 | 0.00198 | 0.00132 | 0.00044 | 0.000044 |
| 95 | ¼ + 95/72 | 0.4516 | 0.0150 | 0.00375 | 0.00188 | 0.00125 | 0.00042 | 0.000042 |
| 96 | ¼ + 96/72 | 0.4691 | 0.0175 | 0.00438 | 0.00219 | 0.00146 | 0.00049 | 0.000049 |
| 97 | ¼ + 97/72 | 0.4857 | 0.0166 | 0.00415 | 0.00208 | 0.00138 | 0.00046 | 0.000046 |
| 98 | ¼ + 98/72 | 0.5026 | 0.0169 | 0.00423 | 0.00211 | 0.00141 | 0.00047 | 0.000047 |
| 99 | ¼ + 99/72 | 0.5198 | 0.0172 | 0.00430 | 0.00215 | 0.00143 | 0.00048 | 0.000048 |
| 100 | ¼ + 100/72 | 0.5373 | 0.0175 | 0.00437 | 0.00219 | 0.00146 | 0.00049 | 0.000049 |
| 101 | ¼ + 101/72 | 0.5550 | 0.0177 | 0.00443 | 0.00221 | 0.00148 | 0.00049 | 0.000049 |
| 102 | ¼ + 102/72 | 0.5730 | 0.0180 | 0.00450 | 0.00225 | 0.00150 | 0.00050 | 0.000050 |
| 103 | ¼ + 103/72 | 0.5914 | 0.0184 | 0.00460 | 0.00230 | 0.00153 | 0.00051 | 0.000051 |
| 104 | ¼ + 104/72 | 0.6100 | 0.0186 | 0.00465 | 0.00232 | 0.00155 | 0.00052 | 0.000052 |
| 105 | ¼ + 105/72 | 0.6289 | 0.0189 | 0.00473 | 0.00236 | 0.00158 | 0.00053 | 0.000053 |
| 106 | ¼ + 106/72 | 0.6481 | 0.0192 | 0.00480 | 0.00240 | 0.00160 | 0.00053 | 0.000053 |
| 107 | ¼ + 107/72 | 0.6676 | 0.0195 | 0.00487 | 0.00244 | 0.00163 | 0.00054 | 0.000054 |
| 108 | 1.75 | 0.6875 | 0.0199 | 0.00498 | 0.00249 | 0.00166 | 0.00055 | 0.000055 |

| Average Precision per Crank: | 0.017 | 0.0043 | 0.0022 | 0.0014 | 0.00048 | 0.000048 |
|---|---|---|---|---|---|---|
| | (inch/Full C) | (inch/¼ C) | (inch/⅛C) | (inch/ 1/12 C) | (inch/ 1/36 C) | (inch/ 1/360 C) |

Table 7-7: X_{b} = 1.75, ¼ + 109/72, ¼ + 110/72, to 2.0 key 7-8 equiv.

| | | | | | | | | |
|---|---|---|---|---|---|---|---|---|
| 108 | 1.75 | 0.6875 | 0.0000 | 0.00000 | 0.00000 | 0.00000 | 0.00000 | 0.000000 |
| 109 | ¼ + 91/72 | 0.7032 | 0.0157 | 0.00393 | 0.00196 | 0.00131 | 0.00044 | 0.000044 |
| 110 | ¼ + 9272 | 0.7189 | 0.0157 | 0.00392 | 0.00196 | 0.00131 | 0.00044 | 0.000044 |
| 111 | ¼ + 93/72 | 0.7349 | 0.0160 | 0.00400 | 0.00200 | 0.00133 | 0.00044 | 0.000044 |
| 112 | ¼ + 94/72 | 0.7511 | 0.0162 | 0.00405 | 0.00203 | 0.00135 | 0.00045 | 0.000045 |
| 113 | ¼ + 95/72 | 0.7674 | 0.0163 | 0.00408 | 0.00204 | 0.00136 | 0.00045 | 0.000045 |
| 114 | ¼ + 96/72 | 0.7840 | 0.0166 | 0.00415 | 0.00208 | 0.00138 | 0.00046 | 0.000046 |
| 115 | ¼ + 97/72 | 0.8008 | 0.0168 | 0.00420 | 0.00210 | 0.00140 | 0.00047 | 0.000047 |
| 116 | ¼ + 98/72 | 0.8178 | 0.0170 | 0.00425 | 0.00213 | 0.00142 | 0.00047 | 0.000047 |
| 117 | ¼ + 99/72 | 0.8350 | 0.0172 | 0.00430 | 0.00215 | 0.00143 | 0.00048 | 0.000048 |
| 118 | ¼ + 100/72 | 0.8524 | 0.0174 | 0.00435 | 0.00218 | 0.00145 | 0.00048 | 0.000048 |
| 119 | ¼ + 101/72 | 0.8701 | 0.0177 | 0.00442 | 0.00221 | 0.00147 | 0.00049 | 0.000049 |
| 120 | ¼ + 102/72 | 0.8879 | 0.0178 | 0.00445 | 0.00223 | 0.00148 | 0.00049 | 0.000049 |
| 121 | ¼ + 103/72 | 0.9060 | 0.0181 | 0.00453 | 0.00226 | 0.00151 | 0.00050 | 0.000050 |
| 122 | ¼ + 104/72 | 0.9243 | 0.0183 | 0.00458 | 0.00229 | 0.00153 | 0.00051 | 0.000051 |
| 123 | ¼ + 105/72 | 0.9428 | 0.0185 | 0.00462 | 0.00231 | 0.00154 | 0.00051 | 0.000051 |
| 124 | ¼ + 106/72 | 0.9616 | 0.0188 | 0.00470 | 0.00235 | 0.00157 | 0.00052 | 0.000052 |
| 125 | ¼ + 107/72 | 0.9806 | 0.0190 | 0.00475 | 0.00238 | 0.00158 | 0.00053 | 0.000053 |
| 126 | 2 | 1.0000 | 0.0194 | 0.00485 | 0.00243 | 0.00162 | 0.00054 | 0.000054 |

| Average Precision per Crank: | 0.017 | 0.0043 | 0.0022 | 0.0014 | 0.00048 | 0.000048 |
|---|---|---|---|---|---|---|
| | (inch/Full C) | (inch/¼ C) | (inch/⅛ C) | (inch/ 1/12 C) | (inch/ 1/36 C) | (inch/ 1/360 C) |

TABLE 8-1
PEMD Domain and Range Values in Binary Format
PEMD Size Equal to or Larger Than Prototype (Full-Size):

| Size | | Binary | | | Binary | |
|---|---|---|---|---|---|---|
| nX | PEMD | Domain | | PEMD | Range | |
| Value | Domain | Equiv. | | Range | Equiv. | |
| nX | | 2ⁿ to 2ⁿ⁺² | | | 0 to 2ⁿ⁺¹ | |
| . | | . | . | | . | . |
| . | | . | . | | . | . |
| . | | . | . | | . | . |

| | | | | | |
|---|---|---|---|---|---|
| 5X | 5 X Full | 32 to 128 | 2⁵ to 2⁽⁵⁾⁺² | 0 to 64 | 0 to 2⁽⁵⁾⁺¹ |
| 4X | 4 X Full | 16 to 64 | 2⁴ to 2⁽⁴⁾⁺² | 0 to 32 | 0 to 2⁽⁴⁾⁺¹ |
| 3X | 3 X Full | 8 to 32 | 2³ to 2⁽³⁾⁺² | 0 to 16 | 0 to 2⁽³⁾⁺¹ |
| 2X | 2 X Full | 4 to 16 | 2¹ to 2⁽²⁾⁺² | 0 to 8 | 0 to 2⁽²⁾⁺¹ |
| 1X | Full-Size | 2 to 8 | 2¹ to 2⁽¹⁾⁺² | 0 to 4 | 0 to 2⁽¹⁾⁺¹ |

PEMD Sizes Smaller Than Full-Size (also referred to as Fractional PEMD):

| Size | Binary | | | | | | |
|---|---|---|---|---|---|---|---|
| n | Size | PEMD | Binary | | PEMD | Binary | |
| Value | Value | Domain | Domain Equiv. | | Range | Range Equiv. | |
| | | | D_{L} | D_{U} | | R_{L} | R_{U} |
| | | | . | . | | . | . |
| | | | . | . | | . | . |
| | | | . | . | | . | . |
| n | 1/(2ⁿ⁺¹) | | 1/(2ⁿ) to 1/(2ⁿ⁻²) | | | 0 to 1/[2 (2ⁿ⁻²)]] | |
| . | . | | . | . | | . | . |
| . | . | | . | . | | . | . |
| . | . | | . | . | | . | . |
| 0 | 1/2 1/2⁽⁰⁾⁺¹ | 1 to 4 | 1/[2⁽⁰⁾] to 1/[2⁽⁰⁾⁻²] | | 0 to 2 | 0 to 1/{2 [2⁽⁰⁾⁻²]} | |
| 1 | 1/4 1/2⁽¹⁾⁺¹ | 1/2 to 2 | 1/[2⁽¹⁾] to 1/[2⁽¹⁾⁻²] | | 0 to 1 | 0 to 1/{2 [2⁽¹⁾⁻²]} | |
| 2 | 1/8 1/2⁽²⁾⁺¹ | 1/4 to 1 | 1/[2⁽²⁾] to 1/[2⁽²⁾⁻²] | | 0 to 1/2 | 0 to 1/{2 [2⁽²⁾⁻²]} | |
| 3 | 1/16 1/2⁽³⁾⁺¹ | 1/8 to 1/2 | 1/[2⁽³⁾] to 1/[2⁽³⁾⁻²] | | 0 to 1/4 | 0 to 1/{2 [2⁽³⁾⁻²]} | |
| 4 | 1/32 1/2⁽⁴⁾⁺¹ | 1/16 to 1/4 | 1/[2⁽⁴⁾] to 1/[2⁽⁴⁾⁻²] | | 0 to 1/8 | 0 to 1/{2⁽⁴⁾⁻²]} | |
| 5 | 1/64 1/2⁽⁵⁾⁺¹ | 1/32 to 1/8 | 1/[2⁽⁵⁾] to 1/[2⁽⁵⁾⁻²] | | 0 to 1/16 | 0 to 1/{2⁽⁵⁾⁻²]} | |
| 6 | 1/128 | 1/64 to 1/16 | 1/[2⁽⁶⁾] to 1/[2⁽⁶⁾⁻²] | | 0 to 1/32 | 0 to 1/{2⁽⁶⁾⁻²]} | |
| | 1/2⁽⁶⁾⁺¹ | | | | | | |
| 7 | 1/256 | 1/128 to 1/32 | 1/[2⁽⁷⁾] to 1/[2⁽⁷⁾⁻²] | | 0 to 1/64 | 0 to 1/{2⁽⁷⁾⁻²]} | |
| | 1/2⁽⁷⁾⁺¹ | | | | | | |
| | . | | . | . | | . | . |
| | . | | . | . | | . | . |
| | . | | . | . | | . | . |

| | | | |
|---|---|---|---|
| n | 1/2ⁿ⁺¹ | 1/(2ⁿ) to 1/(2ⁿ⁻²) | 0 to 1/[2 (2ⁿ⁻²)] |

TABLE 8-2
PEMD Key Scheme & PEM Algorithm Most Significant Digit (MSD) Real
Numbers of Avg. ppc expressed in Power of 10 in Standard Form.

| | | | | MSD | | | | | |
|---|---|---|---|---|---|---|---|---|---|
| | Domain | Range | Range | 360 | 90 | 45 | 30 | 10 | 1 |
| Crank | Lower-Upper | Lower | Upper | 2 pi | pi/2 | pi/4 | pi/6 | pi/18 | pi/180 |

Prototype (Full Size) (tpi = 10)

| | | | | | | | | | | |
|---|---|---|---|---|---|---|---|---|---|---|
| Key | | | | | | | | | | |
| 1-2 | 0-10 | 1-2 | −0.75 | 0.00 | −2 | −2 | −3 | −3 | −3 | −4 |
| 2-3 | 10-20 | 2-3 | 0.00 | 0.25 | −2 | −3 | −3 | −3 | −4 | −5 |
| 3-4 | 20-30 | 3-4 | 0.25 | 0.50 | −2 | −3 | −3 | −3 | −4 | −5 |
| 4-5 | 30-40 | 4-5 | 0.50 | 1.00 | −2 | −2 | −3 | −3 | −3 | −4 |
| 5-6 | 40-50 | 5-6 | 1.00 | 1.50 | −2 | −2 | −2 | −3 | −3 | −4 |
| 6-7 | 50-60 | 6-7 | 1.50 | 2.75 | −1 | −2 | −2 | −2 | −3 | −4 |
| 7-8 | 60-70 | 7-8 | 2.75 | 4.00 | −1 | −2 | −2 | −2 | −3 | −4 |
| | | | | Exp.: | −2 | −2.67 | −3 | −3 | −3.67 | −4.67 |

PEMD Full Size (tpi = 40)

| | | | | | | | | | | |
|---|---|---|---|---|---|---|---|---|---|---|
| 1-2 | 0-10 | 1.00-1.25 | −0.75 | −0.6549 | −2 | −3 | −3 | −3 | −4 | −5 |
| 1-2 | 10-20 | 1.25-1.50 | −0.6549 | −0.5 | −2 | −3 | −3 | −3 | −4 | −5 |
| 1-2 | 20-30 | 1.50-1.75 | −0.5 | −0.284 | −2 | −3 | −3 | −3 | −4 | −5 |
| 1-2 | 30-40 | 1.75-2.00 | −0.284 | 0 | −2 | −3 | −3 | −3 | −4 | −5 |
| 2-3 | 40-50 | 2.00-2.25 | 0 | 0.0467 | −3 | −3 | −4 | −4 | −4 | −5 |
| 2-3 | 50-60 | 2.25-2.50 | 0.0467 | 0.1039 | −3 | −3 | −4 | −4 | −4 | −5 |
| 2-3 | 60-70 | 2.50-2.75 | −0.1039 | 0.1716 | −3 | −3 | −4 | −4 | −4 | −5 |
| 2-3 | 70-80 | 2.75-3.00 | 0.1716 | 0.25 | −3 | −3 | −3 | −4 | −4 | −5 |
| 3-4 | 80-90 | 3.00-3.25 | 0.25 | 0.3044 | −3 | −3 | −4 | −4 | −4 | −5 |
| 3-4 | 90-100 | 3.25-3.50 | 0.3044 | 0.3642 | −3 | −3 | −4 | −4 | −4 | −5 |
| 3-4 | 100-110 | 3.50-3.75 | 0.3642 | 0.4292 | −3 | −3 | −4 | −4 | −4 | −5 |
| 3-4 | 110-120 | 3.75-4.00 | 0.4292 | 0.5 | −3 | −3 | −4 | −4 | −4 | −5 |
| 4-5 | 120-130 | 4.00-4.25 | 0.5 | 0.6098 | −2 | −3 | −3 | −4 | −4 | −5 |
| 4-5 | 130-140 | 4.25-4.50 | 0.6098 | 0.7296 | −2 | −3 | −3 | −3 | −4 | −5 |
| 4-5 | 140-150 | 4.50-4.75 | 0.7296 | 0.8594 | −2 | −3 | −3 | −3 | −4 | −5 |
| 4-5 | 150-160 | 4.75-5.00 | 0.8594 | 1 | −2 | −3 | −3 | −3 | −4 | −5 |
| 5-6 | 160-170 | 5.00-5.25 | 1 | 1.1142 | −2 | −3 | −3 | −3 | −4 | −5 |
| 5-6 | 170-180 | 5.25-5.50 | 1.1142 | 1.2359 | −2 | −3 | −3 | −3 | −4 | −5 |
| 5-6 | 180-190 | 5.50-5.75 | 1.2359 | 1.3643 | −2 | −3 | −3 | −3 | −4 | −5 |
| 5-6 | 190-200 | 5.75-6.00 | 1.3643 | 1.5 | −2 | −3 | −3 | −3 | −4 | −5 |
| 6-7 | 200-210 | 6.00-6.25 | 1.5 | 1.7786 | −2 | −3 | −3 | −3 | −4 | −5 |
| 6-7 | 210-220 | 6.25-6.50 | 1.7786 | 2.0794 | −2 | −3 | −3 | −3 | −4 | −5 |
| 6-7 | 220-230 | 6.50-6.75 | 2.0794 | 2.4029 | −2 | −3 | −3 | −3 | −4 | −5 |
| 6-7 | 230-240 | 6.75-7.00 | 2.4029 | 2.75 | −2 | −3 | −3 | −3 | −4 | −5 |
| 7-8 | 240-250 | 7.00-7.25 | 2.75 | 3.0368 | −2 | −3 | −3 | −3 | −4 | −5 |
| 7-8 | 250-260 | 7.25-7.50 | 3.0368 | 3.43 | −2 | −3 | −3 | −3 | −4 | −5 |
| 7-8 | 260-270 | 7.50-7.75 | 3.34 | 3.6605 | −2 | −3 | −3 | −3 | −4 | −5 |
| 7-8 | 270-280 | 7.75-8.00 | 3.6605 | 4 | −2 | −3 | −3 | −3 | −4 | −5 |
| | | | | Exp.: | −2.67 | −3 | −3.58 | −3.75 | −4 | −5 |

½ Size PEMD (tpi = 48)

| | | | | | | | | | | |
|---|---|---|---|---|---|---|---|---|---|---|
| Equiv. | | | | | | | | | | |
| Key (to Full) | | | | | | | | | | |
| 1-2 eq. | 0-24 | 0.5-1.0 | −0.3750 | 0.0000 | −2 | −3 | −3 | −3 | −4 | −5 |
| 2-3 eq. | 24-48 | 1.0-1.5 | 0.0000 | 0.1250 | −3 | −3 | −4 | −4 | −4 | −5 |
| 3-4 eq. | 48-72 | 1.5-2.0 | 0.1250 | 0.2500 | −3 | −3 | −4 | −4 | −4 | −5 |
| 4-5 eq. | 72-96 | 2.0-2.5 | 0.2500 | 0.5000 | −2 | −3 | −3 | −3 | −4 | −5 |
| 5-6 eq. | 96-120 | 2.5-3.0 | 0.5000 | 0.7500 | −2 | −3 | −3 | −3 | −4 | −5 |
| 6-7 eq. | 120-144 | 3.0-3.5 | 0.7500 | 1.3750 | −2 | −3 | −3 | −3 | −4 | −5 |
| 7-8 eq. | 144-168 | 3.5-4.0 | 1.3750 | 2.0000 | −2 | −3 | −3 | −3 | −4 | −5 |
| | | | | Exp.: | −2.4 | −3 | −3.4 | −3.5 | −4 | −5 |

¼ Size PEMD (tpi = 72)

| | | | | | | | | | | |
|---|---|---|---|---|---|---|---|---|---|---|
| Equiv. | | | | | | | | | | |
| Key | | | | | | | | | | |
| 1-2 eq. | 0-18 | ¼-½ | −0.1875 | 0.0000 | −2 | −3 | −3 | −3 | −4 | −5 |
| 2-3 eq. | 18-36 | ½-¾ | 0.0000 | 0.0625 | −3 | −3 | −4 | −4 | −4 | −5 |
| 3-4 eq. | 36-54 | ¾-1.0 | 0.0625 | 0.1250 | −3 | −3 | −4 | −4 | −4 | −5 |
| 4-5 eq. | 54-72 | 1.0-1¼ | 0.1250 | 0.2500 | −3 | −3 | −3 | −4 | −4 | −5 |
| 5-6 eq. | 72-90 | 1¼-1½ | 0.2500 | 0.3750 | −3 | −3 | −4 | −4 | −4 | −5 |
| 6-7 eq. | 90-108 | 1½-1¾ | 0.3750 | 0.6875 | −2 | −3 | −3 | −3 | −4 | −5 |
| 7-8 eq. | 108-126 | 1¾-2.0 | 0.6875 | 1.0000 | −2 | −3 | −3 | −3 | −4 | −5 |
| | | | | Exp.: | −2.67 | −3 | −3.5 | −3.67 | −4 | −5 |

TABLE 8-3
Binary Fraction and it's Power of 10 Arranged for First (Most)
Significant Digit (MSD) to be First Digit Right of the Decimal
Point for: PEM's Form for Domain & Range (vs. Standard Form)

| | | | | | | PEM |
|---|---|---|---|---|---|---|
| PEMD | Binary | (A): Decimal | (Std.) | A × B = | PEM | Form |
| n | Fraction | Fraction | B: ×10 | (Std. Form) | C: ×10 | A × C = |
| 0 | ½ | 0.5000000 | −1 | 5.0000000 | 0 | 0.5000000 |
| 1 | ¼ | 0.2500000 | −1 | 2.5000000 | 0 | 0.2500000 |
| 2 | ⅛ | 0.1250000 | −1 | 1.2500000 | 0 | 0.1250000 |
| 3 | 1/16 | 0.0625000 | −2 | 6.2500000 | −1 | 0.6250000 |
| 4 | 1/32 | 0.0312500 | −2 | 3.1250000 | −1 | 0.3125000 |
| 5 | 1/64 | 0.0156250 | −2 | 1.5625000 | −1 | 0.1562500 |
| 6 | 1/128 | 0.0078125 | −3 | 7.8125000 | −2 | 0.7812500 |
| 7 | 1/256 | 0.0039063 | −3 | 3.9063000 | −2 | 0.3906300 |
| 8 | 1/512 | 0.0019531 | −3 | 1.9531000 | −2 | 0.1953100 |
| 9 | 1/1024 | 0.0009766 | −4 | 9.7660000 | −3 | 0.9766000 |
| 10 | 1/2048 | 0.0004883 | −4 | 4.8830000 | −3 | 0.4883000 |
| 11 | 1/4096 | 0.0002441 | −4 | 2.4410000 | −3 | 0.2441000 |
| 12 | 1/8192 | 0.0001221 | −4 | 1.2210000 | −3 | 0.1221000 |
| 13 | 1/16384 | 0.0000610 | −5 | 6.1000000 | −4 | 0.6100000 |
| 14 | 1/32768 | 0.0000305 | −5 | 3.0500000 | −4 | 0.3050000 |
| 15 | 1/65536 | 0.0000153 | −5 | 1.5300000 | −4 | 0.1530000 |
| 16 | 1/131072 | 0.0000076 | −6 | 7.6000000 | −5 | 0.7600000 |
| 17 | 1/262144 | 0.0000038 | −6 | 3.8000000 | −5 | 0.3800000 |
| 18 | 1/524288 | 0.0000019 | −6 | 1.9000000 | −5 | 0.1900000 |
| 19 | 1/1048576 | 0.0000010 | −6 | 1.0000000 | −5 | 0.1000000 |
| 20 | 1/2097152 | 0.0000005 | −7 | 5.0000000 | −6 | 0.5000000 |
| 21 | 1/4194304 | 0.0000002 | −7 | 2.0000000 | −6 | 0.2000000 |
| 22 | 1/8388608 | 0.0000001 | −7 | 1.0000000 | −6 | 0.1000000 |

| | | | |
|---|---|---|---|
| 23 | 1/16777216 | 0.0000001 | Error: |
| | | | n = 23 exceeds spreadsheet's accumulator |

TABLE 8-4
Sample Calculation for Hydrogen (H₂):
Find Niels Bohr's H₂ Electron Orbital Radius (R) Value Using PEM

H₂ Radius = 5.29 × 10⁻¹¹ meters or H₂ Radius = Target (T) = 0 . 20 86 61 ×
10⁻⁸ in inches.
Using Table 8-3 to convert H₂ to PEM Binary Fraction Size from PEM
Size in Power of 10 using PEM Form, select a convenient/known PEMD
“n” value and known exponent value for “Binary-Sizing & Finding H₂
PEMD ‘n’ Value” by simple ratio calculation:
On Table 8-3 (Page 85), select PEMD “n” Column for n = 20 and
exponent = −6 fromPEM Form Column “C” for MSD just right of the
decimal:
$\frac{20}{- 6} = \frac{“ n ”}{- 8} , use inch value for Bohr Radius exponent .$
(−6) “n” = 20(−8)
“n” = 27, use rounded whole number of ratio result.

Hydrogen PEMD “n” value=27. Using Table 8-1, General Expression for Equivalent Binary Domain and Binary Range, and using H₂ Radius Value as an Example Target (T) Value, Bohr's H₂ infinitesimal Radius Value is estimated using PEM Algorithm to to demonstrate and set-up pi estimating math scheme for atomic, Subatomic and beyond. Fractional PEMD uses the following PEM Math Process for effecting a PEM Computer Control Unit (See FIG. 6) which obeys PEM Algorithm for micro-miniature targets. Fractional PEM (See Table 8-1 for Fractional Meaning, Page 82) Computer Interface and Fractional PEM Displacement Device are not discussed but are within current industry art. Computer Methods will require super-computing for unbounded expressions but methods permit repeatable techniques for estimating (e.g.) quantum strings and beyond. Using Binary Domain and Range, coupled with PEM Algorithm for estimating displacements, allow ‘repeating’ a Target's quantum space with greater probability and lessens uncertainty that particles will occur within a PEMD's Target domain and range. Owing to PEM's truncated pi displacement operations, estimates reach very close to actual values. Although Fractional PEM Interface and Device exceed the scope of this Utility Application, PEM Algorithm which are integral to Quarter, Half, and Full-Size PEMD (and greater) are actually essential for ‘all’ PEMD. Software control presented in word algorithm format and basic diagram only (FIG. 6) for Fractional PEMD (mainly <Quarter-Size PEMD) are essential for PEM Process and are integral to this Utility Application. The following Math Process uses pi estimating method (PEM) which essentially integrates PEM Algorithm and Avg. ppc Tables for the H₂ Example given. Methods supplement and are submitted equally with, PEM and Device (PEMD) for precision displacement approximations.

Lower Boundary (D_{L}) of H₂'s Binary Domain (D), n=27, is:

$$\frac{1}{( {2}^{n} )} = \frac{1}{( {2}^{27} )} = \frac{1}{1.34 {( 10 )}^{8}}$$

$${D}_{L} = 0.74 \; 62 \; 69 {( 10 )}^{- 8} , PEM Form , Ref . Table 8 \text{-} 3.$$

Upper Boundary (D_{U}) of H₂'s Binary Domain (D), n=27, is:

$$\frac{1}{( {2}^{n - 2} )} = \frac{1}{( {2}^{25} )} = \frac{1}{3.36 {( 10 )}^{7}}$$

$${D}_{U} = 0.29 \; 76 \; 19 {( 10 )}^{- 7} , Table 8 \text{-} 1 for Format$$

Lower Boundary (R_{L}) of H₂'s Binary Range (R) is =“0”. Value is zero owing to PEMD being ‘leveled or plumb’ for starting displacements. Hence equivalents to Prototype PEMD Domain ‘Key’ for “1 to 2” or (1-2 equiv.) are values omitted for finding Target Displacements.

R_{L}=0.0.

Upper Boundary (R_{U}) of H₂'s Binary Range (R) from Table 8-1, n=27, is:

$$\frac{1}{[ 2 ( {2}^{n - 2} ) ]} = \frac{1}{2 ( {2}^{25} )} = \frac{1}{2 ( 3.36 ) {( 10 )}^{7}}$$

$${R}_{U} = 0.14 \; 88 \; 10 {( 10 )}^{- 7}$$

### Note: Confidence Check:

“Full” Range versus “Full” Domain Upper Values: R_{U} are one half D_{U} in all “Binary” PEM Key Schemes:

$$\begin{matrix}Hence {D}_{U} / 2 = [ 0.297619 {( 10 )}^{- 7} ] / 2 \\ = 0.148810 {( 10 )}^{- 7} \\ = {R}_{U} .\end{matrix}$$

### Check

Knowing Target Domain and Range ‘Boundary’ Values of Hydrogen (H₂), and in a sense, working in reverse, in that, a PEMD's binary displacements used for atomic displacements are not governed by physical dimensions dictated by user packaging constraints, Average Displacement per Crank (C) becomes Average Displacement per Circumference (C) or 2 pi, without loss of meaning for fractional Crank (Key Scheme used with Full-Size PEMD).

A Table 8-4 is ‘set-up’ for working in reverse, using Binary H₂, n=27 (PEM Math Equivalence), to estimate fractional displacement, and using Table 8-1 for finding D_{L}, D_{U}, R_{L}, and R_{U} Values above. By Prototype Key Scheme, PEM Calculations for “Average Precision per Circumference (C)” are made for H₂'s Avg. ppc Table. The result is Table 8-5, Page 96. H₂ Domain and Range Values are congruent with Key pi Intervals and Divisions for simulated ‘Full-Size’ pi estimated equivalency (outlined on Table 8-4 set-up).

From above upper range value (R_{U}) repeated below, find Mid- and Qtr.-Range Values that fall in Prototype ‘KEY’ Domain Intervals: 2-3, 3-4, 4-5, 5-6, 6-7 or 7-8.

R_{U}=0.148810(10)⁻⁷, n=27.

Mid-range for R_{U}=(R_{U}−0)/2 locates pi angle 78.69 degrees, shown below. And R_{U}/2=Mid-Range=0.074405(10)⁻⁷ or 0.74405(10)⁻⁸ (PEM Form, ref. Table 8-3). A PEM n=27 Mid-Range Value is near and >T. A PEM Mid-Range is at Key 4-5 and 5-6 boundary or at I3 and I4 Boundary, respectively. Hence, H₂ Range Target (T) Value is <n=27 Mid-Range Value at Interval 3's (I3's) Upper Boundary, using upper boundary Range Reference and observing that T is Not in Domain Key 5-6.

Mid-Range of n=27 R_{U} must be further divided to determine if T is less than or greater than another pi boundary. Mid-Range/2=¼ R_{U} and recognizing proportionality of pi's Full-Size PEMD Equivalency (Y_{b}), Mid-Range PEM Intervals are I1+I2+I3=I4+I5+I6. Obeying and following PEM Full-Size Scheme: I1+I2 and I3 (by itself) are ¼ R_{U}—see Table 8-4 below. So that PEM Intervals divide according to arc length measurements using pi, ¼ R_{U} is located at Pi Interval=82.87 degrees and is I3 lower boundary.

Therefore, relative to 6 pi intervals and R_{U}, PEM Quarter-Range n=27 (relative to upper boundary value) is I3 (4-5 equiv.) in order to be equivalent to Pi Intervals and Boundary Pi Angles, that obey PEM. At 82.87 Degrees, find I3 lower ‘Domain’ boundary and at 78.69 Degrees, find I3 upper ‘Domain’ Boundary, discussed further in next paragraph.

TABLE 8-4
H₂ Domain Intervals Using PEM Scheme

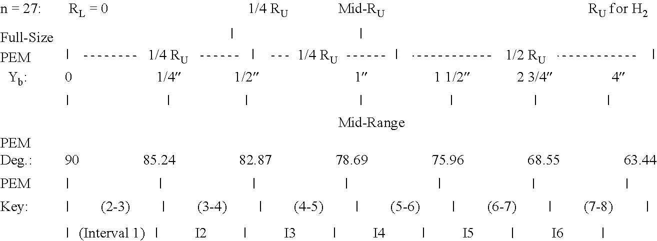

Domain Interval that corresponds to the above Range Interval (I3) occurs between Pi Boundaries: 82.87 degrees and 78.69 degrees and shown below:

$$82.87 deg . 78.69 deg . \\ \vert \vert \vert I 3 \vert \vert \vert \vert \\ {D}_{L} = 0.74 \; 62 \; 69 {( 10 )}^{- 8} \vert \\ \vert \vert \vert 0.29 \; 76 \; 19 {( 10 )}^{- 7} = {D}_{U} \\ \vert \vert \vert \\ \begin{matrix}{x}_{b} = PEM Intervals \\ = ( {D}_{U} - {D}_{L} ) / 6 Intervals - \\ which correspond to 7 angles ( Pi ) / \# above . \\ = 2.97 \; 62 {( 10 )}^{- 8} - 0.74 \; 63 {( 10 )}^{- 8} / 6 \\ = 2.22 \; 99 \; 21 {( 10 )}^{- 8} / 6 \\ = 0.37 \; 16 \; 54 {( 10 )}^{- 8} per pi degree interval .\end{matrix} \\ \vert I 1 \vert I 2 \vert I 3 \vert … \vert … \vert … \vert$$

Domain Increments will correspond to the pi range increments. Divisions will be equal for all intervals and by example, are equal to 10¹ or 10. Therefore, each X_{b} change is [0.371654(10)⁻⁸]/10 or 0.037166(10)⁻⁸.

### Note:

The nice part of Computer Simulation allows selection of divisions within Pi Intervals that do not have to obey threads per inch or TPI. Hence, for Math convenience, select power of 10 and initially select 10¹ or 10 divisions within Pi Intervals for Math ease. Therefore, X_{b}=0.371654(10)⁻⁸ will be divided 10 times or each increment=0.037165(10)⁻⁸. It should be noticed that unlimited 10ⁿ subdivisions are available for infinite increments of X_{b} used in Equation 2-1 calculations for pi estimated (PEM) displacements and are only limited by how close ‘estimate’ values are intended to approximate ‘target’ values.

Find the H₂ Domain Values which identify fractional Pi (expressed in degrees) Increments (Inc.) used for calculating displacement (Y_{b}), using Equation 2-1:

$$\vert I 1 \vert I 2 \vert I 3 \vert I 4 \vert I 5 \vert I 6 \vert \\ Interval \text{:} 0 \; 10 \; 20 \; 30 \; 40 \; 50 \; 60$$

$$( Crank Equivalent )$$

$${( 10 )}^{1}$$

$$\begin{matrix}Inc . ( 20 ) = {D}_{L} + 20 [ Increments ( Inc . ) ] \\ = 0.746269 {( 10 )}^{- 8} + 20 [ 0.037165 {( 10 )}^{- 8} ] of I 3. \\ = 1.48 \; 95 \; 69 {( 10 )}^{- 8} , \\ value is the domain lower boundry ( {D}_{L} ) of I 3.\end{matrix}$$

$$\begin{matrix}Inc . ( 21 ) = {D}_{L} + 21 \times [ 0.03 \; 71 \; 65 {( 10 )}^{- 8} ] \\ = 1.52 \; 67 \; 34 {( 10 )}^{- 8} of I 3.\end{matrix}$$

$$\begin{matrix}Inc . ( 22 ) = {D}_{L} + 22 \times [ 0.03 \; 71 \; 65 {( 10 )}^{- 8} ] \\ = 1.56 \; 38 \; 99 {( 10 )}^{- 8} of I 3.\end{matrix}$$

$$\begin{matrix}Inc . ( 23 ) = {D}_{L} + 23 \times [ 0.03 \; 71 \; 65 {( 10 )}^{- 8} ] \\ = 1.60 \; 10 \; 64 {( 10 )}^{- 8} of I 3.\end{matrix}$$

$$\begin{matrix}Inc . ( 24 ) = {D}_{L} + 24 \times [ 0.03 \; 71 \; 65 {( 10 )}^{- 8} ] \\ = 1.63 \; 82 \; 29 {( 10 )}^{- 8} of I 3.\end{matrix}$$

$$\begin{matrix}Inc . ( 25 ) = {D}_{L} + 25 \times [ 0.03 \; 71 \; 65 {( 10 )}^{- 8} ] \\ = 1.67 \; 53 \; 94 {( 10 )}^{- 8} of I 3.\end{matrix}$$

$$\begin{matrix}Inc . ( 26 ) = {D}_{L} + 26 \times [ 0.03 \; 71 \; 65 {( 10 )}^{- 8} ] \\ = 1.71 \; 55 \; 59 {( 10 )}^{- 8} of I 3.\end{matrix}$$

$$\begin{matrix}Inc . ( 27 ) = {D}_{L} + 27 \times [ 0.03 \; 71 \; 65 {( 10 )}^{- 8} ] \\ = 1.74 \; 97 \; 24 {( 10 )}^{- 8} of I 3.\end{matrix}$$

$$\begin{matrix}Inc . ( 28 ) = {D}_{L} + 28 \times [ 0.03 \; 71 \; 65 {( 10 )}^{- 8} ] \\ = 1.78 \; 68 \; 89 {( 10 )}^{- 8} of I 3.\end{matrix}$$

$$\begin{matrix}Inc . ( 29 ) = {D}_{L} + 29 \times [ 0.03 \; 71 \; 65 {( 10 )}^{- 8} ] \\ = 1.82 \; 40 \; 54 {( 10 )}^{- 8} of I 3.\end{matrix}$$

$$\begin{matrix}Inc . ( 30 ) = {D}_{L} + 30 \times [ 0.03 \; 71 \; 65 {( 10 )}^{- 8} ] \\ = 1.86 \; 12 \; 19 {( 10 )}^{- 8} {D}_{U} of I 3.\end{matrix}$$

Range Interval that corresponds to the above Domain Increments occur between Equivalent Pi Boundaries: 82.87 degrees and 78.69 degrees. Domain Degree Intervals must be mathematically congruent with the same Increments used in Domain Intervals. For math ease, power of 10 was chosen, exponent=to 1, or 10 divisions. Therefore:

$$\frac{82.87 - 78.69}{{10}^{1}} = 0.418 degrees per increment for I 3.$$

I3 Range Increments (Crank/Rev. equivalents) and corresponding pi increments are:

Increment vs. Pi (degree)
20/82.870
21/82.452
22/82.034
23/81.616
24/81.198
25/80.780
26/80.362
27/79.944
28/79.526
29/79.108
30/78.690

With Interval X_{b} Values and corresponding Interval Pi Values above, using Equation 2-1, Avg. ppc are calculated and listed on Table 8-5, Page 95, for PEM H₂ Values. It should be realized that Avg. ppc Tables for all Key Interval Schemes could have been computed instead of the above method which locates the specific Avg. ppc Table for H₂. By computing all Avg. ppc Tables for PEM (10)⁻⁸ and then searching for nearest value (less than) of H₂ identifies which Key Interval contains Bohr's Value−Target (T) Value. The above method allows one to go directly to the Crank Number (Number of Circumferences) or Number of Revolutions to find a math equivalent displacement for further evaluation by PEM Algorithm's value approximation. On Table 8-5 Sample Calculations Page 96, using PEM Algorithm, Bohr's Radius is estimated.

Notice that T−E is 10 one-millionths accurate. By doubling pi truncation to 12 digits and expanding domain interval divisions for 10² increments, and expanding the methods of PEM Algorithm—for example: 7th & 8th digit Accuracy, 9th & 10th Digit Accuracy, and 11th & 12th Digit Accuracy using Partials ‘D’ for Fourth, ‘E’ for Fifth and ‘F’ for Sixth Partial pi Estimate Scheme (See PEM Algorithm, Page 33), respectively, to achieve 12 digit truncations, improves T−E error estimate. For even greater accuracy, more increments within Intervals are necessary. It should be noticed that a continuous set of real numbers can be used for 10ⁿ increments within Domain Intervals. As ‘n’ approaches a very large number (say toward ∞), and recognizing pi's irrational property of never ending (say pi truncations approaching ∞, and never repeating values), Equation 2, using PEM Key Scheme and pi estimating Methods, in general, can produce accurate, repeatable, approximations for displacement values that go beyond atomic, beyond subatomic, beyond quantum and beyond—beyond (e.g.: to the depths of the darkest black hole in space, and possibly, without ending). Exactness of Target Results become only limited by the computational capacity of super-computer use, and of course, cost.

TABLE 8-5
H₂ Confidence Check
Refer to Table 8-4 Row entitled: Full-Size PEM “Y_{b}”, find I3 Displacement
Values and other proportional equivalents in ‘binary magnitudes’ for each Equivalent Key Scheme,
for Binary Domain and Range Intervals, for PEM Device computer simulation using pi estimating:

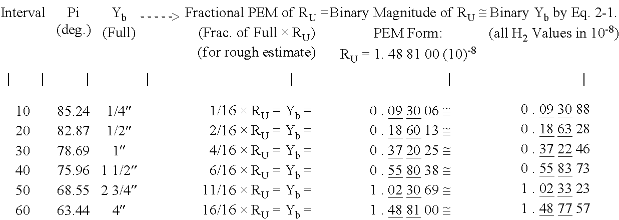

Rough estimates above are used to verify that PEM approximations will simulate Full-Size PEM device magnitudes in relative proportions to micro-miniature Fractional PEM and equally obey Full Size displacement proportionality. Rough Estimates are compared to Binary Y_{b} calculated using PEM of Equation 2-1 and Key Scheme, Ref. Table 8-4.

For example: 6/16 times 4″ is 24/16 or 1.5″ Displacement for Full-Size PEMD. The fractional PEM ( 6/16) times the upper boundary—Full Range—of H₂'s R_{U}, n=27, is compared to Y_{b} calculation at Increment 40, Interval 4, Key Scheme Equivalent (5-6) for PEMD proportionality using pi estimating with PEM Key Scheme and simulated for equivalent results of math values compared to base values established by Prototype Device obeying PEM. Both rough and PEM Eq. 2-1 methods provide agreement. Scheme behavior in atomic space holds.

TABLE 8-5
Average Precision per Crank (Avg. ppc), All Values Multipied by Power of 10, Exponent = −8

| | | | | | | | | |
|---|---|---|---|---|---|---|---|---|
| | | | Precision | Precision | Pecision | Precision | Precision | Precision |
| (C) | | | Per Full C | Per ¼ C | Per ⅛ C | Per 1/12 C | Per 1/36 C | 1/360 C |
| Full 360/C | X_{b} | Y_{b} | (360 deg) | (90 deg) | (45 deg) | (30 deg) | (10 deg) | (1 degree) |

X_{b} = 4.0 to 5.0 Equiv.

| | | | | | | | | |
|---|---|---|---|---|---|---|---|---|
| 20 | 1.489569 | 0.186329 | 0.000000 | 0.000000 | 0.000000 | 0.000000 | 0.000000 | 0.000000 |
| 21 | 1.526734 | 0.202299 | 0.015971 | 0.003993 | 0.001996 | 0.001331 | 0.000444 | 0.000044 |
| 22 | 1.563899 | 0.218845 | 0.016546 | 0.004137 | 0.002068 | 0.001379 | 0.000460 | 0.000046 |
| 23 | 1.601064 | 0.235968 | 0.017123 | 0.004281 | 0.002140 | 0.001427 | 0.000476 | 0.000048 |
| 24 | 1.638229 | 0.253670 | 0.017702 | 0.004426 | 0.002213 | 0.001475 | 0.000492 | 0.000049 |
| 25 | 1.675394 | 0.271955 | 0.018285 | 0.004571 | 0.002286 | 0.001524 | 0.000508 | 0.000051 |
| 26 | 1.715559 | 0.291336 | 0.019381 | 0.004845 | 0.002423 | 0.001615 | 0.000538 | 0.000054 |
| 27 | 1.749724 | 0.310287 | 0.018951 | 0.004738 | 0.002369 | 0.001579 | 0.000526 | 0.000053 |
| 28 | 1.786889 | 0.330342 | 0.020055 | 0.005014 | 0.002507 | 0.001671 | 0.000557 | 0.000056 |
| 29 | 1.824054 | 0.350993 | 0.020651 | 0.005163 | 0.002581 | 0.001721 | 0.000574 | 0.000057 |
| 30 | 1.861219 | 0.372246 | 0.021253 | 0.005313 | 0.002657 | 0.001771 | 0.000590 | 0.000059 |

| | | | | | | |
|---|---|---|---|---|---|---|
| Average Precision per Crank: | 0.018592 | 0.004648 | 0.002324 | 0.001549 | 0.000516 | 0.000052 |
| | (inch/Full C) | (inch/¼ C) | (inch/⅛ C) | (inch/ 1/12 C) | (inch/ 1/36 C) | (inch/ 1/360 C) |

TABLE 8-5
Sample Calculation
Find Hydrogen Radius by PEM Algorithm

| | | | |
|---|---|---|---|
| Hydrogen Target, All Values times Power of 10 | R | = | 0. 20 86 61 |
| with Exponents = −8 and Pi Truncated to 6 Digits | | | |
| for Values of Y | | | |
| (1) A = First Partial of pi estimate Tables 8-5: | C 21 | = | 0. 20 22 99 |
| | | (minus) | |
| (2) ‘Target Value’ (T) minus ‘Crank (C) Value’ | T − C Result | = | 0. 00 63 62 |

| | | | |
|---|---|---|---|
| (3) At Table 8-5 | ½ pi | = C/4 | Avg. ppc = 1 × 0.004648 or 0. 00 46 48 < 0. 00 63 |
| | ¼ pi | = C/8 | Avg. ppc = 2 × 0.002324 or 0. 00 46 48 < 0. 00 63 |
| | ⅙ pi | = C/12 | Avg. ppc = 4 × 0.001549 or 0. 00 61 96 < 0. 00 63 |
| | 1/18 pi | = C/36 | Avg. ppc = 12 × 0.000516 or 0. 00 61 92 < 0. 00 63 |

| | | | |
|---|---|---|---|
| (4) Select C/12 = 0. 00 15 49 | C/12 | = | 0. 00 15 49 |
| (5) Find Multiples of C/12 | 4 Multiples | = | × 4 |

| | | |
|---|---|---|
| (6) B = Second Partial pi Estimate | = | 0. 00 61 96 |

(7) Add both Partials (A + B) and subtract from Target (T):

| | | | | | |
|---|---|---|---|---|---|
| A | = | 0. 20 22 99 | Target | = | 0. 20 86 61 |
| B | = | 0. 00 61 96 | (A + B) | = | 0. 20 84 95 |
| (A + B) | = | 0. 20 84 95 | | (minus) | |

| | | |
|---|---|---|
| T − (A + B) Result | = | 0. 00 01 66. |

| (8) Compare T − (A + B) Result | | | |
|---|---|---|---|
| to Table 8-5's C/360's “Avg. ppc | | | |
| or 5th & 6th Digit Accuracy”: | | | |
| | T − (A + B) Result | = | 0. 00 01 66 |
| | Avg. ppc C/360 | = | 0. 00 00 52 |

| | | |
|---|---|---|
| (9) 3 × [0. 00 00 52] | = | 0. 00 01 56 < 0. 00 01 66. |

| | | | |
|---|---|---|---|
| (10) Select. Multiple M (3). | C = Third Partial pi Estimate | = | 0. 00 01 56 |

(11) Show PEM Estimated Value for Target Value by sum of all partials:

| | | | |
|---|---|---|---|
| Partial A | (1st) | | 0. 20 22 99 |
| Partial B | (2nd) | | 0. 00 61 96 |
| Partial C | (3rd) | + | 0. 00 01 56 |

| | | | |
|---|---|---|---|
| PEM Value Equals: | 0. 20 86 51 | for | Target 0. 20 86 61 |

| | |
|---|---|
| [pi Estimated (E)] | [actual/Target value (T)] |

T − E = 0. 00 00 10

To avoid Specification Fragmentation, it is recommended that the ‘entire’ Specification (Pages 1 to 98) be read for complete Detailed Descriptions, in that, essential detail are intermingled throughout and further supplements methods used in PEM Algorithm of this utility application. Only when repetition occurs, emphasis or clarity are intended.

$$Postscript for Miscellaneous Legend : \\ Pi = Π$$

$$Truncation ( {10}^{- n} )$$

$$n = : 1 \; 2 \; 3 \; 4 \; 5 \; 6 \; 7 \; 8 \; 9 \; 10 \; 11 \; 12$$

$$Pi = ( 3. \underline{1 \; 4} \underline{1 \; 5} \underline{9 \; 2} \underline{6 \; 5} \underline{3 \; 5} \underline{8 \; 9} ) \times {10}^{0} Standard Form$$

$$Pi = ( 0.314159265358 ) \times {10}^{1} PEM Form$$

$$Year \text{:} {2011}_{10} = \begin{matrix}{1}^{{2}^{10}} & {1}^{{2}^{9}} & {1}^{{2}^{8}} & {1}^{{2}^{7}} & {1}^{{2}^{6}} & {0}^{{2}^{5}} & {1}^{{2}^{4}} & {1}^{{2}^{3}} & {0}^{{2}^{2}} & {{1}^{′}}^{{2}^{1}} & {{1}_{2}}^{{2}^{0}}\end{matrix}$$

$$( base 10 ) ( base 2 )$$

$$Π - Day \text{:} 3 \text{-} 14 symbolizes March 14 , Π - Day .$$

1. PEM Algorithm is an original and unique Math Process that utilizes the set of all real numbers in a bounded binary domain, and when combined with pi's ability for infinite truncations, without repeating values, original PEM Equation 2 allow computed binary range values in a restricted arc segment Partition, such that, User-defined Precisions for accurate (target) displacement approximations are integrally obtained by PEM Average Precision per Circumference or Crank (Avg. ppc) Tables specifically constructed for use with PEM Algorithm to either Control an external Device (D) or to support operation of PEM Device(D) or Hardware (PEMD) Operations.

2. Once a PEMD's size is determined and its corresponding Average Precision per Crank (Avg. ppc) Table is constructed for an intended device's Target (T) Range(s), an ornamental PEMD can be fabricated for its intended PEM Tables, such that, a hardware device will be an original device functioning as a self-contained unit, a pi device, a binary device, which will pi estimate displacement by operation of its mechanism.

3. PEM Algorithm can yield precise approximations for displacements within extremely small (>minus infinity) target/goal-value, binary ranges & domains, to extremely large (<positive infinity) target/goal-value, binary ranges & domains, using predetermined user specified precisions in Algorithm usage of pi estimating method (PEM) for results limited only by the arithmetic unit capacities of super-computers, by the concatenation of their links, and/or by budget restrictions.
